(19) United States
(12) Patent Application Publication
(10) Pub. No.: US 2012/0317016 A1
(43) Pub. Date: Dec. 13, 2012

(54) System and Method for Trading Debt Instruments

(75) Inventor: David Hughes, Springfield, IL (US)

(73) Assignee: My Interest Broker, LLC, Springfield, IL (US)

(21) Appl. No.: 13/492,020

(22) Filed: Jun. 8, 2012

Related U.S. Application Data
(60) Provisional application No. 61/495,039, filed on Jun. 9, 2011.
(60) Provisional application No. 61/543,852, filed on Oct. 6, 2011.
(60) Provisional application No. 61/642,532, filed on May 4, 2012.

(51) Int. Cl. G06Q 40/02

(52) U.S. Cl. 705/38

(57) ABSTRACT

A system for facilitating debt instrument transactions has a processor for communication with a plurality of remote computers via a network. The processor is configured to store a data structure in a memory. The data structure has data items associated together as a user profile. The data items comprise data representative of a financial condition and creditworthiness for a user associated with the user profile. The processor is further configured to complete a debt instrument transaction between the user and a lender in response to inputs from a plurality of the remote computers. The processor is further configured to detect the completed debt instrument transaction, and in response to detection of the completed debt instrument transaction, automatically update the stored user profile based on the completed debt instrument transaction and republish the updated user profile so a lender may extend an offer to the user regarding another debt instrument transaction.

### CROSS-REFERENCE AND PRIORITY CLAIM TO RELATED PATENT APPLICATIONS

This patent application claims priority to provisional patent application 61/495,039, filed Jun. 9, 2011, entitled “System and Method for Trading Debt Instruments,” the entire disclosure of which is incorporated herein by reference.

This patent application also claims priority to provisional patent application 61/543,852, filed Oct. 6, 2011, entitled “System and Method for Trading Debt Instruments,” the entire disclosure of which is incorporated herein by reference.

This patent application also claims priority to provisional patent application 61/642,532, filed May 4, 2012, entitled, “System and Method for Trading Debt Instruments and Tax Liens,” the entire disclosure of which is incorporated herein by reference.

### BACKGROUND

Access to capital has traditionally been cyclical. Prior to the latest significant economic downturn that began around 2008, capital markets were liquid. However, outside of the residential mortgage market, the market was not necessarily efficient or competitively priced. Credit was available to many, qualified or not.

As the recession that began around 2008 deepened, many traditional bank lending outlets became constricted. The ability of individuals and businesses to identify banks that were capable and interested in providing capital became a challenge. Additionally, other capital providers such as venture capital firms, angel investors and private equity investors were unknown to qualifying small to mid-sized businesses. In turn, when local capital was available, the terms were often too restrictive. Restrictive terms and a working capital drought exacerbated the downturn.

Today, capital markets are fractured and inefficient. Borrowers have difficulty locating capital providers and lenders. While investors have difficulty finding qualified opportunities to deploy capital. Additionally, the restrictive geographic nature of capital access has compounded this problem. Banks in certain markets face the same financial challenges, choking off capital access. Banks that do lend know their market competition well and will only offer terms good enough to win the business.

Magnifying the challenge, the process to access capital is complicated time consuming and transactional. Business owners compile financial reports for each potential transaction and each capital provider that could be a potential lender. This inefficient process leads to high costs, potential errors, and time consumption that could be better spent managing and growing their business. Even when the business is successful in acquiring capital, it is for a single transactional event. Improvements in profitability, significant contract awards, or other positive business events go unrewarded—ultimately, holding down profits and stifling growth.

Banks and investors also engage in a time consuming, inefficient process. They waste time and money prospecting for business that may not exist in their market and underwriting opportunities that do not meet their credit standards when a deeper review of the borrower is undertaken. Geographic reach also presents unwanted credit concentration and geographic risk.

In an effort to improve on this state of affairs, the inventors disclose a system to assist in trading debt instruments. Specifically, the system and methods disclosed herein allow privately owned businesses, and individuals and families, with access to capital markets and professional business services. Potential capital products include, but are not limited to, venture capital, mezzanine debt, working capital, equipment, floor plans, and real estate for small and middle market businesses, as well as, real estate, automobile, credit lines, and credit cards for consumers. Additionally, the system and methods disclosed herein provide capital providers including, but not limited to, traditional banks, venture capital, private equity/angel investors, asset based lenders, factoring companies, and international lenders, with gain access to individuals and families, and privately owned businesses through the use of screening tools and a database accessible through the internet.

To that end, the system and methods disclosed herein seek to the following:
To provide access to venture capital and traditional bank loans
To provide access to capital for business and individuals and families
To provide access to companies or consumers in accordance with a financial institution specific underwriting guidelines and profiles
To provide businesses, individuals and families with improved access to capital
To provide investors with access to tax liens levied by local municipalities, for instance, in relation to unpaid real estate property taxes and other personal property.
To increase transparency and competition between capital providers
To provide a means by which businesses and consumers may maintain application records for use in applying for loans

As disclosed herein the system provides a web platform that provides each user with a personalized dashboard. This dashboard may include overall cost of capital, key debt ratios, comparisons to effectively manage businesses/households, daily market forecasts, and matched capital providers.

As disclosed herein, the system provides individuals and families, referred to herein as consumer users, with a platform to market their capital needs for mortgages, auto loans, and credit cards on a continuous not transactional basis. The platform allow consumer users to update current financial events, for instance, career change, salary increase, debt retirement, and allow capital providers to compete for the consumer user's needs, for instance, remaining debt. Via the system, consumer users may also access professional services including accounting, legal, insurance, credit reporting, and investment management services to assist with needs.

For privately and publicly owned businesses, referred to herein as business users, the system provides a platform that allows business users to market their capital needs for real estate, equipment, receivables financing, start-up capital, merger and acquisition financing, and operating capital on a continuous basis. The platform allows business users to update current financial events, for instance, new contract acquisition, competitive acquisition, and debt retirement, and allow capital providers to compete for the business user's needs, for instance, remaining debt. Via the system, business users may also access professional services including accounting, legal, insurance, credit reporting, and investment management services to assist with needs.

For capital providers, for instance, traditional banks, venture capital, private equity/angel investors, asset based lenders, factoring companies, and international lenders (referred to herein as lender user's), the system provides a searchable database with screening tools and metrics to assist the lender user in evaluating risk, making loans, and equity investments.

The system includes a secure and searchable database to allow opportunities to be created between lender users, and business/consumer users. The database includes information sufficient to finalize loan applications with minimal additional underwriting. The system may be configured to integrate with credit bureaus and other reporting agencies to supplement information in the database, for instance, credit scores, verification of income, and business reporting agencies. The system may also be configured to integrate with municipalities for records on tax liens and real estate to supplement information in the database and assist in asset valuation. The system may also be configured to mask the identity of the users until a binding agreement is reached. The system may be configured to receive monies in escrow to facilitate the parties' good faith in reaching a completed transaction. The system may be configured to users to communicate, send messages, make counteroffers, and negotiate a deal. The system may be configured to republish a user's profile on the system so the user may receive a better offer at a future date. The system may also be configured to enable private investors to look for investment opportunities. For instance, the system may enable investors to buy and sell tax liens levied by federal, state, and local municipalities and provide means for trading such liens via an auction with re-bidding and re-auctioning, once a transaction associated with the lien is consummated. Further advantage will become evident in the description that follows.

### BRIEF DESCRIPTION OF THE DRAWINGS

FIG. 1 illustrates an exemplary system for facilitating trading debt instruments and conducting other transactions;

FIG. 2(a)-2(d) are exemplary illustrations of a database structure for a consumer user personal profile;

FIG. 3 is an exemplary screen display available to a consumer user for creating a personal profile;

FIGS. 4(a)-4(b) are an exemplary screen displays associated with a consumer user's personal profile with fields for personal information;

FIG. 5(a)-5(e) are exemplary screen displays associated with a consumer user's personal profile with fields for work and income information;

FIG. 6 is an exemplary screen display associated with a consumer user's personal profile with fields for credit card information;

FIG. 7(a)-7(b) are exemplary screen displays associated with a consumer user's personal profile with fields for automobile information;

FIG. 8(a)-8(h) are exemplary screen displays associated with a consumer user's personal profile with fields for real estate information;

FIG. 9(a)-9(f) are exemplary screen displays associated with a consumer user's profile with fields for assets and liabilities information;

FIG. 10(a)-10(d) are exemplary screen displays made available to a consumer user providing the consumer user with indications of active work rooms, submissions and offers, and opportunities;

FIG. 11(a)-11(b) are exemplary screen displays associated with a consumer user's public personal profile;

FIG. 12 is an exemplary screen display presented to the consumer user providing dashboard indication of the consumer user's personal profile;

FIG. 13 is an exemplary screen display available to a business user for creating a business profile;

FIGS. 14(a)-(c) are exemplary screen displays associated with a business user's business profile with fields for basic business information;

FIGS. 15(a)-15(c) are exemplary screen displays associated with a business user's business profile with fields for finances;

FIG. 16 is an exemplary screen display associated with a business user's business profile with fields for business equipment information;

FIG. 17 is an exemplary screen display associated with a business user's business profile with fields for business real estate information;

FIG. 18 is an exemplary screen display associated with a business user's business profile with fields for business accounts, assets, and liabilities and loans;

FIG. 19(a)-19(c) are exemplary screen displays associated with a business user's public business profile;

FIG. 20 is an exemplary screen display presented to the business user providing dashboard indication of the business user's business profile;

FIG. 21 is an exemplary screen display available to a lender user for creating a lender profile;

FIG. 22 is an exemplary screen display associated with a lender user's lender's profile with fields for basic lender information;

FIGS. 23(a)-23(b) are exemplary screen displays associated with a lender user's firm with fields for a lender user's basic firm information;

FIGS. 24(a)-24(f) are exemplary screen displays presented to the lender user providing the lender user with indications of active work rooms, submitted offers and submitted opportunities;

FIGS. 25(a)-25(c) are exemplary screen displays presented to the lender user providing the lender user with a template to make an offer to a business/consumer user;

FIG. 26 is an exemplary screen display associated with a lender user's public lender profile;

FIG. 27 is an exemplary screen display presented to the lender user providing dashboard indication of the lender user's lender profile;

FIG. 28 is an exemplary screen display available to a professional partner user for creating a partner profile;

FIG. 29 is an exemplary screen display associated with a professional partner user's partner's profile with fields for basic information;

FIG. 30(a)-30(b) are exemplary screen displays associated with a professional partner user's firm with fields for a partner user's basic firm information;

FIG. 31 is an exemplary screen display associated with a lender user's public lender profile;

FIG. 32 is an exemplary screen display presented to the professional partner user providing dashboard indication of the professional partner user's partner profile;

FIGS. 33(a)-33(g) are exemplary screen displays of a secure workroom to enable parties to consummate a transaction;

FIG. 34 is a flowchart providing an overview of the process by which a transaction is consummated via the system;

FIG. 35 is a flowchart providing an overview of the process by which an auction is conducted via the system; and

FIG. 36 is a flowchart providing an overview of process by which a transaction regarding future capital needs is consummated via the system.

FIG. 37 is a flow chart showing the process by which a user's transaction with a lender is republished on the system after consummation of the transaction; and

FIGS. 38(a)-38(h) are flowcharts illustrating the steps in consummating a transaction between a lender user and a business/consumer user.

### DETAILED DESCRIPTION

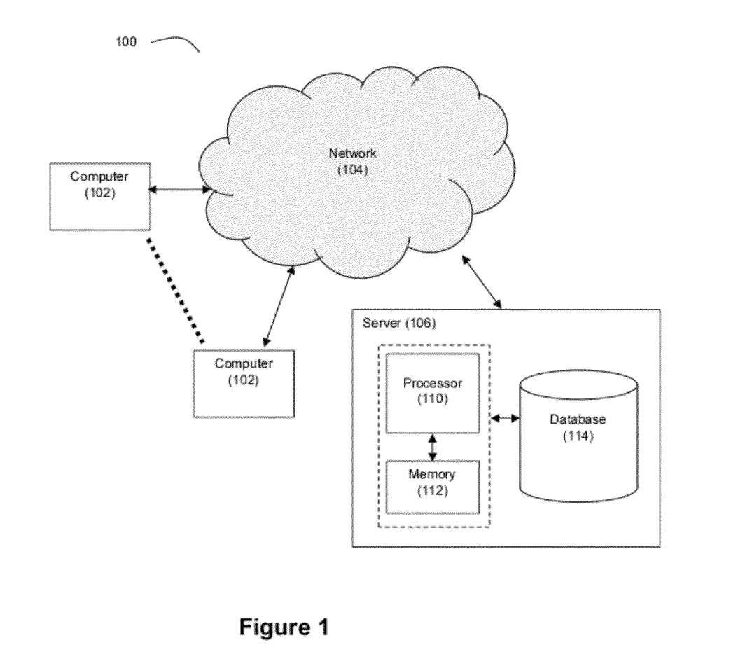

FIG. 1 illustrates an exemplary system 100 for facilitating debt instrument transactions. In this exemplary embodiment, the system comprises a processor 110 in communication with remote computers 102 over a network 104 such as the Internet or other data communications network. Processor 110 is also in communication with memory, such as memory 112 and database 114.

Each remote computer 102 may take the form of any computer or other device capable of connecting to the network 104 to support the type of data interactions and data processing described herein. For example, remote computer 102 can be a standard personal computer (PC) or laptop capable of connecting to the Internet or other data communications network, and optionally including a conventional web browser program (such as Internet Explorer). As another example, the remote computer 102 can be a mobile computing device such as a smart phone (e.g., an iPhone, a Google Android device, a Blackberry device, etc.), a tablet computer (e.g., an iPad), or the like.

The processor 110 may be resident on a server 106, where the server 106 is configured to communicate with the remote computers 102 via the network 104. The server 106 may be configured to host a website through which the remote computers 102 access the functionality described herein. It should also be understood that the server 106 can be configured to host a mobile application site through which the remote computers 102 can access the functionality described herein. Further still, it should be understood that the processor 110 may comprise multiple processors for performing the functionality described herein in a distributed manner, and that the server may comprise multiple servers. Programming may include programming on one or multiple processors for performing the functionality described herein in a distributed manner.

The memory 112 and database 114 can be resident on any of one or more physical memories that can take the form of a non-transitory computer-readable storage medium. Such memory can be configured to store data structures representative of the profiles described herein as well as data structures representative of the executable programming instructions described herein. For example, the memory for memory 112 may take the form of RAM within a server and the memory for database 114 may take the form of a hard drive or the like within the server or accessible by the server. Further still, it should be understood that database 114 may optionally be distributed across multiple physical memories as a plurality of databases. Moreover, the content of the database 114 is preferably encrypted to protect the privacy and security of any data stored therein.

It should be noted that the system described herein may be implemented in software and/or in a combination of software and hardware, e.g., using application specific integrated circuits (ASIC), a general purpose computer or any other hardware equivalents. Programming for the system and/or mobile device may be loaded into memory and executed by processor to implement the functions discussed herein. As such, programming may be stored on a computer readable medium, e.g., RAM memory, magnetic or optical drive or diskette and the like. Further as used herein, the term “program” or “programming” refers to computer program logic utilized to provide the specified functionality. Thus, a program or programming may be implemented in hardware, firmware and/or software.

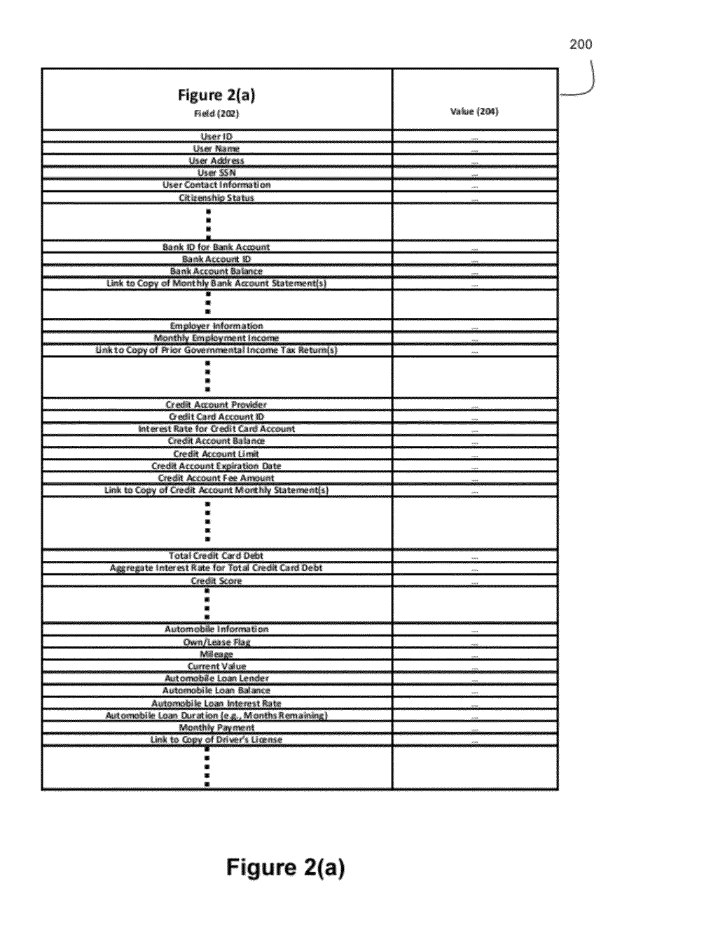

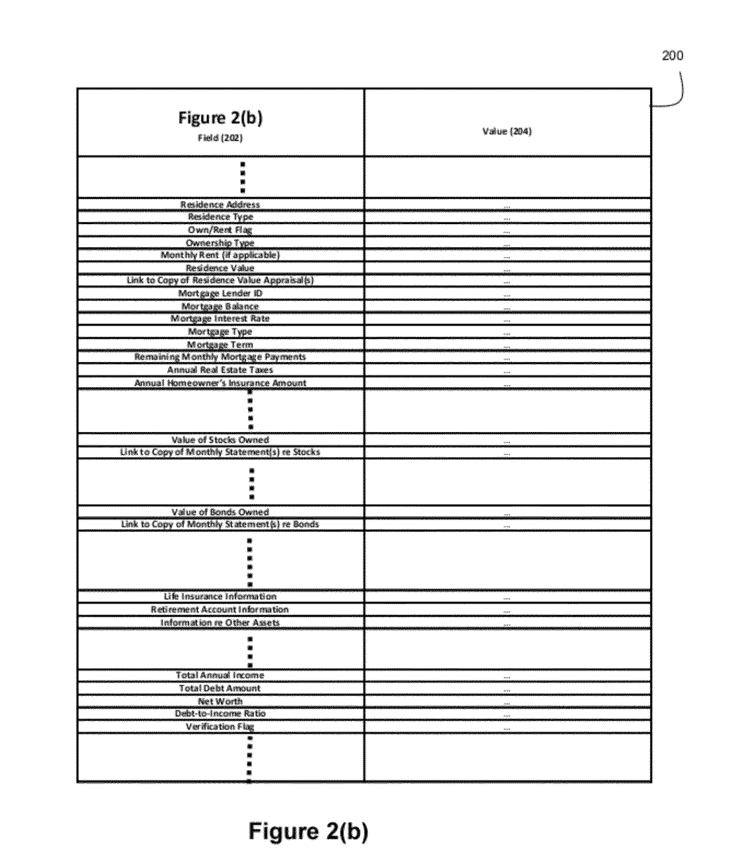

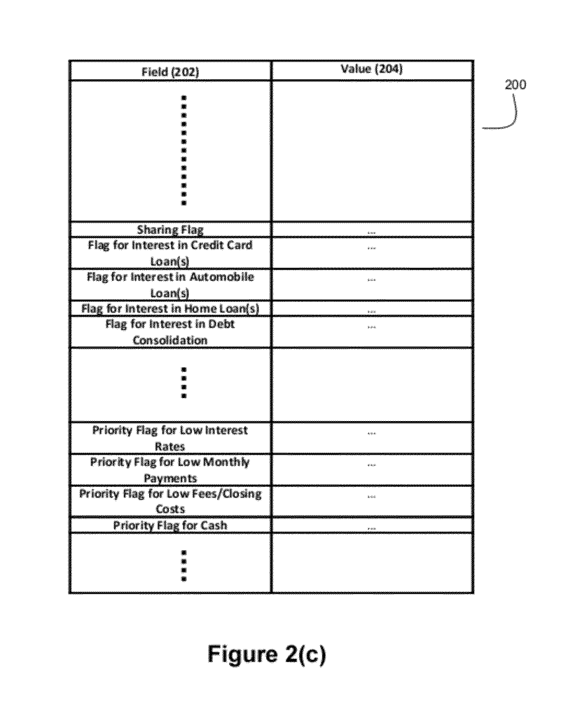

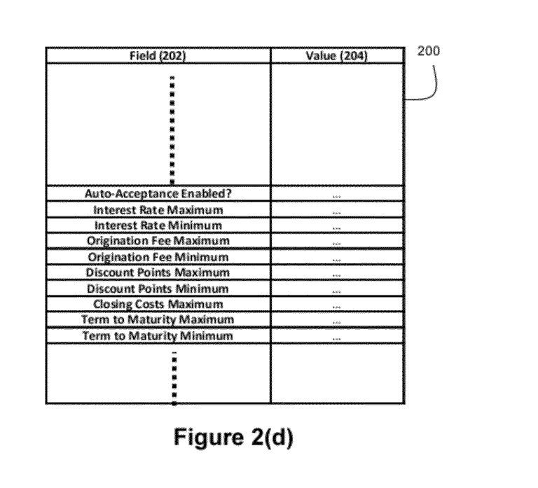

FIGS. 2(a)-2(d) show an exemplary data structure 200 associated with a personal profile of a consumer user. The data structure 200 is stored in the memory associated with the processor. The data structure comprises a plurality of data items 202,204 associated together as a user profile. For instance, as shown in FIGS. 2(a)-2(d), the data items are representative of the financial condition and credit worthiness of the consumer user. Similar data structures with more or less fields may be created and associated with the business user, a lender user, or a professional partner as will be described in greater detail below. The information shown in the drawing figures is intended to be exemplary and not limiting in any fashion.

### “Overview”

The system processor may have programming to present a series of displays with fields to allow the different users of the system to input information to facilitate making a debt instrument transaction. The inputted information will form a data structure 200 to be associated with the user's personal profile. The exemplary types of users and characteristics of the profiles are discussed below and may include a consumer (i.e., personal, individual, family) user, business user, professional partner user, and a lender user.

The system will generate the series of displays depending upon the type of user selected. One individual may have different uses for the system, and may be, for example, both a consumer user for personal use on the system, and a business user, as a business owner. The system has programming configured to display a graphic user interfaces for each user. The system has programming to allow the linking of profiles, for instance, husband and wife, an individual and the individual's business. Each user will be invited to create a personal profile, and each user will be provided with a home page providing a dashboard of the user's activity on the system. The dashboard will include the user's system message board, a summary of the user's profile information, and links to various pages on the system. In addition, to provide anonymity on the system while parties seek opportunities, a public profile is created with metrics reflective of creditworthiness. A user's public profile is made available through the system so parties may evaluate risk and consider a further business relationship. The system may be configured to evaluate a user's inputted information and resultant profile, and highlight for the user areas of concern, for instance, where the user may have an unusually high credit card interest rate, or another uncustomary term associated with the user's debt or finances.

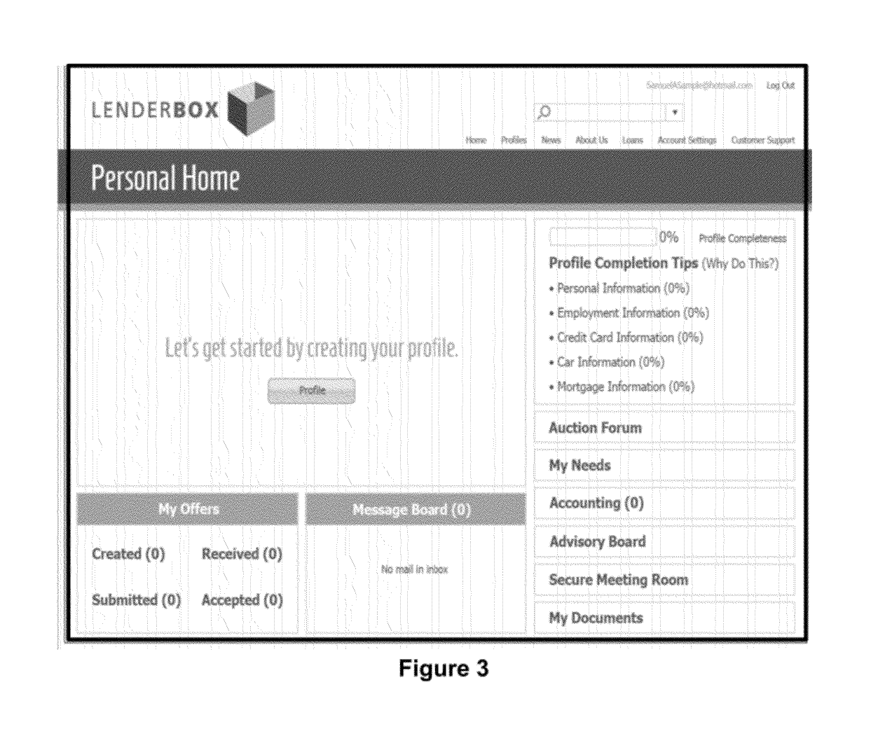

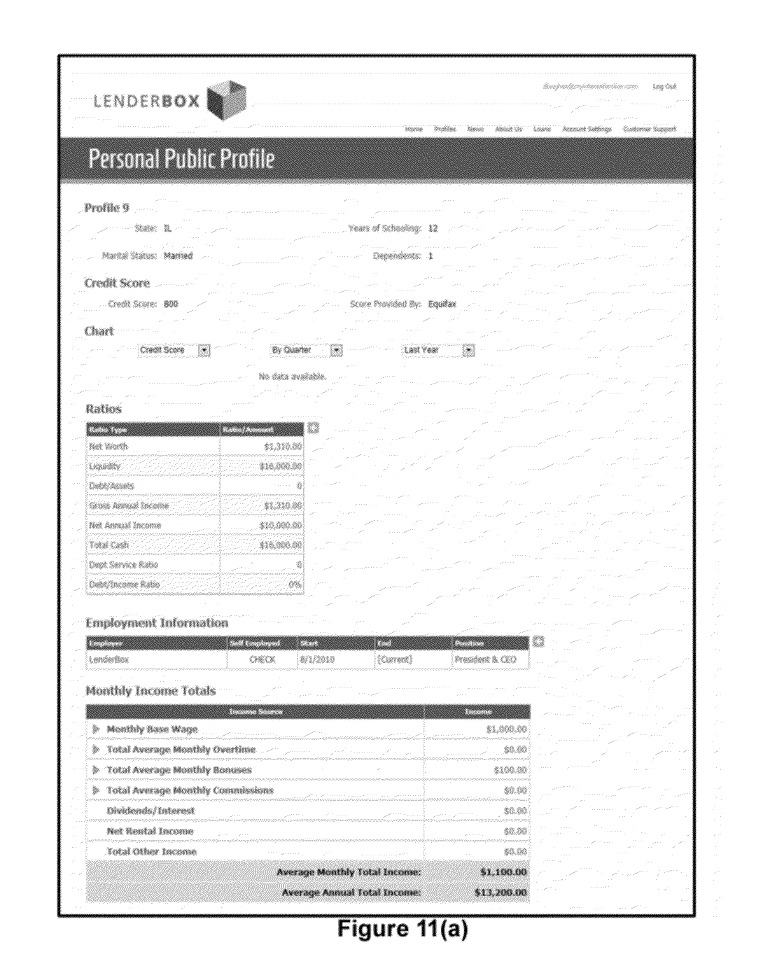

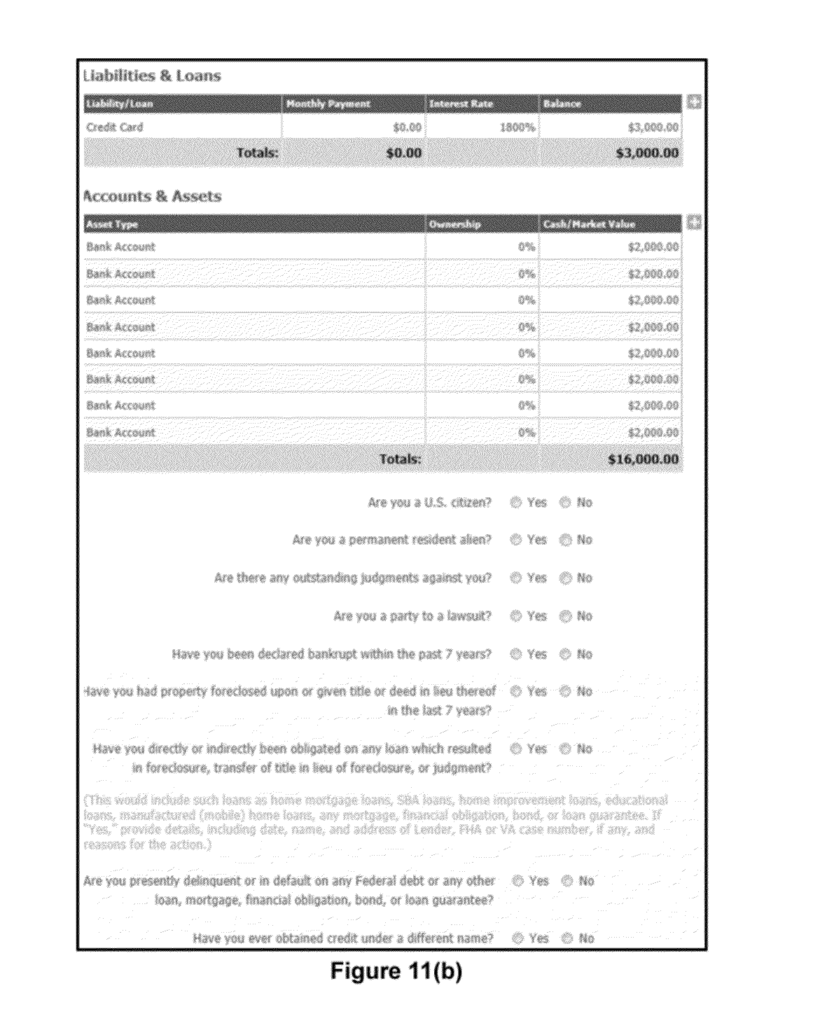

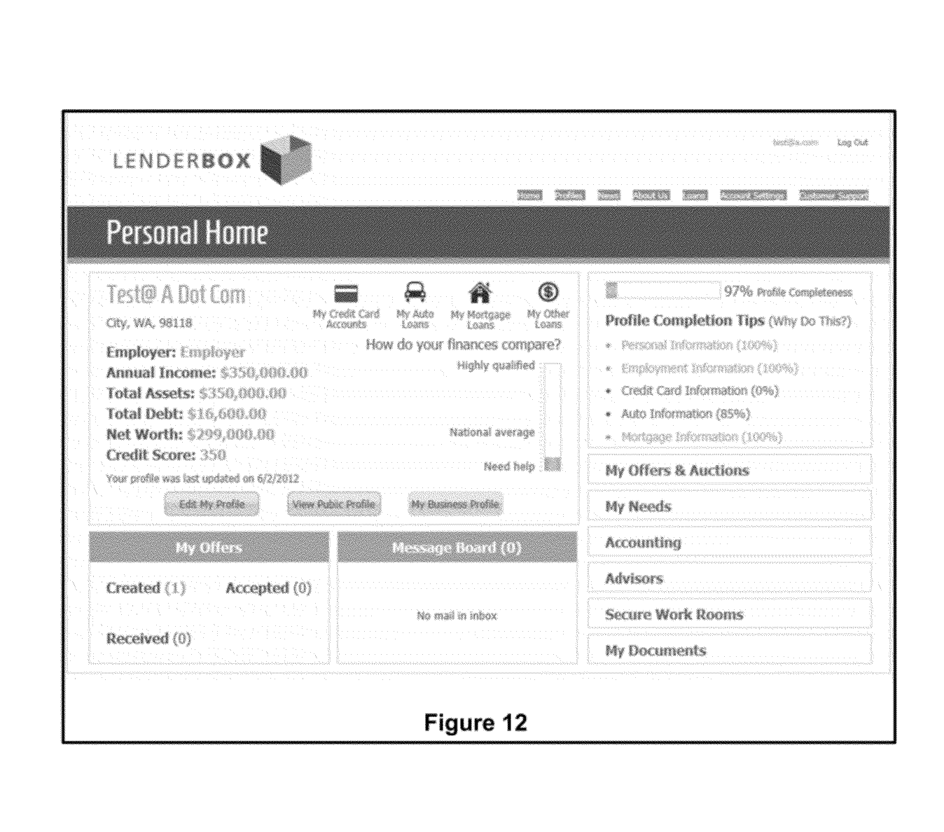

Representative screen displays showing the graphic user interfaces associated with the consumer user's personal profile are shown in FIGS. 3, 4(a)-4(b), 5(a)-5(e), 6, 7(a)-7(b), 8(a)-8(h), and 9(a)-9(f). The screens and data input collects all of the information and documents needed to allow for the consumer user to apply for a credit card, auto loan, and home loan. Among the several displays, information from earlier screens and data input is auto-populated to simplify the data input for the consumer user. Once the profile is completed, the information will be displayed to the consumer on the consumer user's home page as shown in FIG. 12. Public profile information for the consumer will made available to users of the system in a format such as that shown in FIGS. 11(a)-11(b).

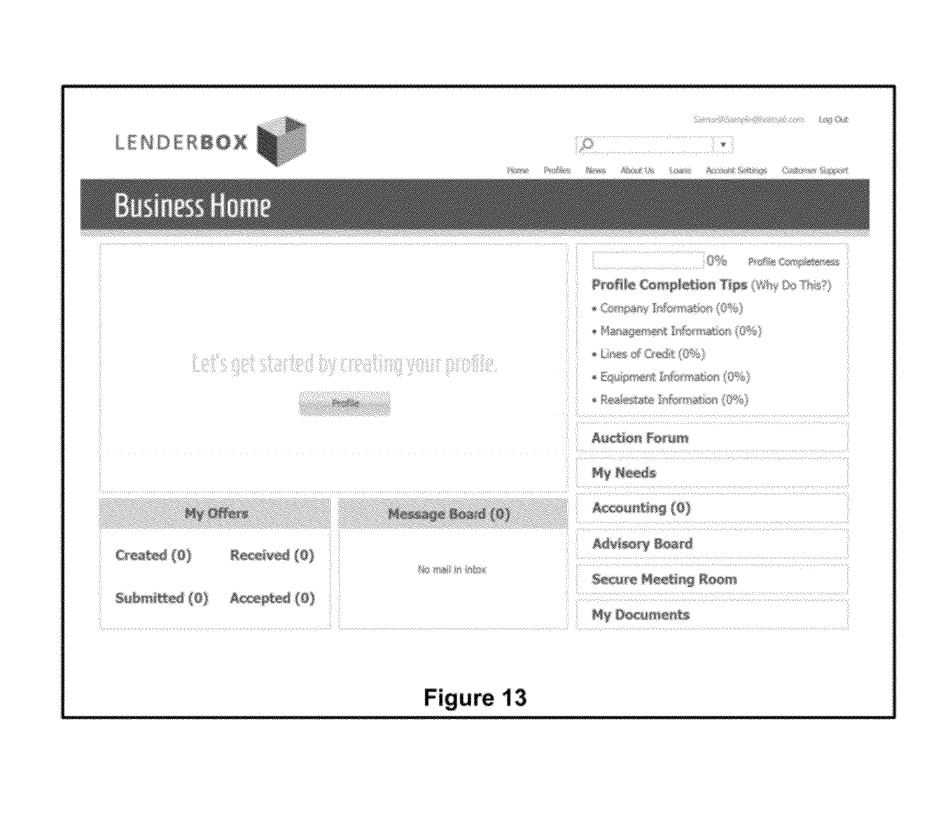

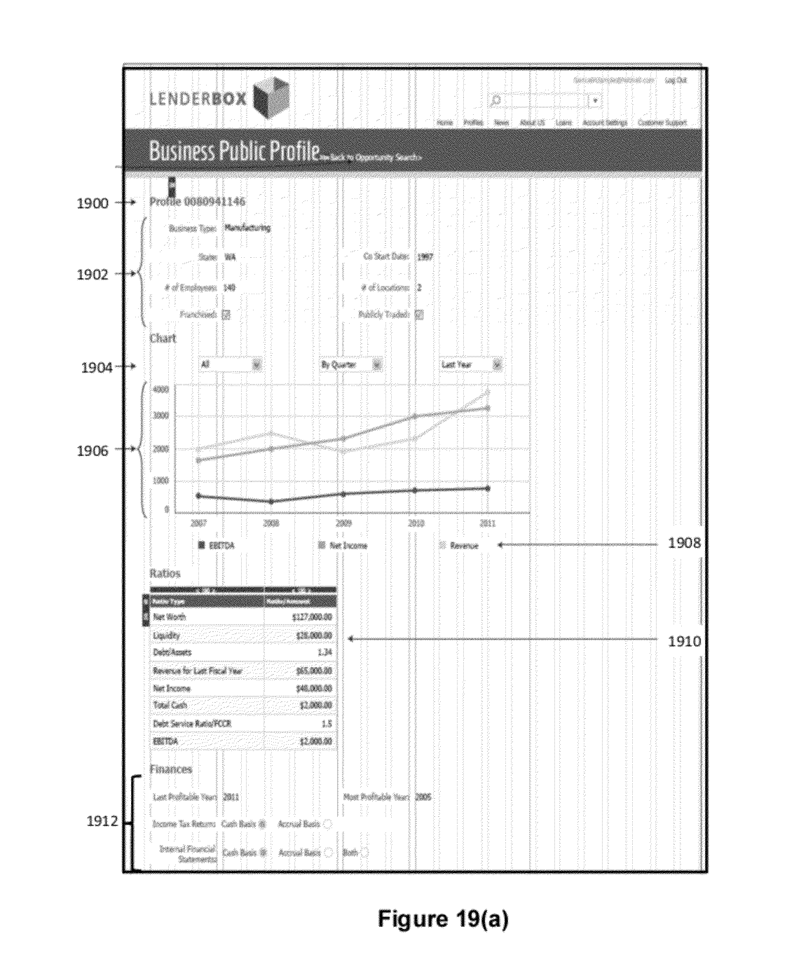

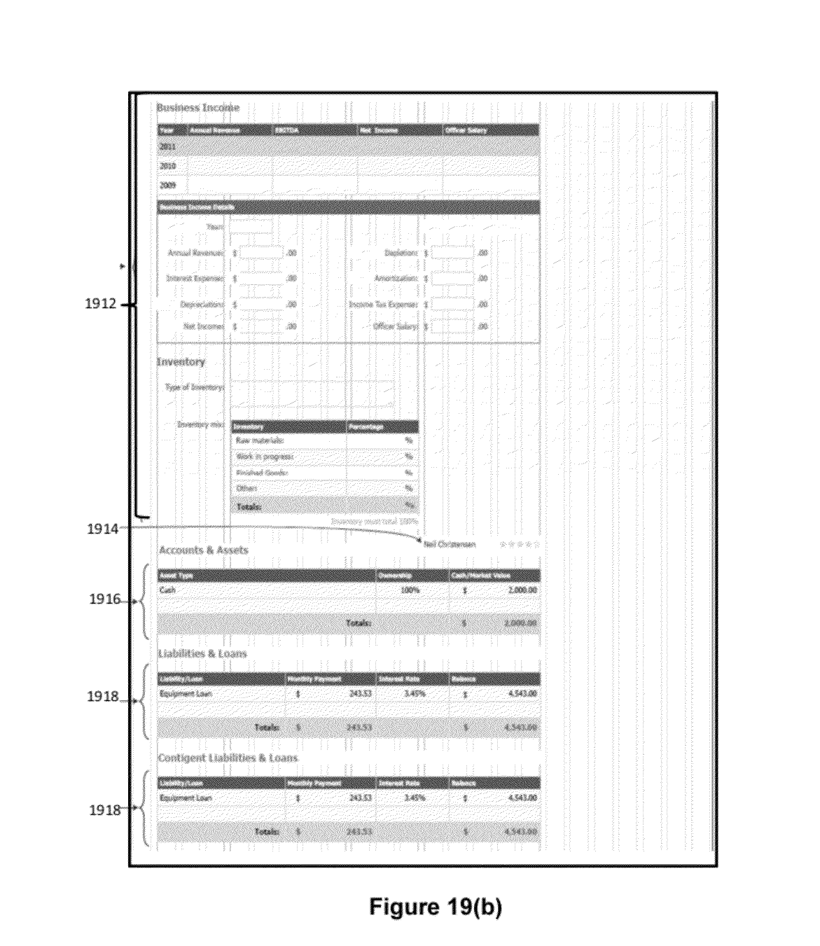

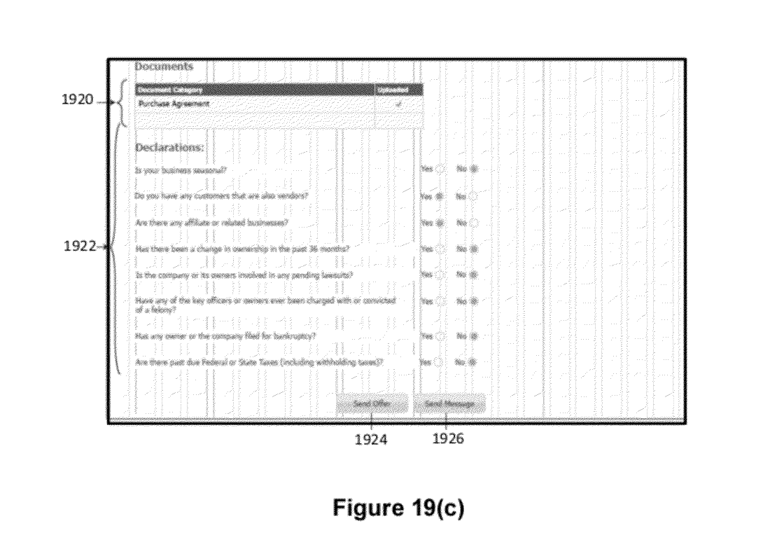

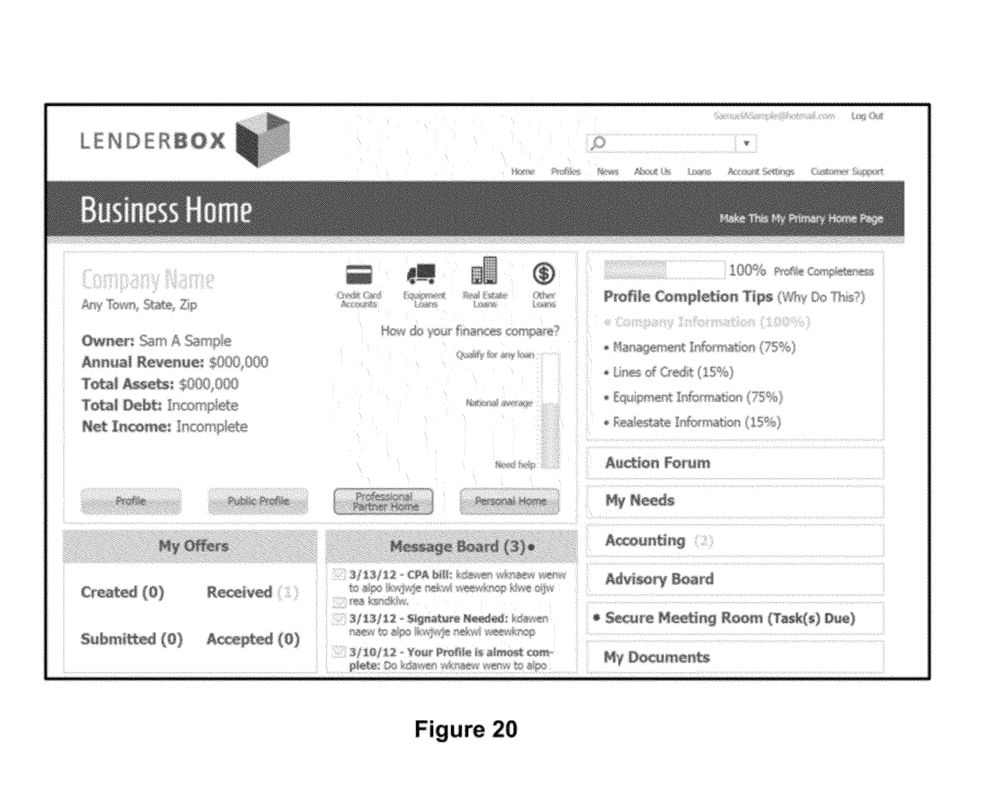

For a business user, the series of display pages will be similar in nature and invite the business user to input all of the information and documents needed for the business user to apply for a business related financing. Representative screen displays showing the graphic user interfaces associated with the business user's business profile are shown in FIGS. 13, 14(a)-14(c), 15(a)-15(c), 16, 17, and 18. Among the several displays, information is auto-populated to simplify the data input for the business user. Once the profile is completed, the information will be displayed on the business user's home page as shown in FIG. 20. Public profile information for the business user will made available to users of the system in a format such as that shown in FIGS. 19(a)-19(c).

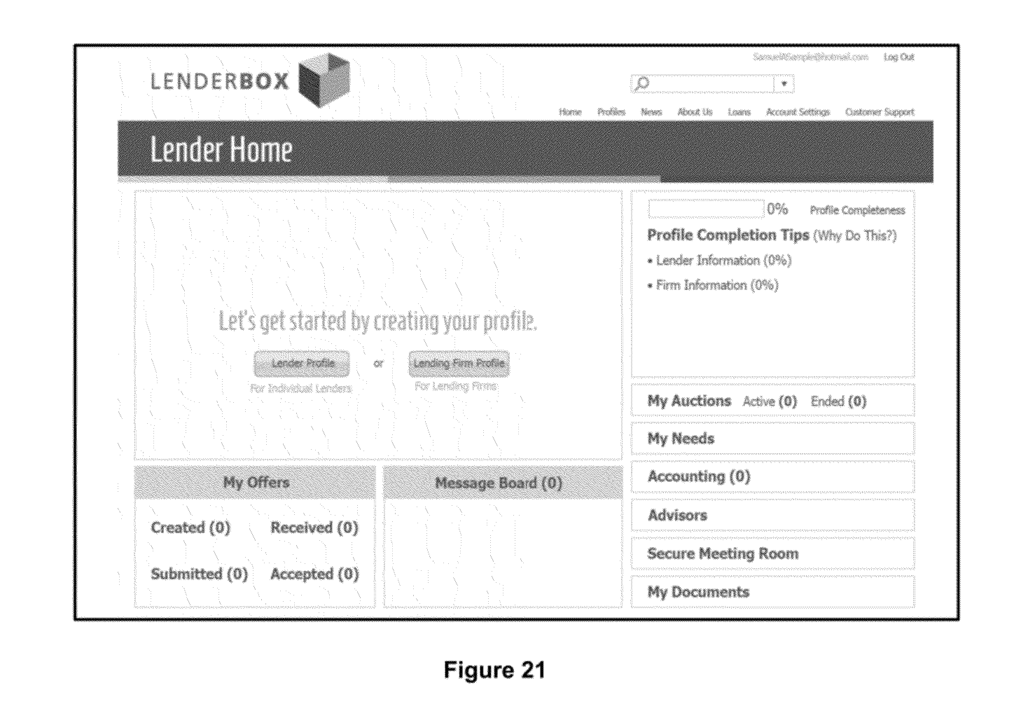

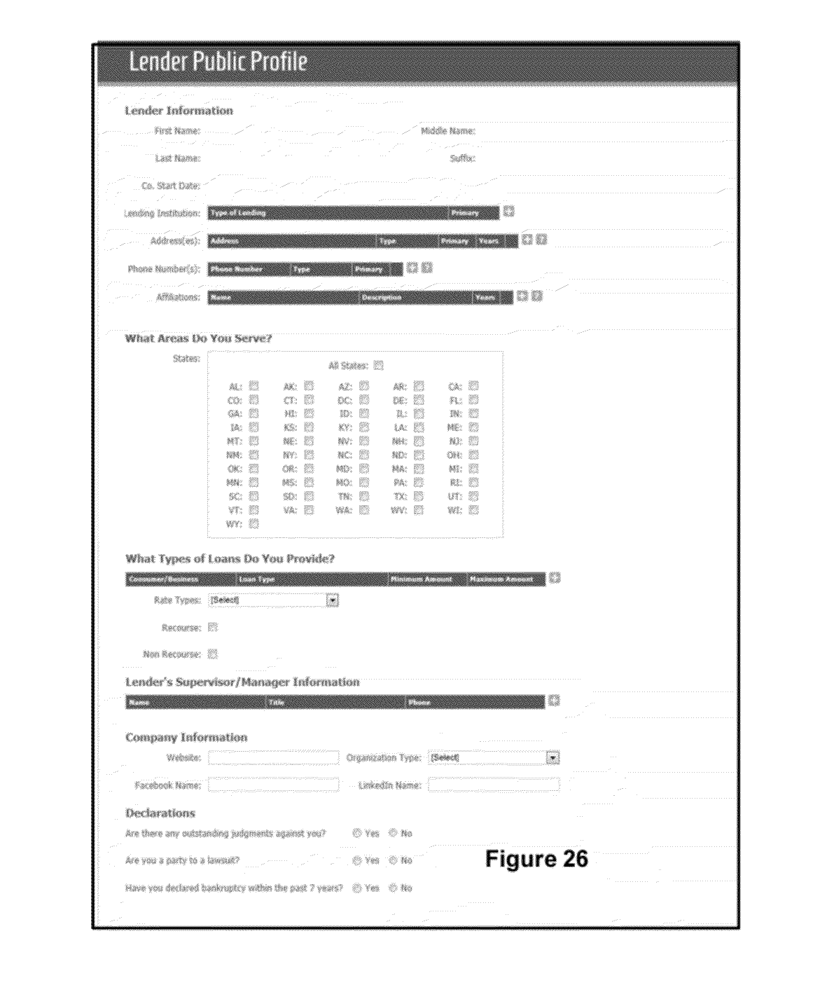

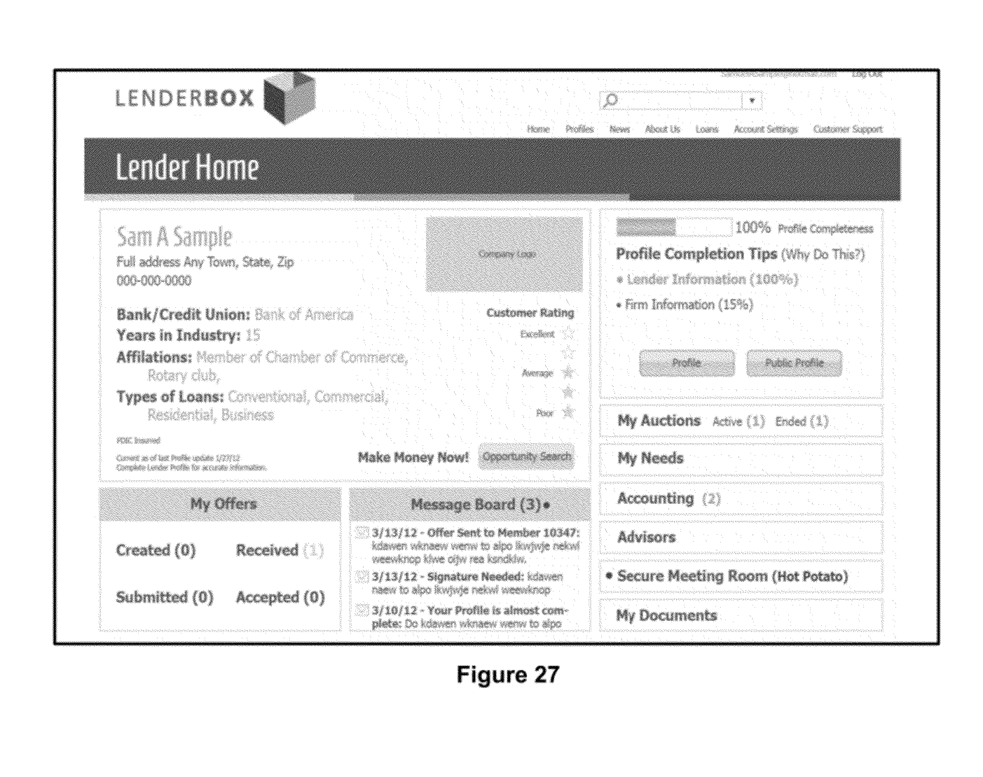

The displays for the lender user are similar but oriented toward offering financial products to consumer users and business users, depending upon the market and type of lender. Representative screen displays showing the graphic user interfaces associated with the lender user's lender profile are shown in FIGS. 21, 22(a)-22(b), and 23. Once the profile is completed, the information will be displayed on the lender user's home page as shown in FIG. 27. Public profile information for the lender user will made available to users of the system in a format such as that shown in FIG. 26.

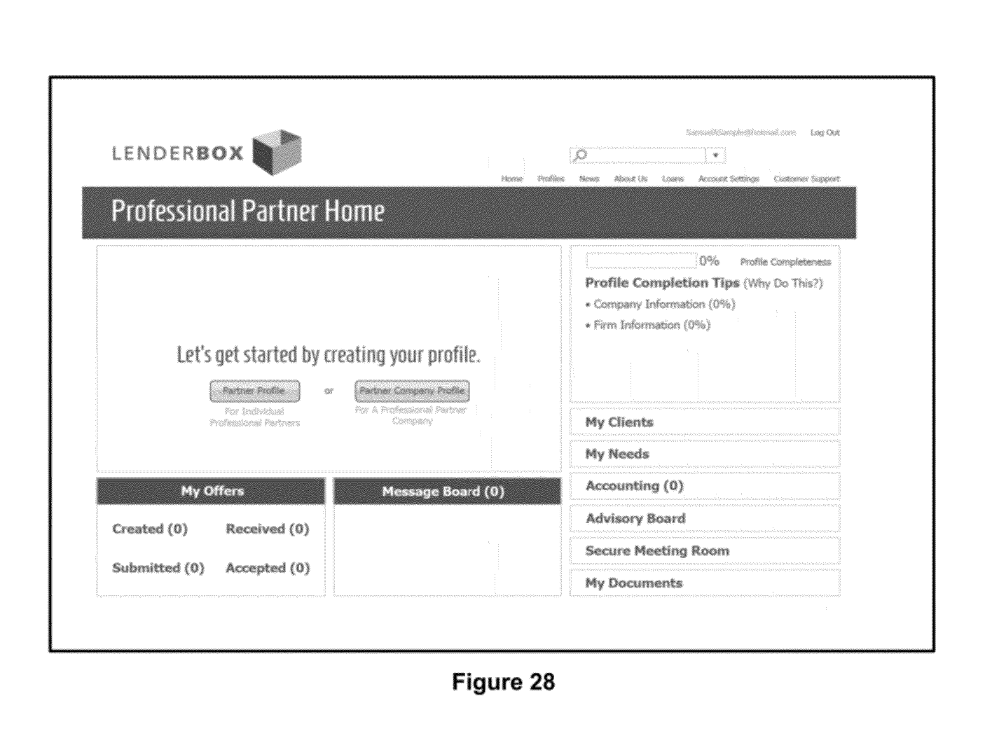

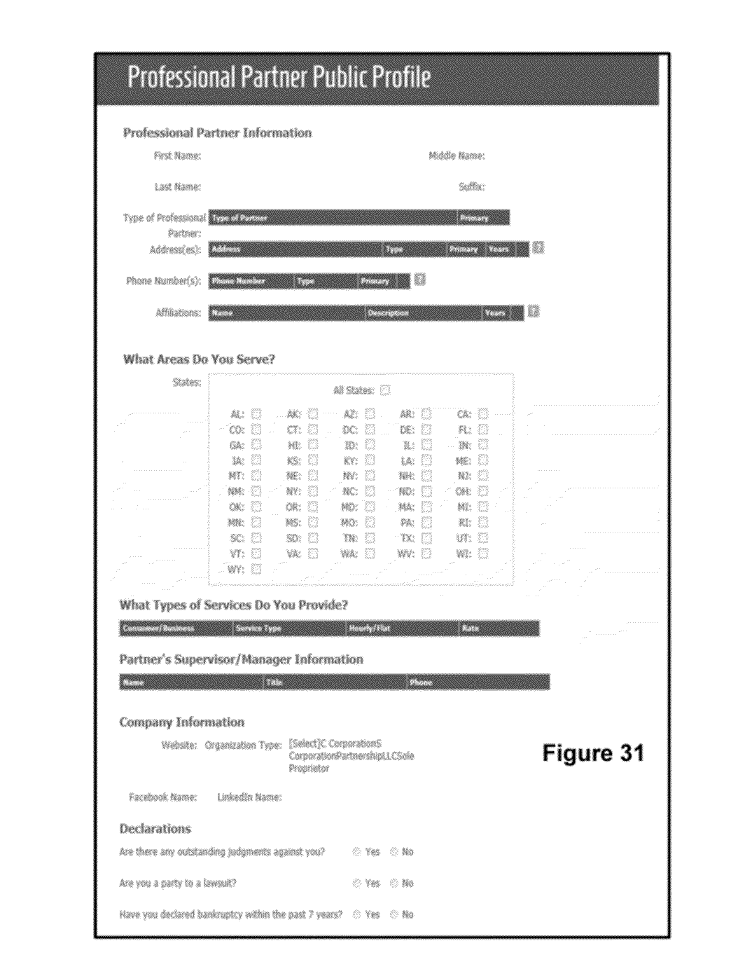

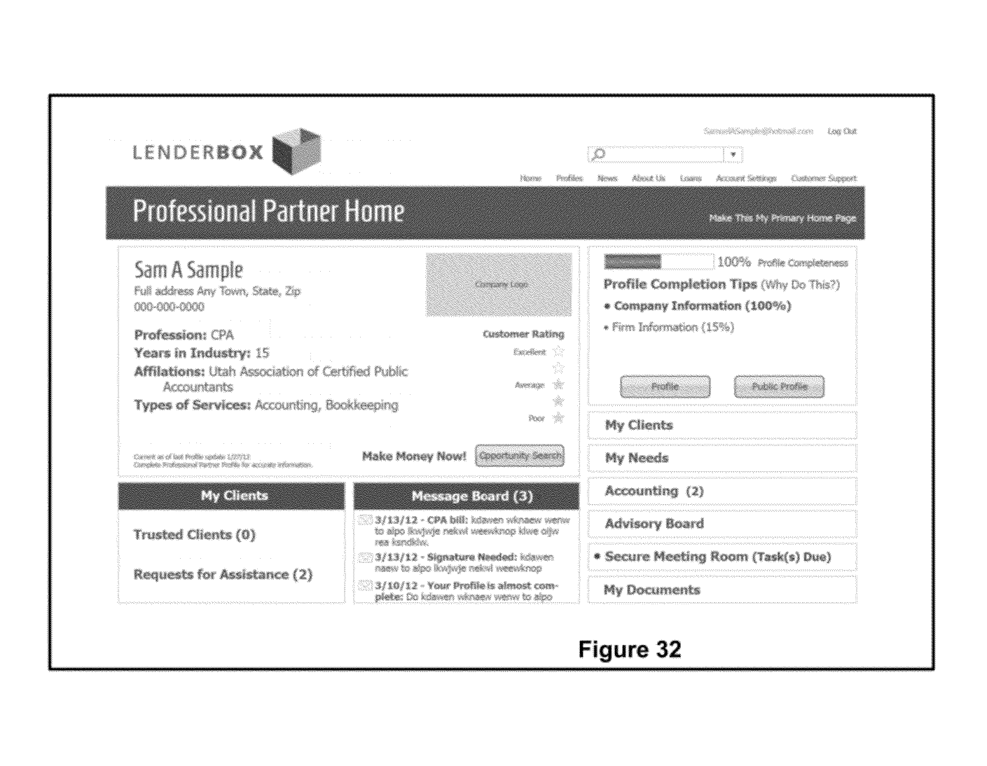

The displays for the professional partner are similar but oriented toward the primary focus of the professional partner, i.e., assisting consumer and business users in completing transactions with lender users. Representative screen displays showing the graphic user interfaces associated with the professional partner user's partner profile are shown in FIGS. 28, 29(a)-29(b), and 30. Once the profile is completed, the information will be displayed on the professional partner user's home page as shown in FIG. 32. Public profile information for the professional partner user will made available to users of the system in a format such as that shown in FIG. 31.

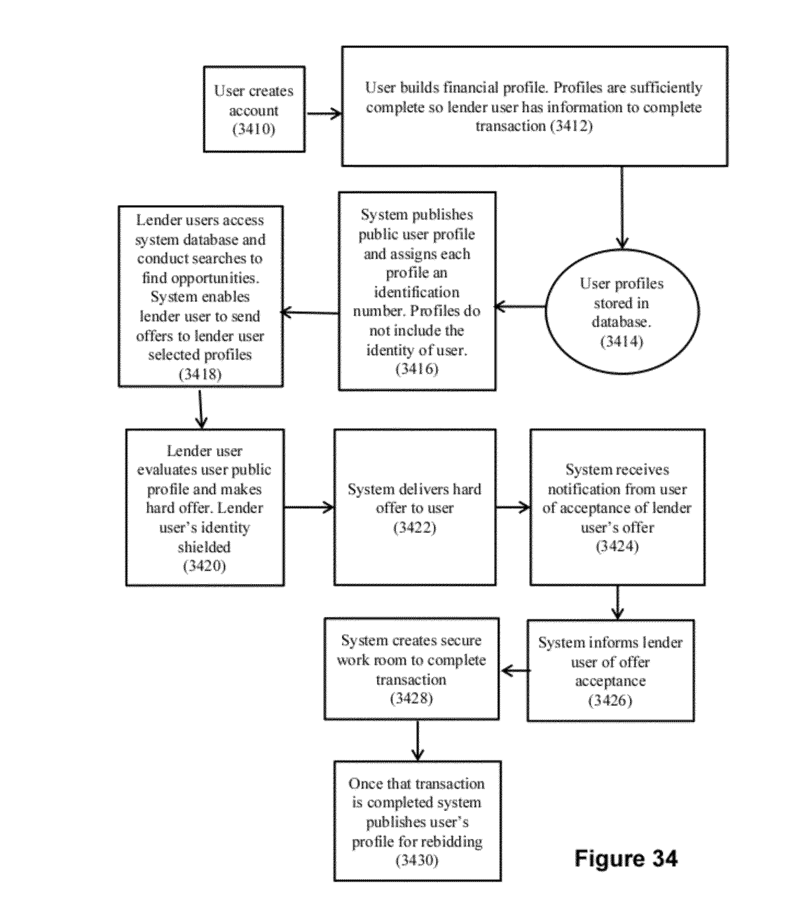

FIG. 34 provides an overview of the methods involved in interacting with the system and completing a transaction. After a user creates an account 3410, the user builds a financial profile 3412. The user's financial profile 3412 is sufficiently complete so that a lender has information to complete a transaction. The user's profile is stored in a database 3414. As will be described in greater detail below, the system publishes a public version of the user's profile and assigns each profile an identification number 3416. The user public profile has sufficient metrics and other information to enable a lender user to evaluate risk and make a hard offer. The user's public profile nonetheless does not include individual characteristics so that anonymity in the process may be preserved. However, the user's public profile provides the lender user with indications that the user is ready to enter into a transaction. Preferably, the user's public profile includes indicators that all of the documents and other information needed for completing a transaction are ready to be produced to a lender user upon a user's acceptance of a lender user's offer. In some cases, the parties may place money into escrow as a sign of good faith in completing a transaction. Thus, a lender user may look at a public profile of a user and immediately see that the user is ready, able, and willing to enter into a transaction. Because the user's profile is complete with the information and documents needed to consummate the transaction, the lender user need not provide substantively new requirements of information or documentation in order to consummate the transaction. Thus, to close a deal the lender user need only corroborate the information and/or documentation associated and ready to be produced with the user profile. Additionally, the system may have programming to enable the administration of a transaction involving an escrowed sum of money to be transferred between parties if a party fails to meet its obligations during the closing period. For example, the system may be configured to deduct from a financial account associated with a user profile earnest money—i.e., the lender sacrifices earnest money if it fails to close an accepted hard offer where the borrower's (consumer user/business user's) information/documentation was corroborated. Lender users access the system database and conduct searches to find opportunities 3418.

The system enables a lender user to send offers to lender user selected profiles. The lender user may then evaluate credit worthiness and decide whether to make a user an offer 3420. While a user may be specifically interested in a credit card, or a home loan, the lender user will have the opportunity via the system to review the user's entire public profile to determine credit worthiness and whether making an offer to the user is warranted. The system enables lender users to send offers to lender user selected profiles. The lender user evaluates the user public profile and makes a hard offer. The lender user's identity is shielded. The system delivers a hard offer to the user 3422. The system receives notification from the user of acceptance of the lender user's offer 3424. The system then informs the lender user of offer acceptance 3426. The system then creates a secure work room to complete the transaction 3428. Once the transaction is completed, the system publishes the user's profile and completed transaction on the system and makes it available again to other lenders who may be interested in making an offer to the user 3430.

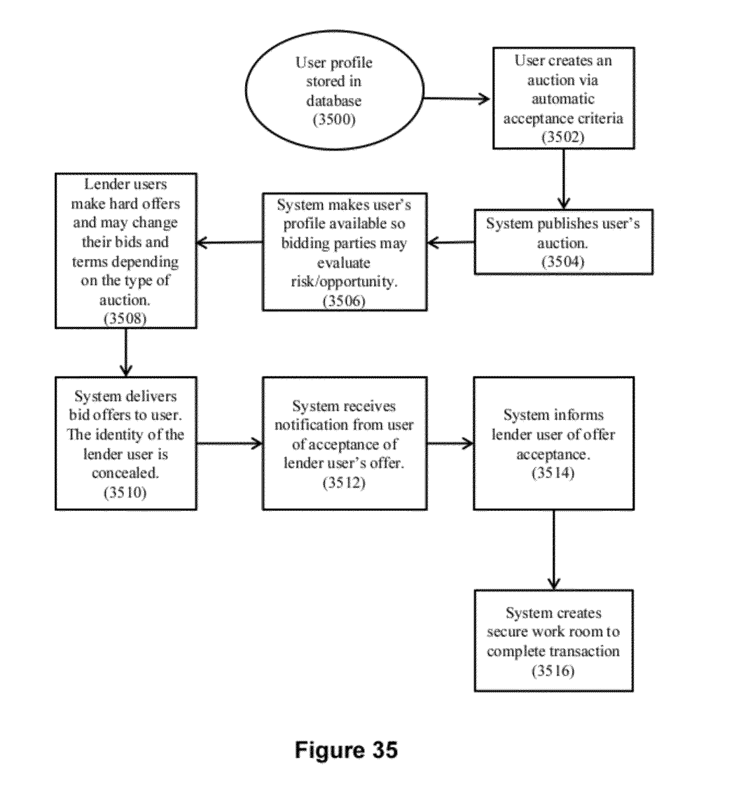

Referring to FIG. 35, the system may be also configured to allow a user to create an auction via automatic acceptance criteria. After the user creates a profile 3500, the user may create an auction with automatic acceptance criteria 3502. The system publishes the user's auction 3504. The along with the auction, the system publishes the user's profile so bidding parties may evaluate risk and opportunity 3506. The user's profile is stored in the database 3500. Lender users may bid on the opportunity and may make hard offers, and further may change their bids and terms depending on the type of auction 3508. The system delivers the bid offers to the user 3510. The identity of the lender user is concealed. The system receives notification from the user of acceptance of a lender user's offer 3512. The system informs the lender user of offer assist acceptance 3514. The system then creates a secure work room to allow the parties to complete the transaction 3516.

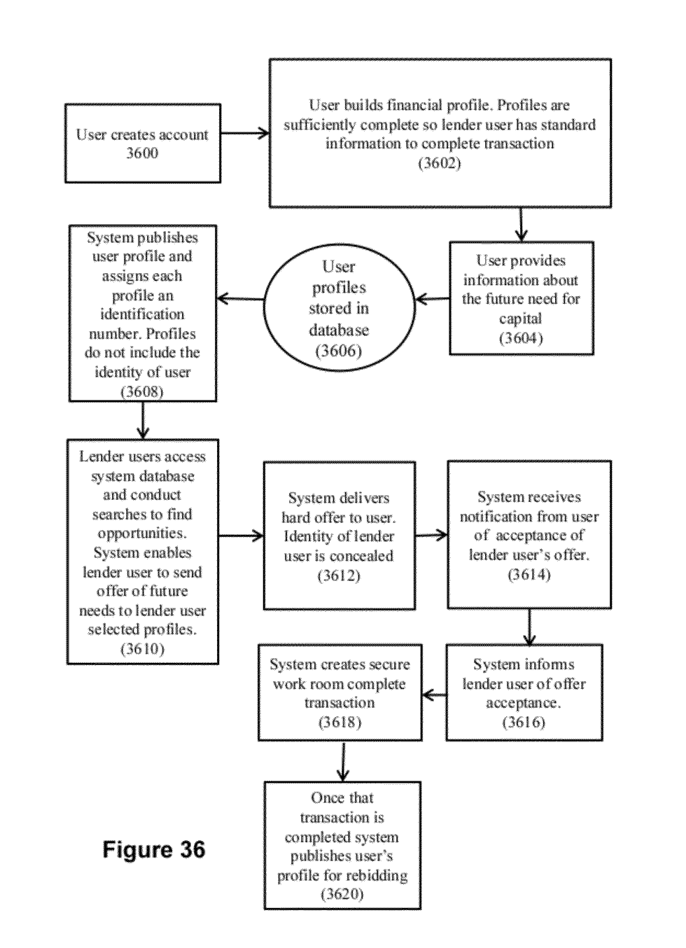

FIG. 36 provides an illustration of the process by which a user, for instance a business user, may create an opportunity based upon future need for capital. After the user creates an account 3600, the user builds a financial profile 3602. The financial profile is sufficiently complete so that a lender has standard information needed to complete the transaction. Included among this, the user provides information about a future need for capital 3604. The business user's profile is stored in a database 3606. The system publishes the user profile and assigns each profile an identification number 3608. The profiles do not include the identity of the user. The lender users access the system database and conduct searches to find opportunities based upon future needs of capital 3610. The system enables the lender user to send an offer of future needs to lender user selected profiles. The system delivers the hard offer to the user and the identity of the lender s concealed 3612. The system receives notification from the user of acceptance of the lender user's offer 3614. The system creates a message to send to the lender user of the offer acceptance 3616. The system creates a secure work room to complete the transaction 3618. Once the transaction is completed, the details of the completed transaction are updated in the user's profile and the user's profile is published on the system and may be rebid by other lenders 3620.

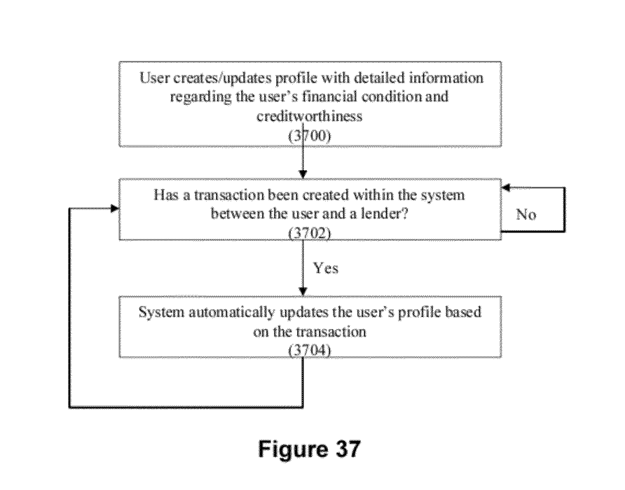

FIG. 37 provides a flow chart illustrating the process in which a user's profile is automatically updated. The user creates/updates a profile with detailed information regarding the user's financial condition and creditworthiness 3700. If a transaction has been created within the system between the user and a lender 3702, the system automatically updates the user's profile based on the transaction 3704.

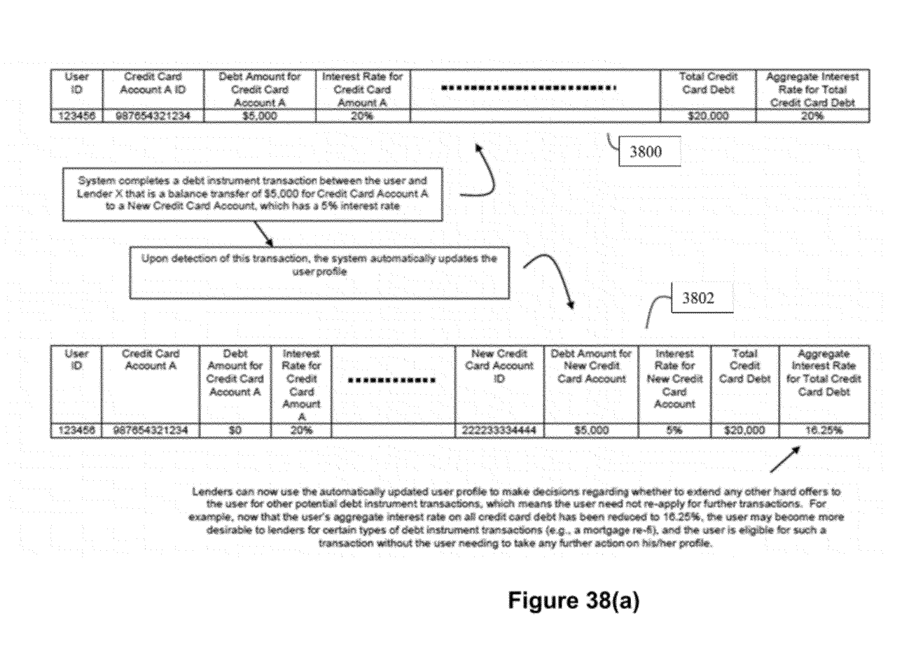

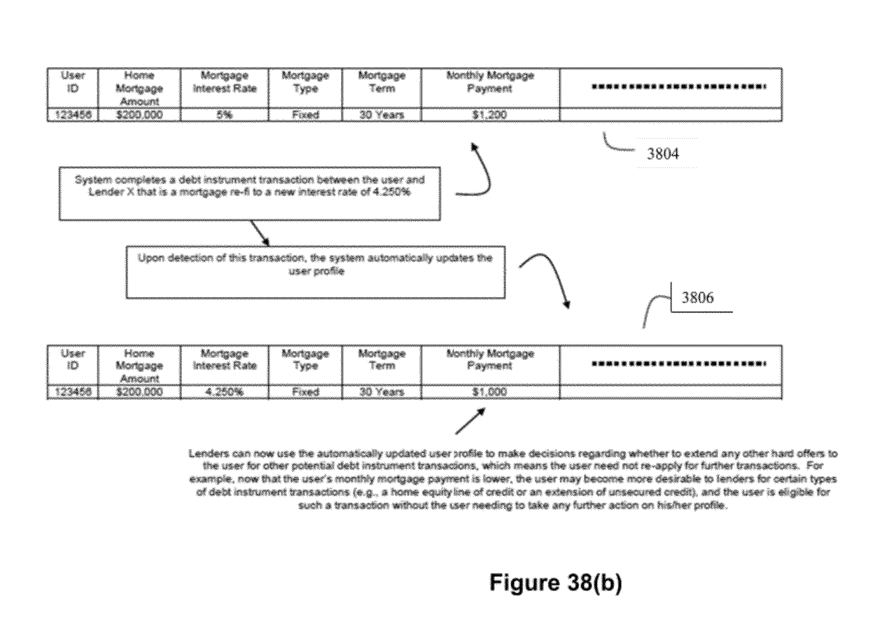

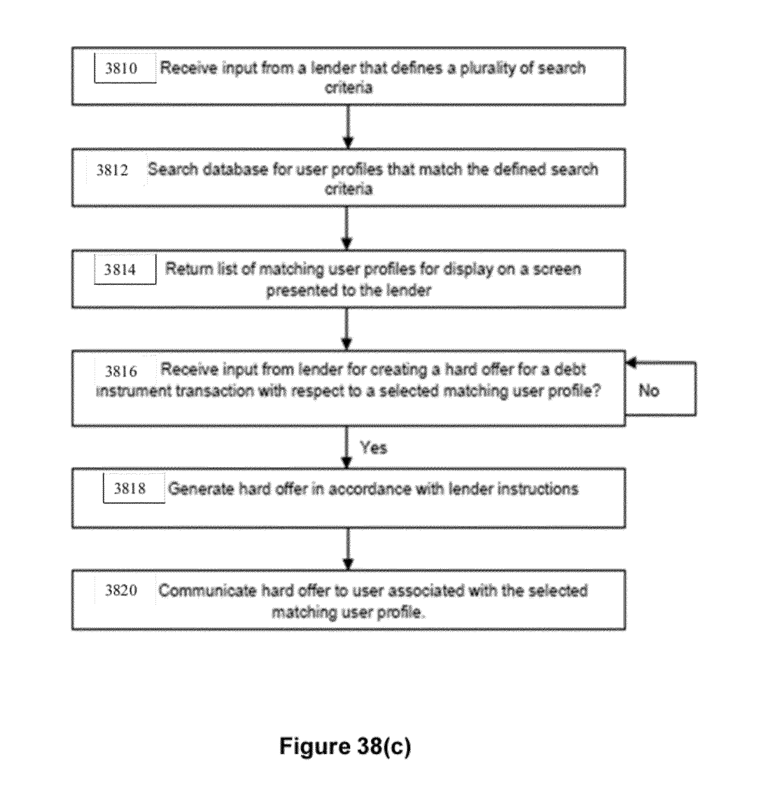

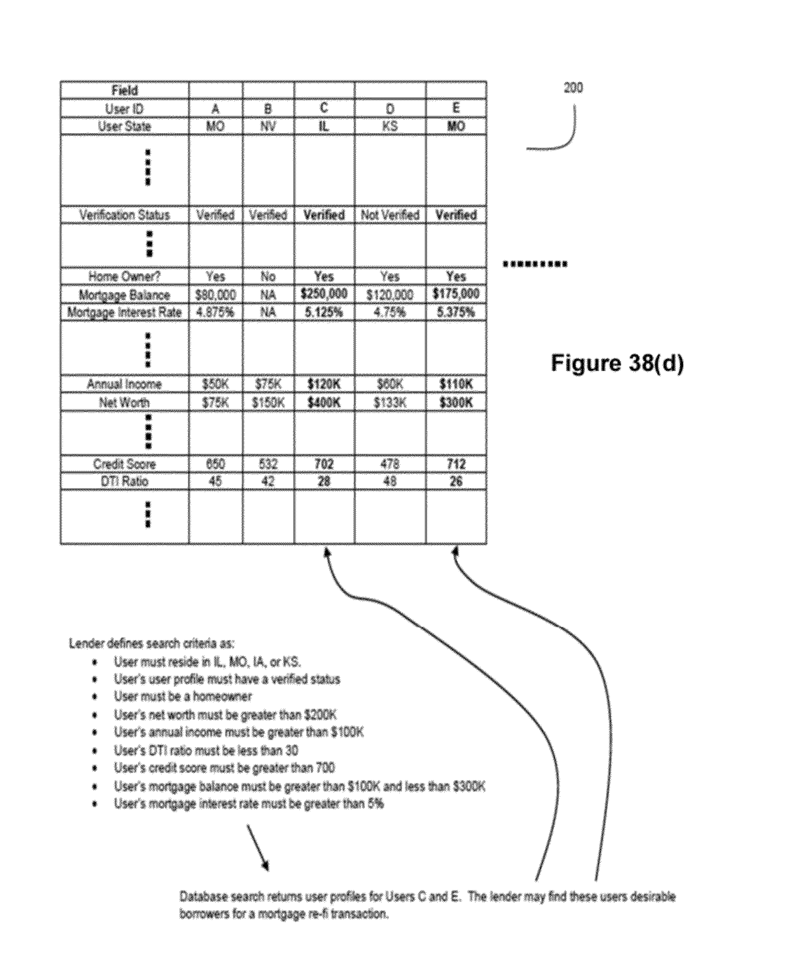

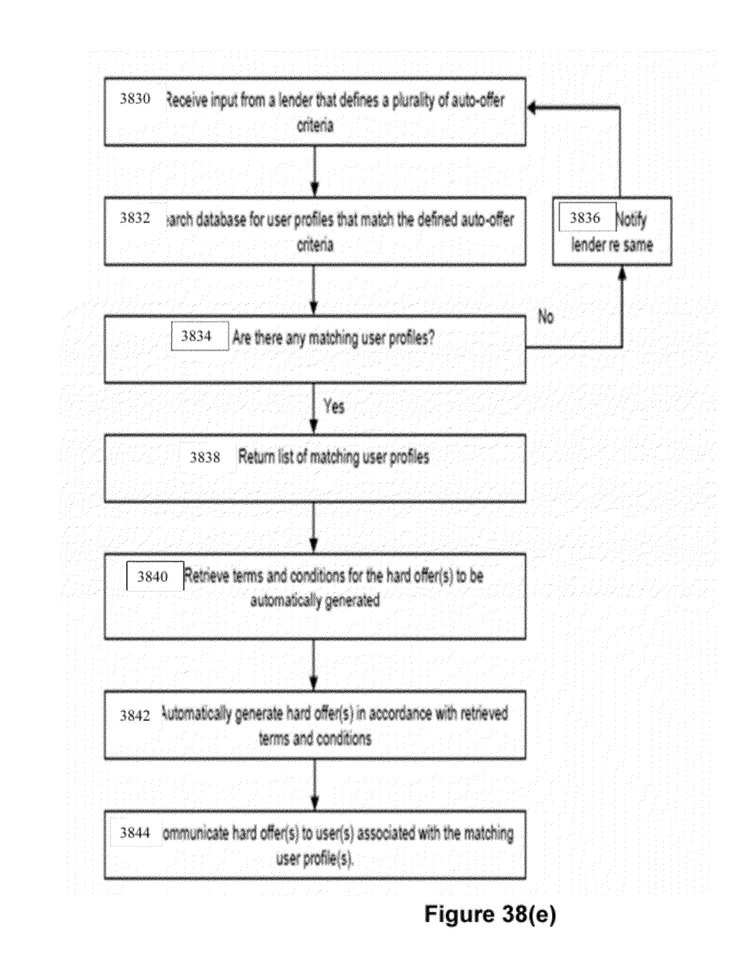

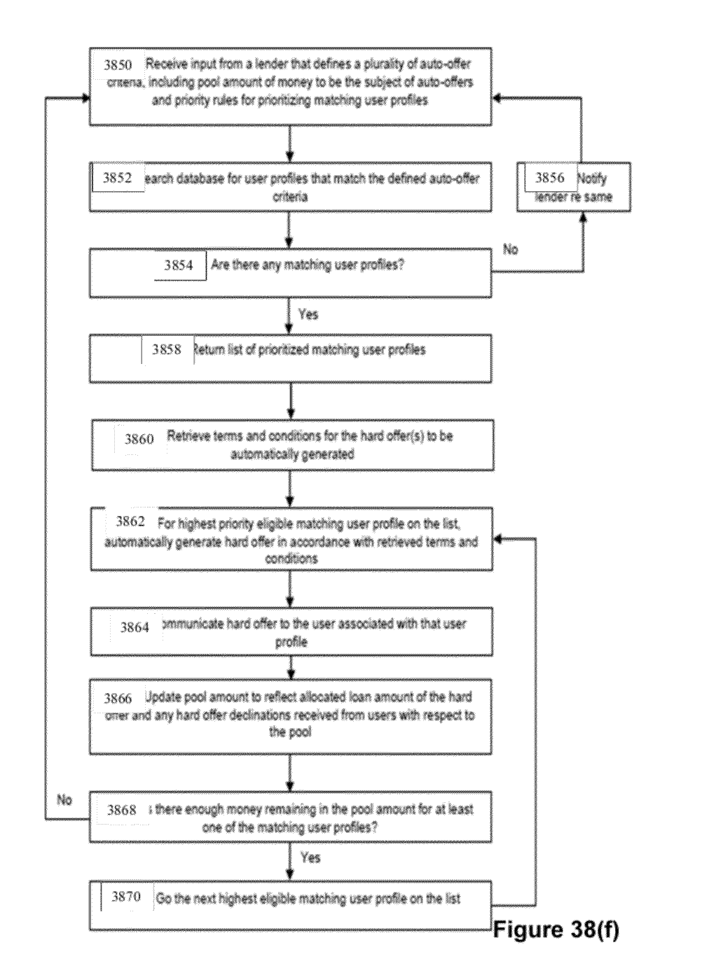

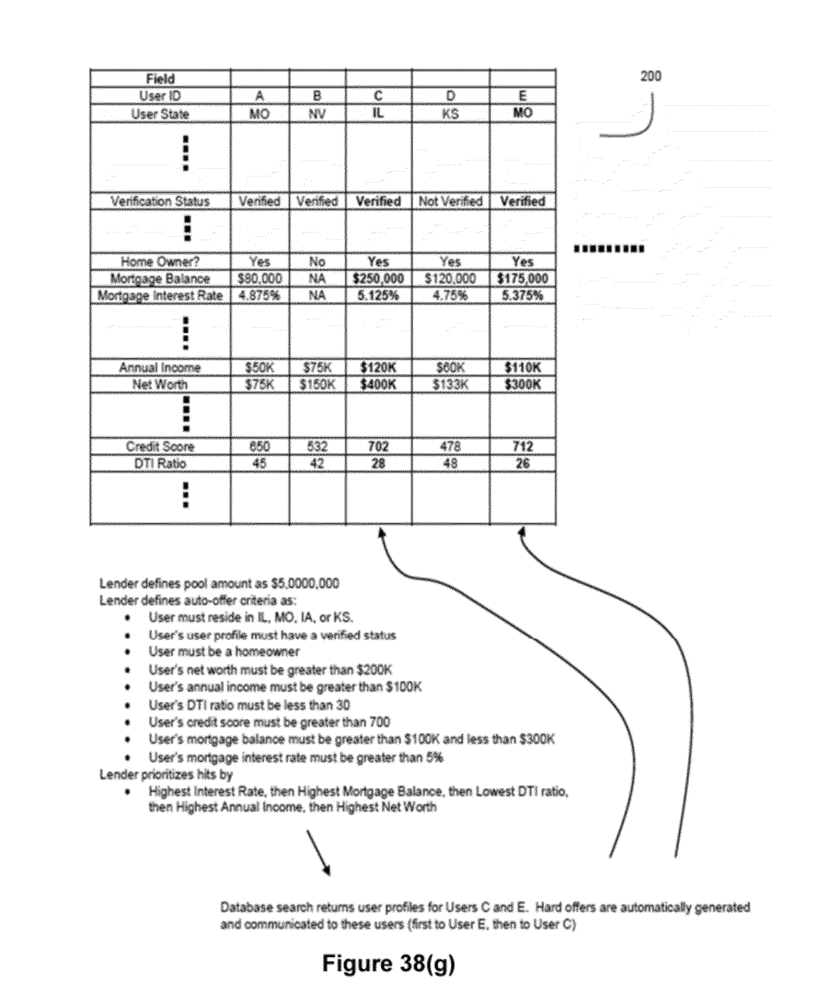

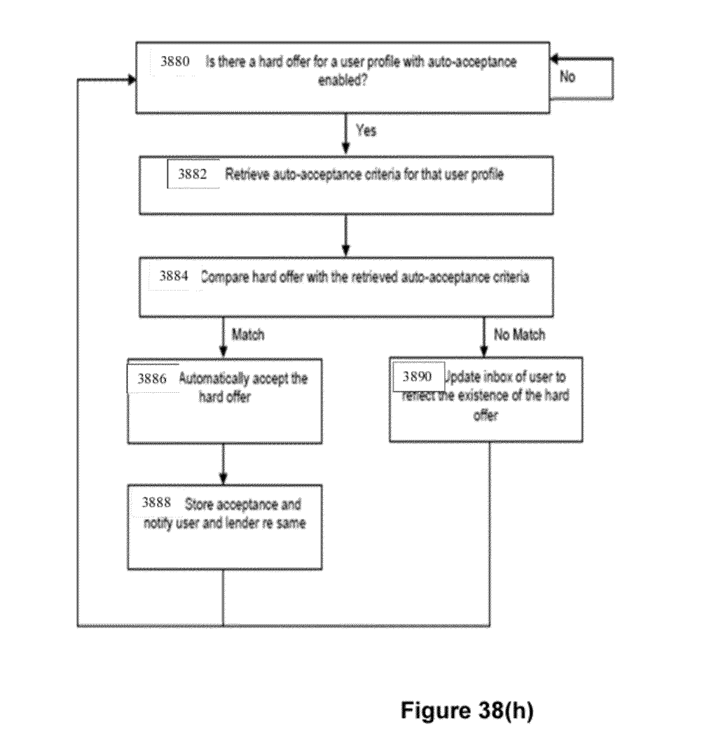

FIGS. 38(a)-38(b) illustrate methods in which the system automatically updates a user's profile upon completion of a transaction. For instance, referring to FIG. 38(a), the system completes a debt instrument transaction 3800 between the user and a lender regarding the transfer of a balance on a credit card. Upon detection of completion of the transaction, the system automatically updates the user's profile with respect to the new credit card information 3802. Lenders can then use the automatically updated user profile to make decisions on whether to extend any additional hard offers to the user. These may include offers to renegotiate credit card rates or other debt instrument transactions. Thus, the system is enabled to allow the lender to determine whether a user is eligible for an additional transaction without the user needing to take any further action to update his or her profile. FIG. 38(b) shows a similar illustration with respect to a home loan 3804,3806.

FIGS. 38(c)-38(h) illustrate a program that may be enabled in the system to correlate data structures with search criteria. As will become evident in the description that follows below, the system may be enabled to receive input from a lender that defines a plurality of search criteria 3810. Programming may be configured to search the database for user profiles that matched defined criteria 3812. Programming may be configured to return a list of matching user profiles for display on a screen presented to the lender 3814. The system may then be configured to receive input from a lender for creating a hard offer based upon a selected matching user profile 3816. A hard offer then may be communicated to the user via the system to allow the user the opportunity to accept the offer and complete the transaction 3818. Referring to FIG. 38(d), an illustration is provided for a lender's search criteria and corresponding data structures 200 matching the criteria stored in the database. As will be described in greater detail below, the system may be automated to provide hard offers to users with matching profiles. FIG. 38(e) provides an illustration of the process by which the system may be configured to automatically generate hard offers in accordance with retrieved terms and conditions provided by the lender user. FIG. 38(f) provides a further illustration of a lender user automatically generating hard offers to users based upon a pool amount of funding that may be loaned. FIG. 38(g) provides a further illustration of lender user defined criteria including a loan pool amount indicated as $5 million. Based upon the lender defined auto offer criteria, matching profiles are assigned a priority and hard offers are automatically generated and communicated to the highest priority users. FIG. 38(h) illustrates the process by which a user may accept a hard offer from a lender.

With the following overview of the system in place, each of the series of displays for each of the different users will be discussed below in greater detail to illustrate the functionality and advantages of the system. Each of the series of displays for the each different user will be discussed below in greater detail to illustrate the functionality and advantages of the system. The discussion is intended to be illustrative and not limiting in any sense. It should be presumed that functionality provided in the context of one particular user may be provided in the context of another user unless expressly stated otherwise.

### “Consumer User”

The system has programming configured to present the display of a series of screens that allow the consumer to build a personal profile in the system. The series of screens may include the following: “Personal Info”, “Work/Income”, “Credit Card(s)”, “Auto(s)”, “Real Estate”, and “Assets/Liabilities”. Each of these will be discussed in greater detail below.

### “Personal Profile”

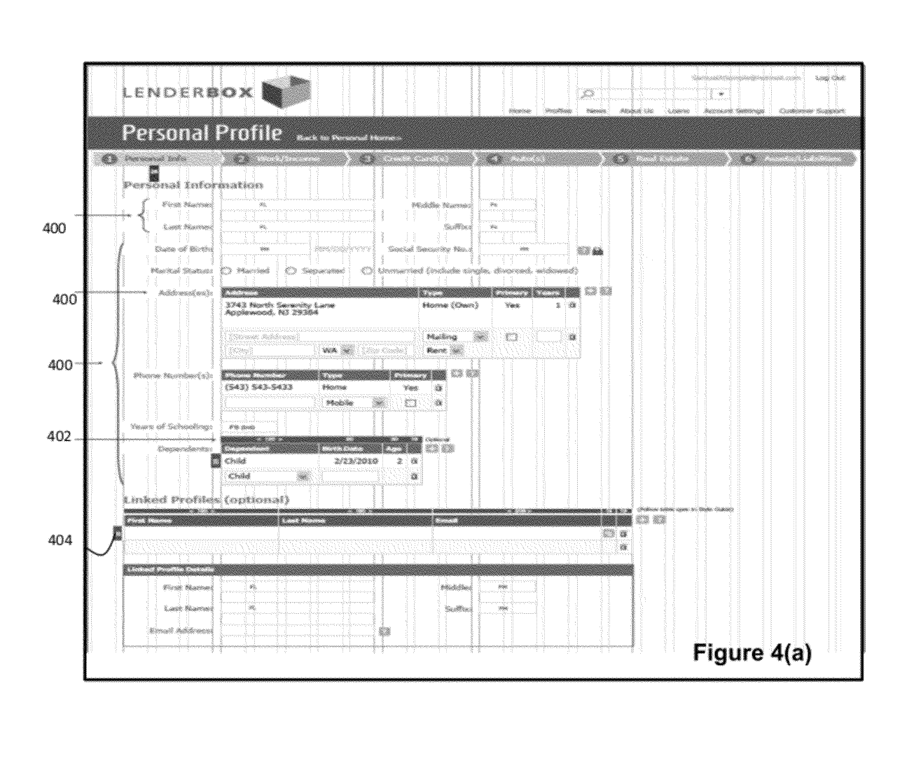

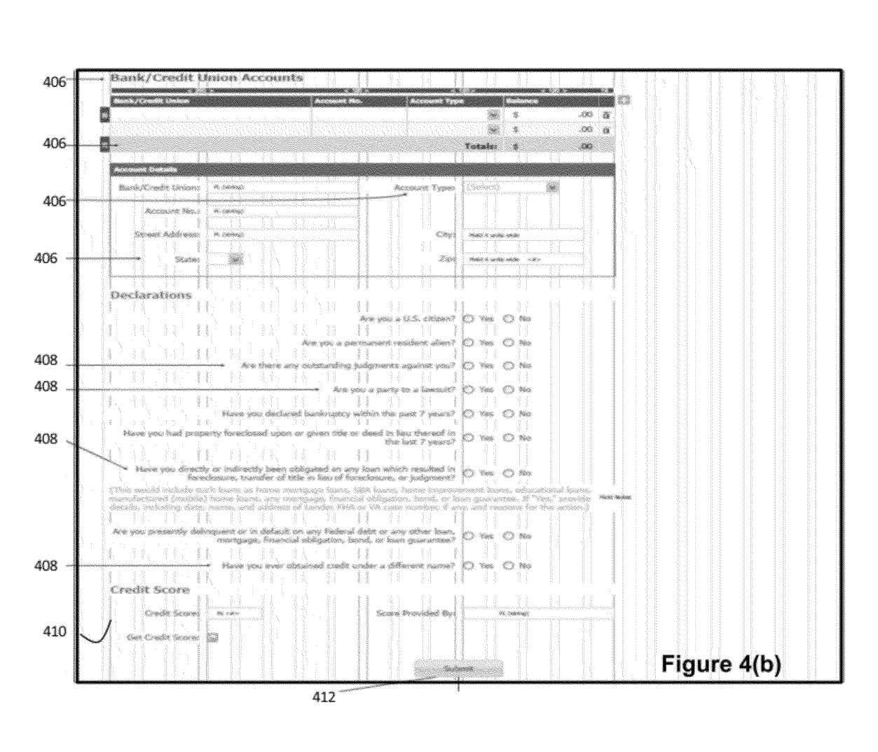

Referring to FIGS. 3, 4(a) and 4(b), the system may have programming configured to enable presenting a series of displays that allow the consumer user to input personal profile information into the system. The personal profile screens include inputs to allow the consumer user to input their personal information 400 into the database for use in the various applications described below. As will be discussed below, after each profile is constructed, a public profile is generated and the consumer user is assigned a profile number that links to their personal public profile. The profile number allows a consumer user to be identified while hiding the consumer user's identity. The public profile will have sufficient metrics and other information and indication of documents available to allow lender users to communicate hard offers. The screen displays are oriented at collecting information and documents sufficient to allow the consumer user to enter into a transaction with the lender user out the need for additional documents or underwriting requirements. Thus, the lender user may review the consumer's public profile and immediately identify whether consumer user matches the lender user's requirements for extending a loan, including whether the consumer has the documentation and other information for consummating the transaction without delay.

The personal information 400 may include: first name, middle name, last name, date of birth, address(es), and phone numbers. Radio buttons may be displayed for the user to indicate marital status (i.e., married, separated, unmarried (include single, divorced, widowed). The programming may also be configured to provide fields to allow the consumer user to input information regarding dependents 402.

The programming may also be configured to provide fields to allow the consumer user to link their profile 404 with another consumer user on the system. Linking profiles allows users of the same household or family to link their profiles. Consumer users may copy information from a linked profile into their profile to avoid re-entering shared information. For instance, a husband and wife may specify that their profiles be linked. This will enable information from the linked profile to be auto-populate several of the screens that follow, as applicable. The programming may also be configured to provide a display with additional fields to caution the consumer user about linking profiles. For instance, a display may state that if the consumer user agrees to link profiles, information from the requested linked profile will be copied to the consumer's profile. If consumer does not agree, the dialog box may close without changing the consumer's profile. When profiles are linked, all non-contact information may be copied from the requested linked profile. When the copy is complete, a dialog box may be displayed identifying what information was copied over to the consumer's profile. For instance, all assets, accounts, liabilities, etc., may be listed by type and then name.

The programming may be configured to enable the sending of a message via the system to other user specified by the consumer user as the requested linked profile. The message may be in the form of an invitation with a link so that the other user may accept or decline status as a linked profile with the consumer user. The consumer user may provide the email address of the other user to facilitate delivery of the message. The programming may be configured to present a display in the form of a table showing a status of the request to link a profile. For instance, a status table may be provided to indicate to the user the status of any requested linked profiles. For instance, the programming may be configured to present a display status with the label pending after the last name of the person for which a linked profile was requested until that user accepts or approves being a linked profile. Once accepted, the programming may be configured to eliminate the label pending from requested link profile's name.

If the other user accepts or approves of being a linked profile, the programming may be configured to display the name of each user in their personal information page under linked profiles. The programming may be configured to then enable a message to be sent to consumer user that requested the linked profile letting the consumer user know that the request to link profiles has been accepted. If the other user declines status as linked profile, a message is sent to consumer user that requested the linked profile letting the consumer user know that the request to link profiles has been declined. The programming may be configured to enable the message to be provided via the messaging system associated with the system or via a third party email service.

The programming may also be configured to provide fields to allow the consumer user to input information from their bank and/or credit union accounts 406. The fields may appear in chart form. Information from the bank/credit union accounts table may be used to populate certain fields in the assets/liability screen to be discussed below. Programming associated with the bank/credit union accounts table may be configured to total all of the balances in the various accounts. The total may be added to other assets and populated to the total assets field displayed on the consumer user's personal home page.

The programming associated with the bank/credit union accounts table may be configured to provide a master/detail function. In other words, clicking on the row displays the detailed entry fields in the bank/credit union section below the table. The programming may also be configured to provide the display with the following fields: bank/credit union name, account type, account no., street address, and state. The programming may also be configured to provide account type information via drop down with menu choices such as: savings, checking, money market, and retirement.

The programming may also be configured to provide fields to allow the display of declarations used in applying for loans or credit cards 408. For instance, as shown in the drawings, the display may be presented with yes or no radio buttons. If a yes radio button is selected, the programming may also be configured to present a display with an explanatory field for the consumer user to provide additional information.

The programming may be configured to also provide fields to allow a consumer user to input their credit score to the system 410. The programming may also be configured to present a display button to allow the consumer user to request a credit score from a credit score provider (i.e., Experian, FICO, Transunion) via the system.

The programming may also be configured to provide fields to allow the user to save information to the system database. For instance, as shown in the drawings, a save profile button 412 is presented. Clicking the save profile button saves the changes to the database and notifies the consumer that the profile has been saved even if only partially completed. Information will then be populated throughout the system as may be required. For instance, information may be populated other screens in the system.

### “Employment and Income Information”

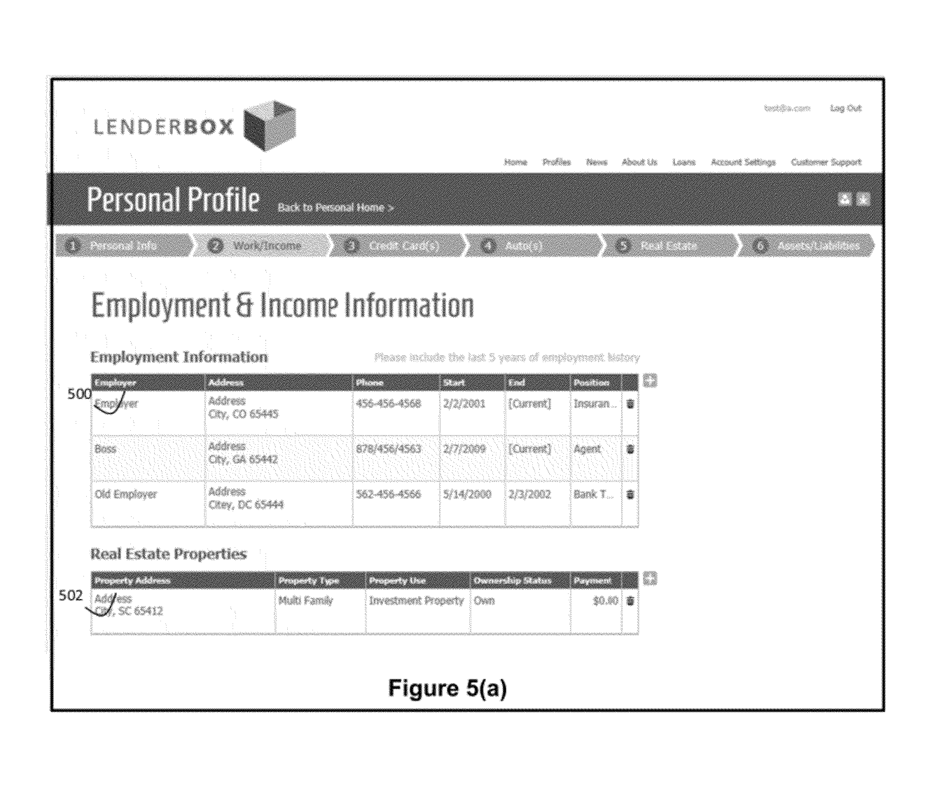

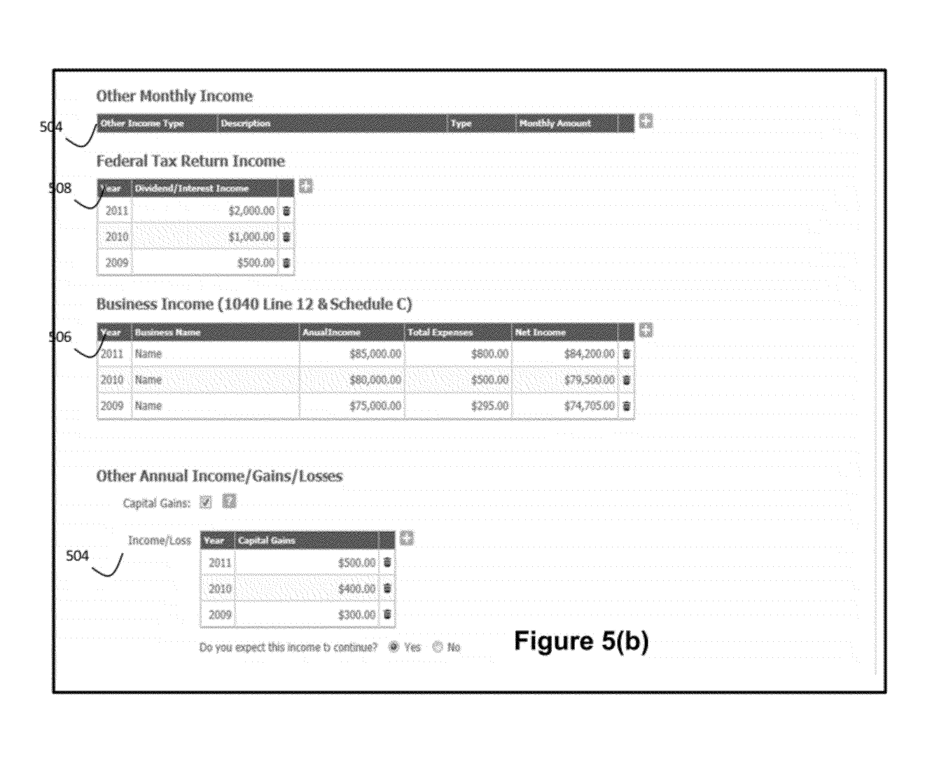

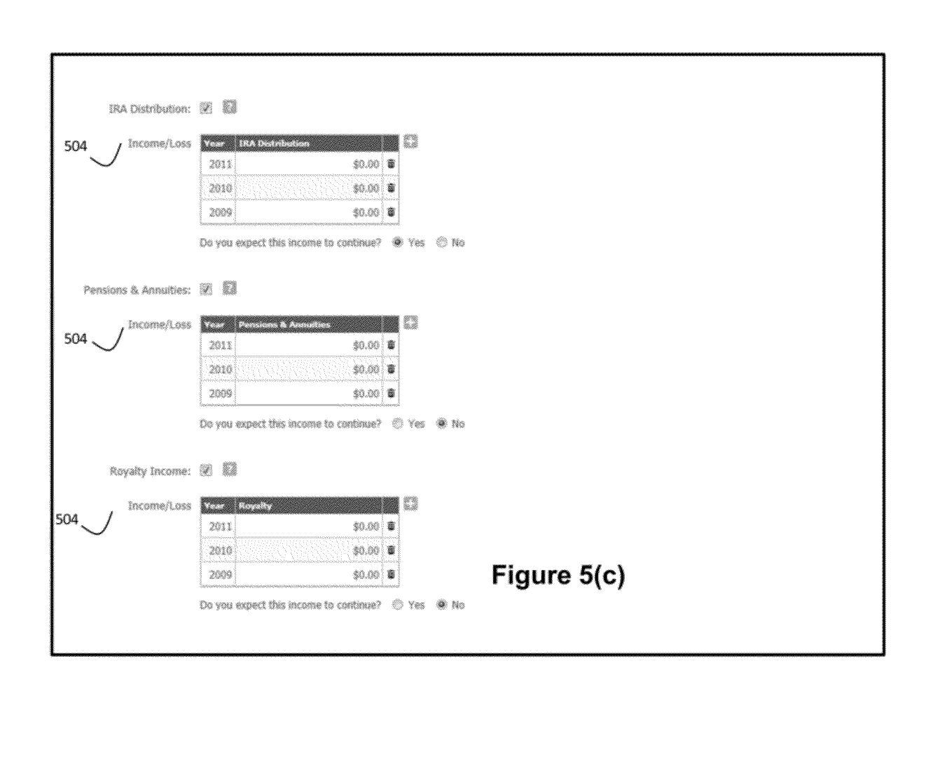

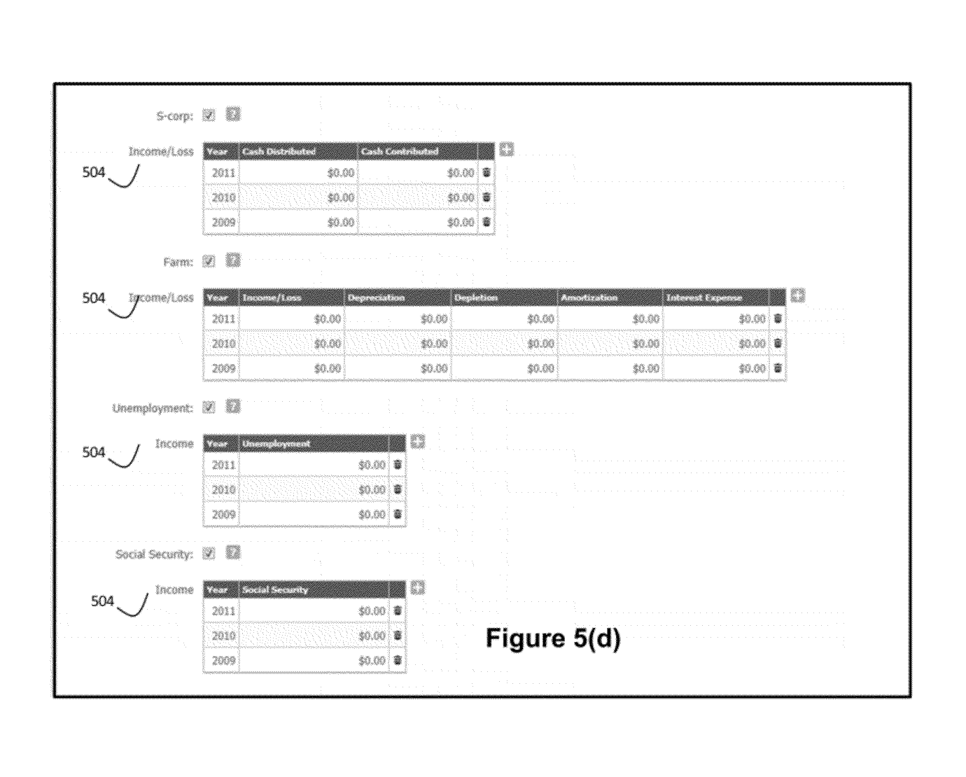

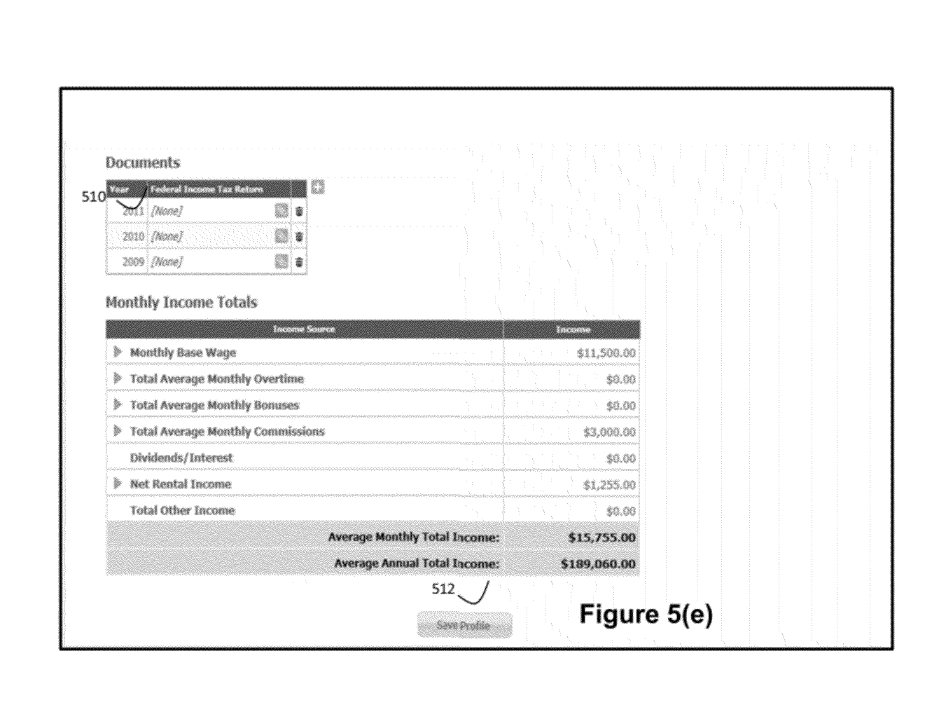

The system may also include programming to allow the consumer to input employment and income information. Referring to FIGS. 5(a)-5(e), the system may be configured to present a series of displays with fields 500 allowing the consumer user to input information regarding employment and income. The programming may be configured to present their employment history in the form of a table with master/detail format as discussed above. The system may also be configured to present a display 502 to allow the consumer user to input information about real estate properties they may own and mortgage payments associated with those properties. The system may also be configured to enable the consumer user to input other information regarding monthly income 504. The system may be configured to enable the consumer user to upload dividend and interest income as well as business income 506. The system may also be configured to enable the consumer user to upload federal income tax returns 508 and to upload pay stubs and other information 510 needed for the consumer user to apply for credit cards, auto loans, or home loans. The system may also be configured to cross-check the consumer user's inputted information from third party reporting agencies. For instance, the system may interface with PAYCHEX to verify the consumer user's stated income.

The programming may also be configured to provide fields to allow the user to save the information to the system database. For instance, as shown in the drawings, a “save profile” 512 button is presented. The programming may be such that clicking the “save profile” button saves the changes to the database and notifies the consumer user that the profile has been saved even if only partially completed. Information will then be populated throughout the system as may be required.

### “Credit Card”

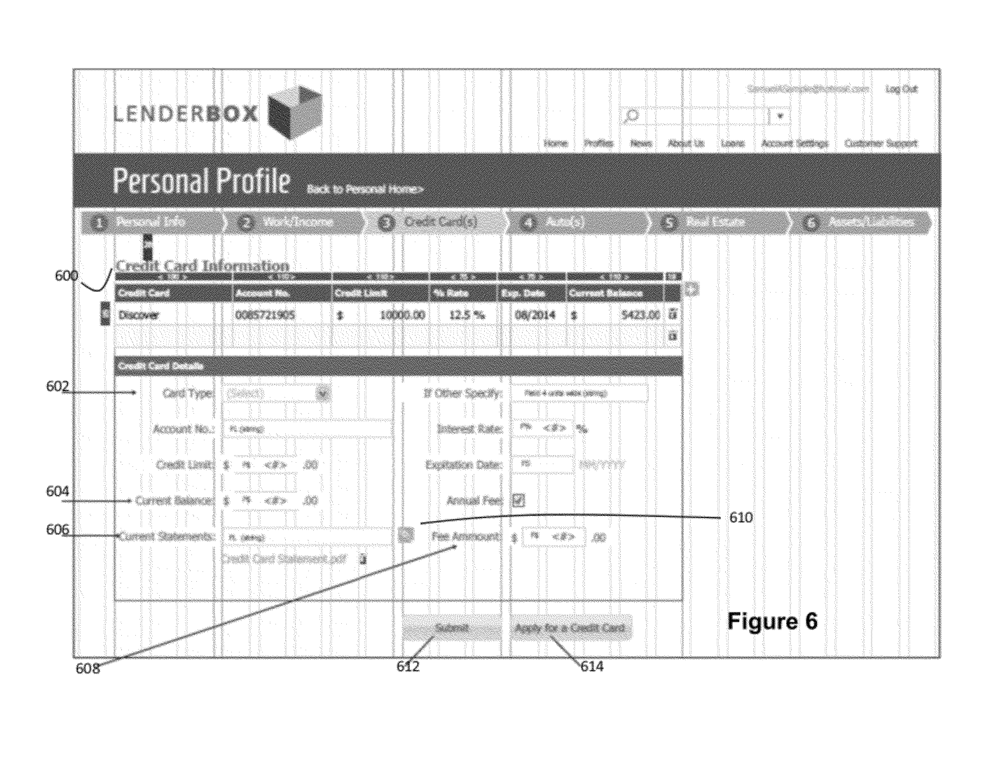

The system may also include programming to allow the consumer user to apply for a credit card. As shown in FIG. 6, the system includes programming to generate a graphic user interface to allow the user to input information into the system needed to apply for a credit card. The credit card application screens include inputs to allow the consumer user to apply for a credit card. This is done seamlessly to the consumer. The standard information needed for completing the application is displayed in a familiar graphic user interface and inputs from fields from the prior personal profile screens are to complete baseline information so that the consumer user need only complete specific requirements for the credit card application. For instance, the credit card application specific inputs may include asking the consumer user for their prior credit card information 600. This may include a credit card type drop down list 602 (“Card Type: Visa, Discover, Master Card, American Express, Other”) and input for the credit card account number, current balance 604, current statement amount 606, and fee amounts 608. A field may enable the consumer user upload a current statement 610 so that potentially interested financial institutions may verify inputted information. Other information related to the consumer user's current account may expiration date and interest rate.

The programming may be configured to enable the consumer user to save their information. For instance, as shown in the drawing, clicking the submit button 612 populates some of the information from the previously completed “Personal Profile” even if only partially filled out. All of the information from the credit card application, including prior information from the personal profile pages is available for display when the consumer connects to the credit card accounts icon on the consumer user's personal home page. For instance, the programming enables current balance information inputted through the credit card interface screen to auto populate debt information and other display fields showing the consumer's debt. The programming may also be configured to enable the consumer user to save information to the system. For instance, clicking the submit button 612 also saves the information inputted at the display even if partially completed so the consumer user may return to the screen and complete any remaining information. The programming may also be configured to enable the consumer user to apply for a credit card via the system. For instance, clicking the apply button 614 provides the credit card and personal profile information to financial institutions in the form of a submission described below in greater detail.

### “Auto Loan”

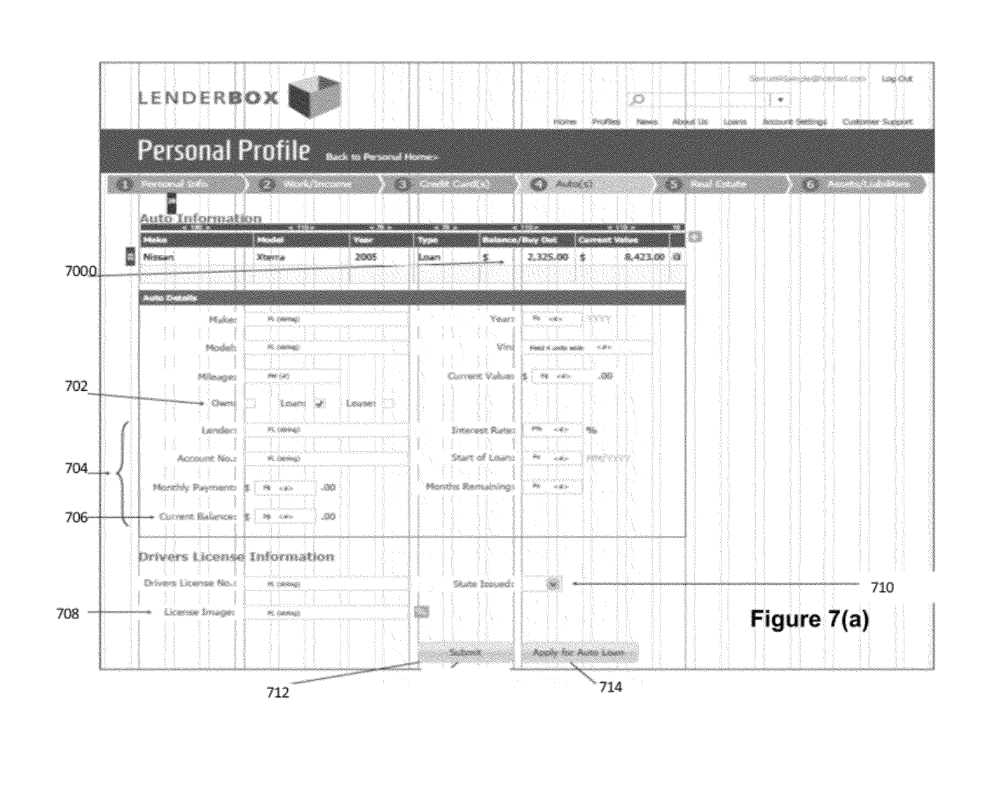

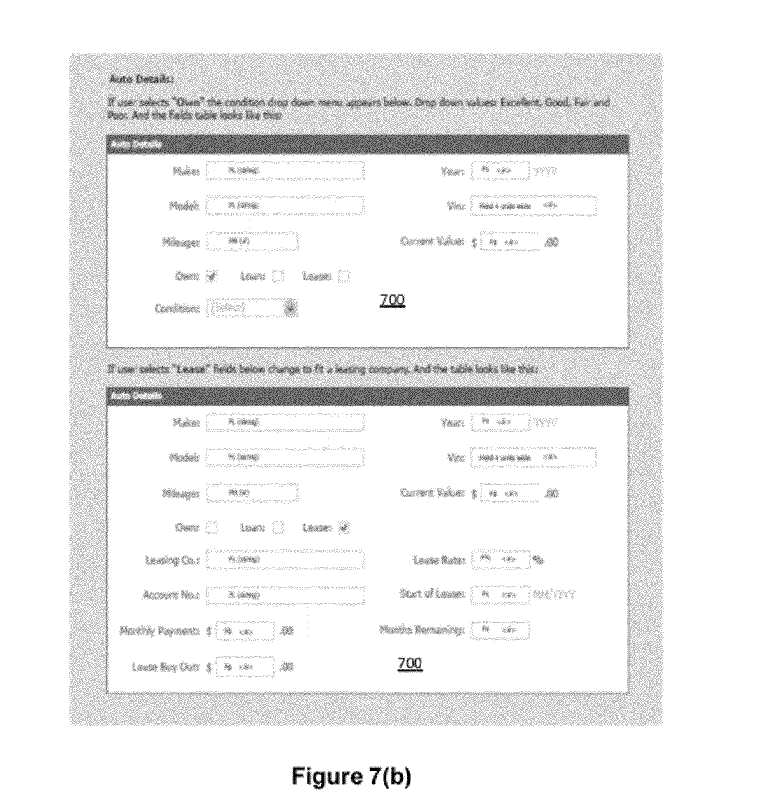

The system may also include programming to allow the consumer user to apply for an automobile loan. For instance, as shown in FIGS. 7(a)-7(b), the programming may be configured to present a graphic user interface to allow the consumer user to input information needed to complete an automobile loan. Preferably, this is done seamlessly to the consumer user. The standard information needed for completing the application is displayed in a familiar graphic user interface and inputs from fields from the prior personal profile screens are to complete baseline information so that the consumer user need only complete specific requirements for the auto loan application. For instance, the graphic user interface may allow the consumer user to input information about their current automobiles 700. The programming may be configured to present displays to allow the consumer user to indicate whether its automobiles are loans or leases in the balance/buy out field 702. If the consumer user owns their auto, they may leave this field displays blank. If consumer user has a loan, the loan amount may be inputted. If the consumer user has a lease, the lease buy out amount may be inputted. The graphic user interface may include other fields 704 to allow the user to input information about their current automobiles, including the year, make, model, mileage, vehicle identification number, current value, and current lienholder information. Certain of the fields may or may not be displayed depending upon the users selection of either own, loan, or lease. FIG. 7(b) shows examples of other screens that may be displayed depending upon the consumer user's selection of own or lease. The programming may also be configured to enable certain of the fields to auto populate. For instance, the current balance field 706 will auto populate from debt information inputted from fields on the personal home page.

The graphic user interface also includes inputs 708 to allow the user to input driver license information and a copy of a driver's license may be uploaded to the system for verification by lender institutions. A field 710 may be displayed for indicating the state of insurance.

The programming may also be configured to enable the consumer user to save information to the system. For instance, clicking on the submit button 712 populates some of the information from the previously completed personal profile even if only partially filled out. All of the information from the auto loan application, including prior information from the personal profile pages is available for display when the consumer connects to the credit card accounts icon on the consumer user's personal home page. For instance, auto loan balance information inputted through the auto loan interface screens may be used to auto populate debt information and other display fields showing the consumer's debt. The submit button also saves the information inputted at the display even if partially completed so the consumer may return to the screen and complete any remaining information. Clicking the apply button 714 provides the auto loan and personal profile information to financial institutions.

### “Real Estate”

The programming may be configured to allow the consumer user to input information about their real estate holdings including mortgage information and any income derived from real estate, i.e., rent. For instance, as shown in the drawings, the programming of the processor generates a display 800 showing a schedule of real estate owned by the consumer user. The programming may be configured to allow for a display in the form of a table with master/detail function. In other words, clicking on the row displays the detailed entry fields in the real estate details section below the schedule. Multiple properties may be added to the schedule of real estate owned using the plus button 802. The real estate details fields include inputs to allow the consumer to describe the real estate 804. These may include property address(es) 806, and radio buttons for indicating ownership status as rent 808 or own 810. The programming may also be configured to present a drop down menu 812 for the consumer user to indicate the type of real estate. Real estate type options may include: home, mobile home, apartment, condominium, lodge, townhome, single family, multi family, office, retail, industrial/R&D flex, special use, and other. The programming may also be configured to present a drop down menu for the consumer user to indicate primary use 814. The real estate use options may include: principal residence, second home, and investment property. If the real estate type option selected includes primary residence or secondary home, the programming may be configured to present a field 816 below the property address fields and above the ownership fields, seeking information as to years at residence.

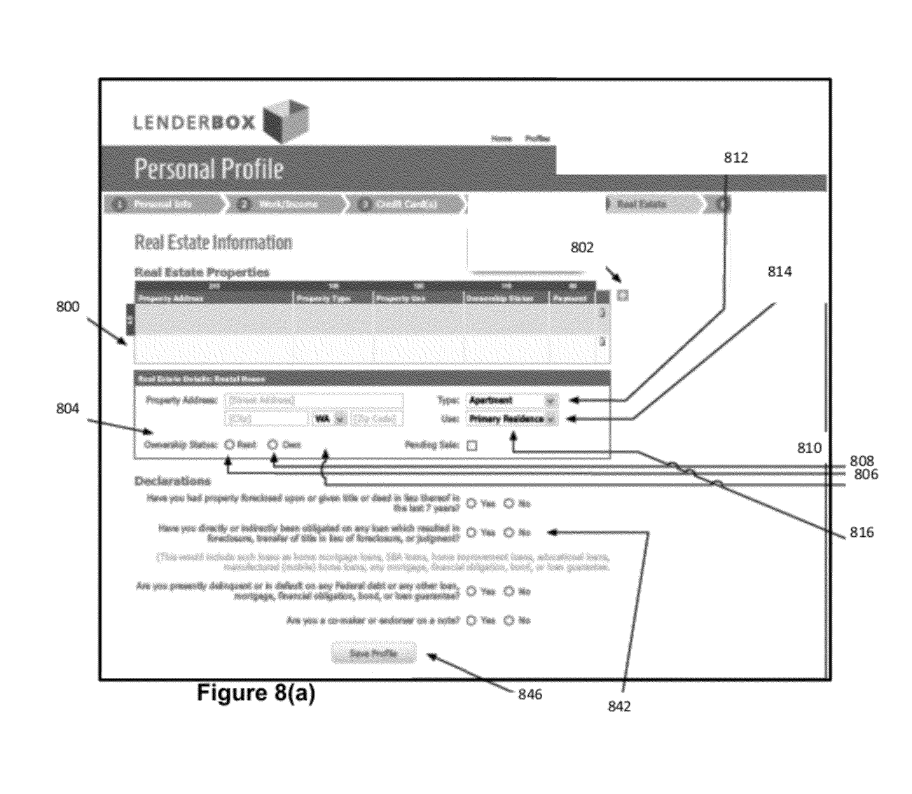

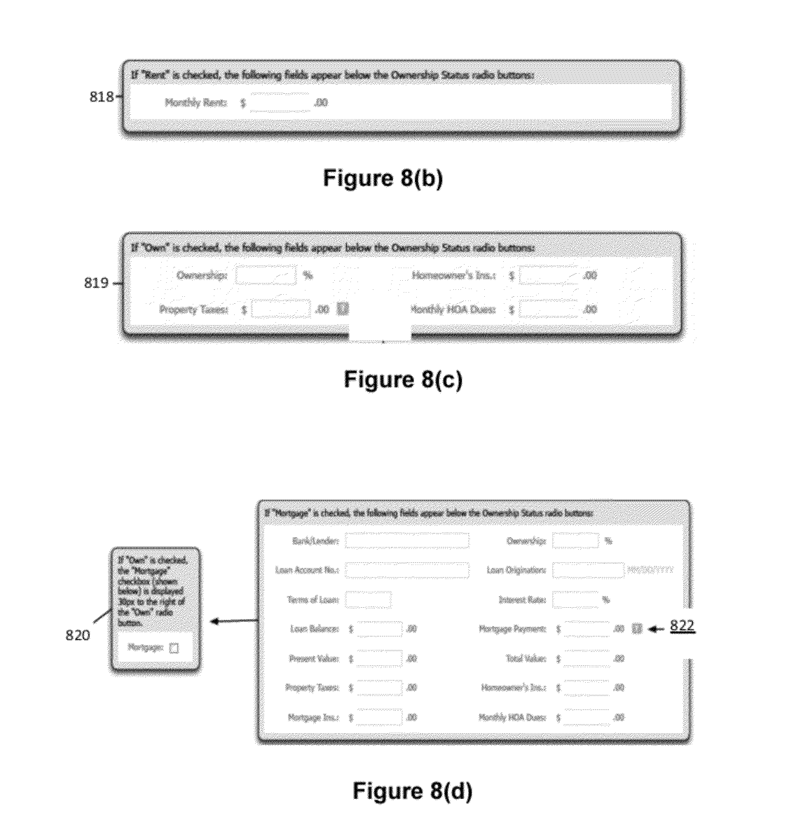

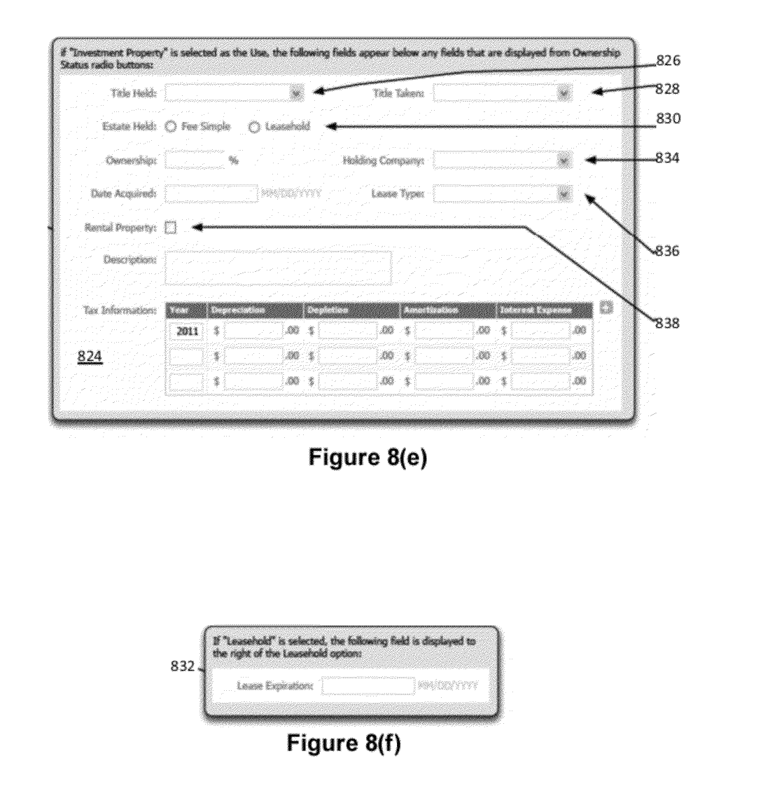

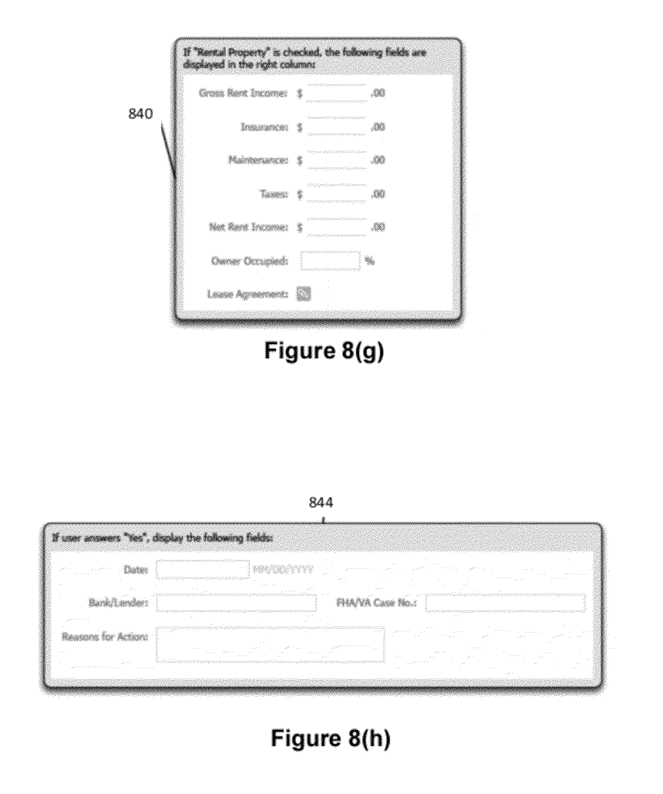

If the ownership status radio button 808 for rent is checked, the programming may also be configured to present a field 818 below the ownership status radio buttons seeking information on monthly rent payments as shown in FIG. 8(b).

If the ownership status radio button 810 for own is checked, the programming may also be configured to present a field 819 below the ownership status radio buttons as shown in FIG. 8(c), seeking information on property taxes, homeowner's insurance, and home owners association dues. The information may be based upon monthly amounts. The programming may also allow the user to input an annual amount into the fields and allow for automatic calculation of monthly amount.

Also, if the ownership status radio button 810 for own is checked, the programming may also be configured to present a field displaying a mortgage checkbox 820 to the right of the ownership status own radio button. If the mortgage box 820 is checked, the programming may also be configured to present fields 822 below the ownership status radio buttons as shown in FIG. 8(d) seeking the following information: bank/lender, loan balance, loan origination, terms of loan, interest rate, mortgage payment, present value, total value, property taxes, homeowner's insurance, mortgage insurance, and home owner's association dues. The information may be based upon monthly amounts. The programming may also allow the user to input an annual amount in the fields and allow for automatic calculation of monthly amount.

If investment property is selected from the real estate use menu, the programming may present fields 824 below the ownership status radio buttons as shown in FIG. 8(e) seeking the information on the investment property. The programming may present a drop down menu for inputting the nature of the title held 826 and the nature of the title taken. The nature of title held options may include by yourself, jointly with spouse, and jointly with another person. The nature of the title taken options may include sole owner, joint with right of survivorship, tenants in common, joint tenants, or undivided interest. The programming may present radio buttons 830 to allow the consumer user to input the type of estate held (i.e., fee simple, leasehold). If the leasehold radio button is selected, the programming may present a further field 832 (FIG. 8(f)) to the right of the leasehold option, seeking information as to the expiration of the leasehold. The consumer user may also be enabled through the programming to specify their ownership interest percentage. The programming may also be configured to present a drop down menu 834 to allow the user to input information as to the type of legal entity owning an interest in the investment property. The holding menu items may include: none (personally owned, LLC, C-corp, S-corp, and partnership. The programming may also be configured to present an input to allow the consumer to input a date of acquisition of the investment property. The programming may also be configured to present a drop down menu 836 configured to present to allow the consumer to input the type of lease. Lease type options may include: net, NNN, gross, and modified gross. The programming may be configured to display an input that may seek information describing the investment property. The programming may be also configured to display a chart to allow the consumer to input tax information associated with the investment property including depreciation, depletion, amortization, and interest expense on a year by year basis.

The programming may be configured to display a check box 838 may for the consumer user to indicate if rent is derived from the investment property. If rental property is checked, the programming may be configured to display a field 840 (FIG. 8(g)), seeking the following inputs: gross rent income, insurance, maintenance, taxes, net rent income, owner occupied, and lease agreement. The programming may be configured to display any of the aforementioned below any fields that are displayed below the ownership status radio buttons as mentioned above, for instance, the ownership or mortgage information fields.

In addition, the programming may be configured to display a field 842 (FIG. 8(a)) listing declarations used in applying for home loans, and the programming may be configured to display yes or no radio buttons next to each declaration. If a yes radio button is selected, the programming may be configured to display an explanatory field for the consumer user to provide additional information. For instance, if the consumer selects yes in response to a question on the declaration, “Have you directly or indirectly been obligated on any loan which resulted in foreclosure, transfer of title in lieu of foreclosure, or judgment?”, then the programming may be configured to display a field 844 (FIG. 8(h)), seeking information on the date of the judgment, the involved bank/lender, the applicable FHA/VA case number, and reasons for the action.

The programming may be configured to save information to the system. For instance, the programming may be configured to display a save button 846, whereupon clicking the save button saves the changes to the database and notifies the consumer user that the profile has been saved.

### “Assets and Liabilities”

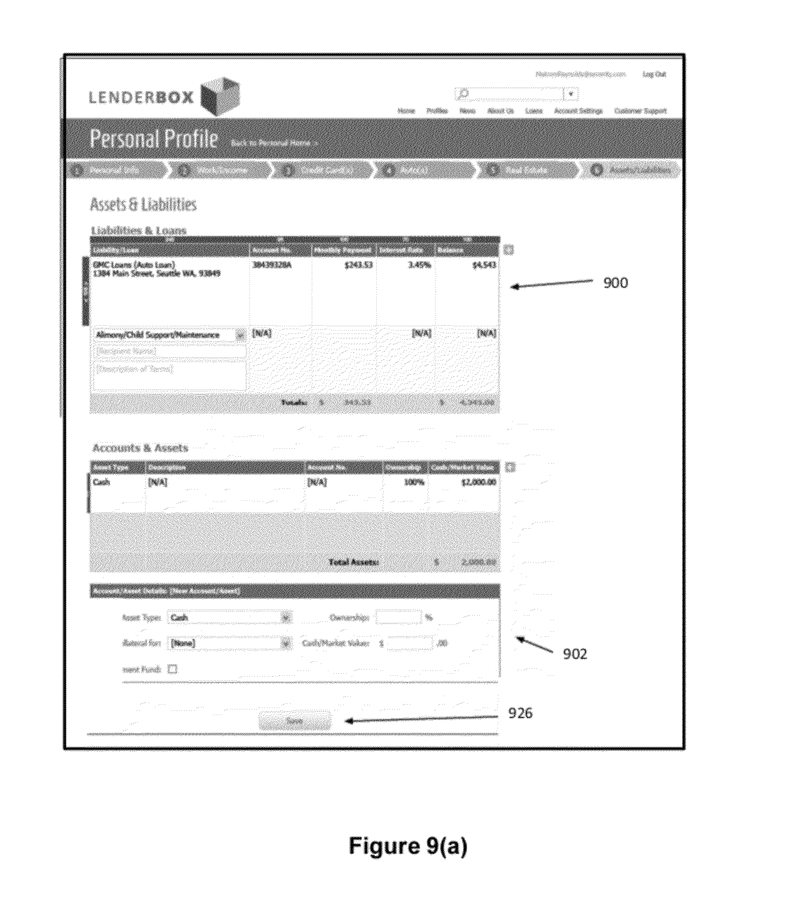

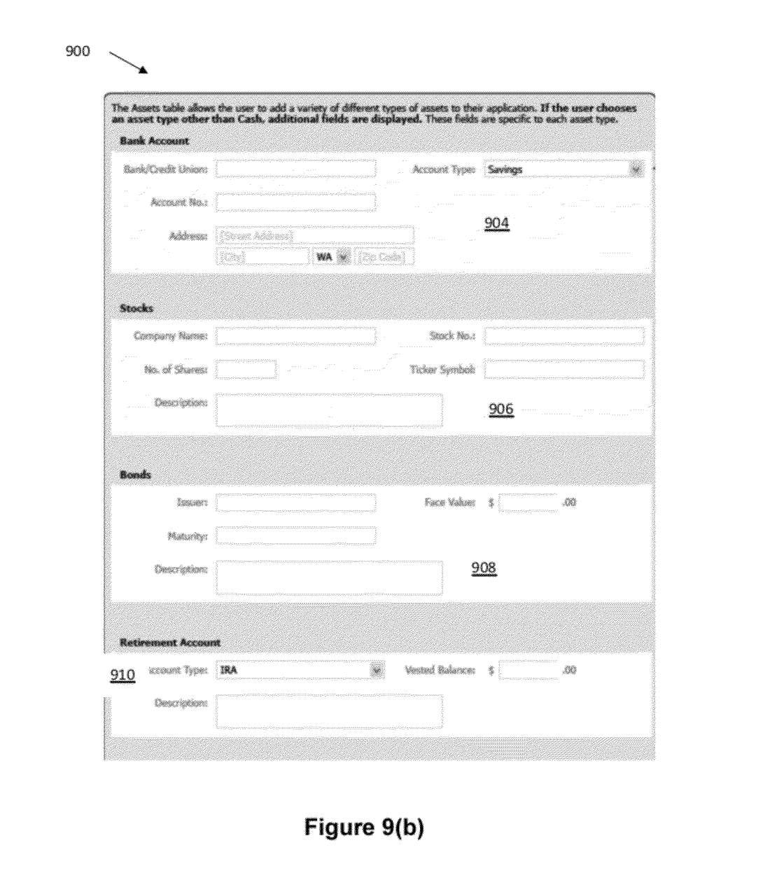

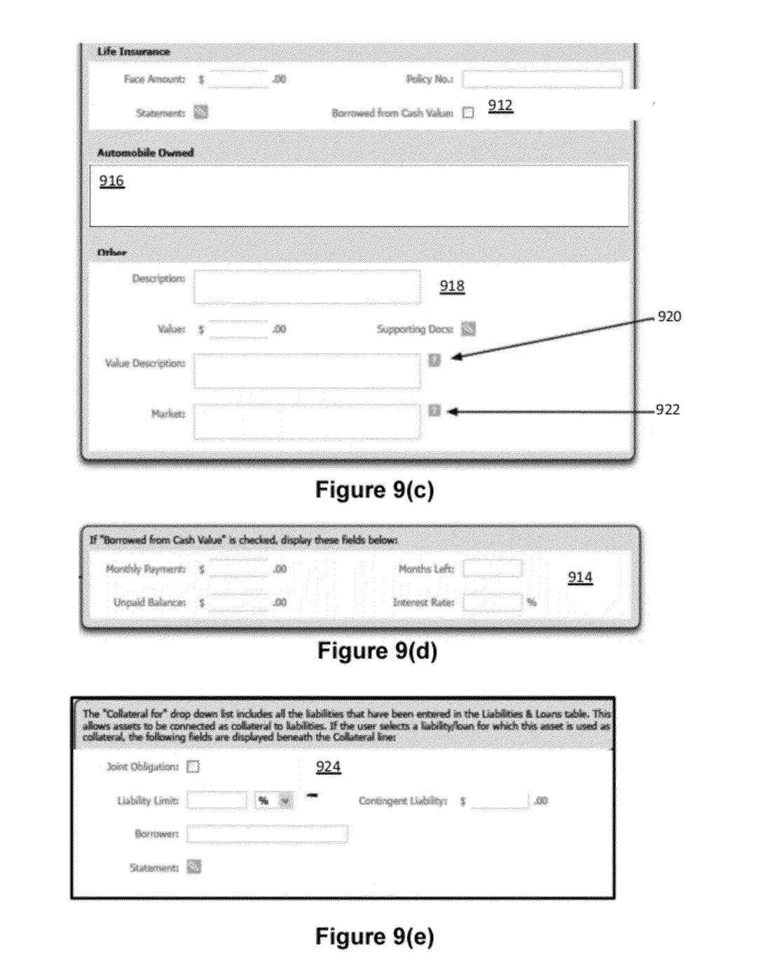

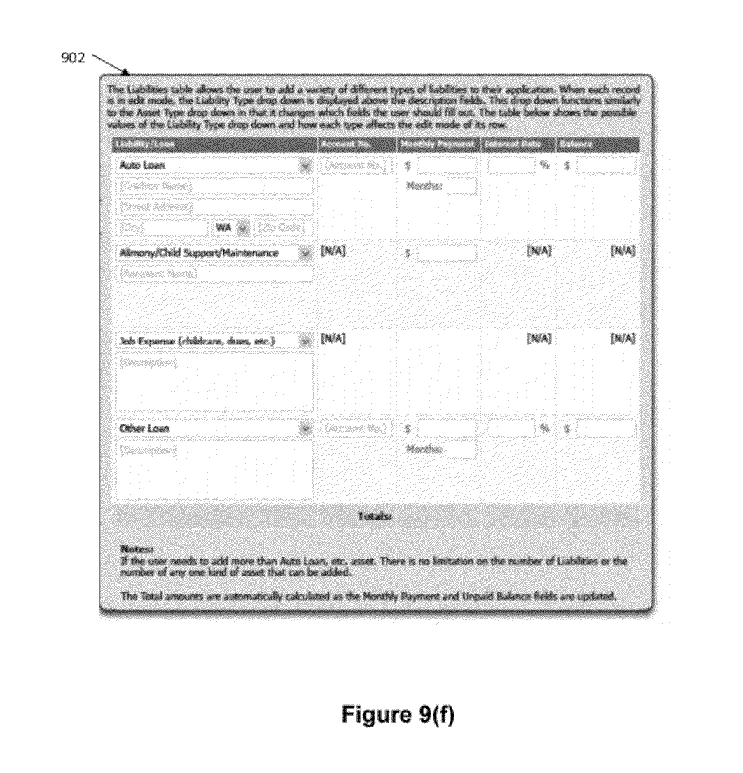

The system may also include programming to allow the consumer user to display information associated with their assets and liabilities. The programming may be configured to display all assets and liabilities included those entered by the consumer from prompts as part of other graphic user interfaces and fields (i.e., bank accounts, auto loans, real estate loans, etc.). The programming may be configured to display the information in summary form. For instance, as shown in FIG. 9(a), the programming is configured to present two tables 900,902 in a manner such that the consumer can view all of their assets and liabilities on the same page. The programming may be also configured to present fields to allow the consumer to input other asset and liability information previously not included as data input from other graphic user interfaces and fields. Preferably, there is no limitation on the number of liabilities or the number of any one kind of asset that can be added. Preferably, information is auto populated into corresponding fields based upon data entered through earlier screen displays, and may be configured to be displayed in a master/detail format described previously.

As shown in the drawings, the programming may be configured to display a table of assets 900 along with the programming configured to allow the user to add a variety of different types of assets which they may wish to include in any credit card, or home loan application. If the user chooses an asset type, the programming may be configured to display additional fields that are specific to each asset type as shown in FIG. 9(b). To facilitate the data input, the programming may be configured to display a table with a master/detail function. In other words, clicking on the row displays the detailed entry fields in the table. The programming may be configured to display drop down menus to specify account types, for instance, cash, bank account, stocks, bonds, retirement fund, business owned, automobile, owned, other, and life insurance. The programming may be configured to display fields allowing the consumer user to indicate whether certain assets are part of a retirement fund. In this way, the programming is configured to allow multiple assets to be associated with the individual's retirement fund, and standard retirement accounts may be identified.

Depending upon the type of asset, the programming may be configured to display different displays specific for the asset type. For instance, referring to FIG. 9(b), for additional bank accounts 904, the programming may be configured to display fields that may include bank/credit union name, street address, and account no., and a drop down menu for account type with options including savings, checking, money market, and brokerage account. For stock, the programming may be configured to display fields 906 that include company name, description, stock no., no. of shares, ticker symbol, and description. For bonds, the programming may be configured to display fields 908 that may include issuer, description, maturity, face value, and description. For retirement account, the programming may be configured to display fields 910 that include account type, vested balance, and description. For life insurance, the programming may be configured to display fields 912 (FIG. 9c) that include face amount, and policy no., and links to allow statements to be uploaded and a box to indicate whether the consumer has borrowed against the policy. If the box is checked, the programming may be configured to display further fields 914 as shown in FIG. 9(d), including monthly payment, months left, unpaid balance, and interest rate. For automobiles owned, the programming may be configured to display a field 916 with information and auto-populate other information from the consumer user's personal profile and previously entered auto information. For “other” assets, the programming may be configured to display fields 918 to allow the user to specify a value and a description 920, and to upload supporting document. The displayed fields may include description, value, and fields 922 to allow the user to describe how they determined the value of the asset and the potential market for selling the asset. Tax liens and other investment instruments may be included in this field.

The programming may be configured to display fields in the asset table for the consumer to specify whether any assets is being pledged as collateral or otherwise encumbered as shown in FIG. 9(e). To facilitate the data input for the consumer, the programming may be configured to present a drop down menu and include a list of all of the liabilities that have been entered in the “Liabilities & Loans” table. Accordingly, the programming is configured to allow the user to connect certain collateral assets to liabilities. If the consumer selects a liability/loan for which this asset is used as collateral, the programming may be configured to present a display beneath the collateral display to assist the consumer in identify the nature of the collateral. For instance, the display may include identifying whether the obligation is of joint nature. In the drawings, check box is shown. If the joint obligation check box is checked, the programming may be configured to present a display of radio buttons indicating status as guarantor or joint applicant. The programming may be configured to present a display to allow the consumer user to enter liability limits and contingent liability as well as identifying the borrower. A link to upload a most recent statement for verification purposes may also be provided.

The programming may be configured to present a display 902 showing liabilities. As shown in the drawings, the display of liabilities may be in a table format. The programming may be configured to allow the consumer to input into the table a variety of different types of liabilities to their application as shown in FIG. 9(c). When each record is in edit mode, the functionality is similar to the asset table in that programming is providing for a master/detail function where clicking on the row displays the detailed entry fields in the table. The programming may enable certain liabilities previously entered by the consumer to be displayed through an auto-population feature. Additionally, the programming may be configured to present a display a drop down menu to allow the consumer user to input other types of liabilities, for instance, as auto loan, auto lease, credit card, revolving charge accounts, real estate loans, child support, maintenance, alimony, and stock pledges. The programming may be configured to present additional fields to allow the consumer to input information regarding the creditor name and address, monthly payment, interest rate and balance. The programming is such that the liability type drop down menu selection affects the edit mode of its row. Programming may be provided so that the total amounts are automatically calculated as the monthly payment and unpaid balance fields are updated. The programming may display fields in accordance with the type of liability listed.

The programming may be configured to save information to the system. For instance, the programming may be configured to display a save button 926, whereupon clicking the save button saves the changes to the database and notifies the consumer user that the profile has been saved.

### “Auction Forum”—Borrower

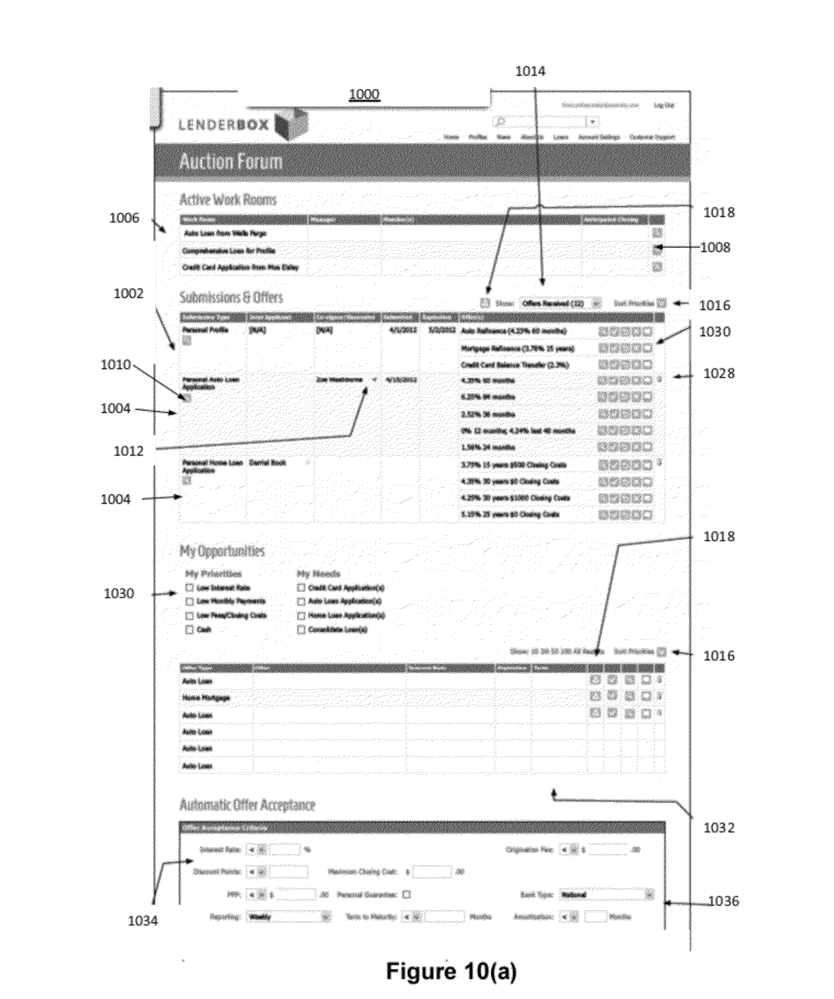

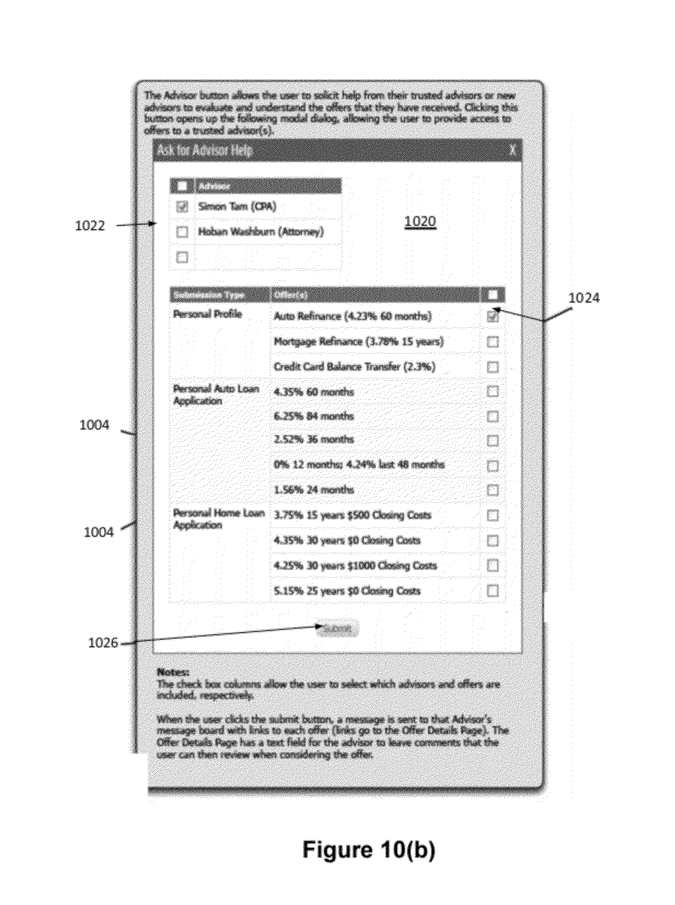

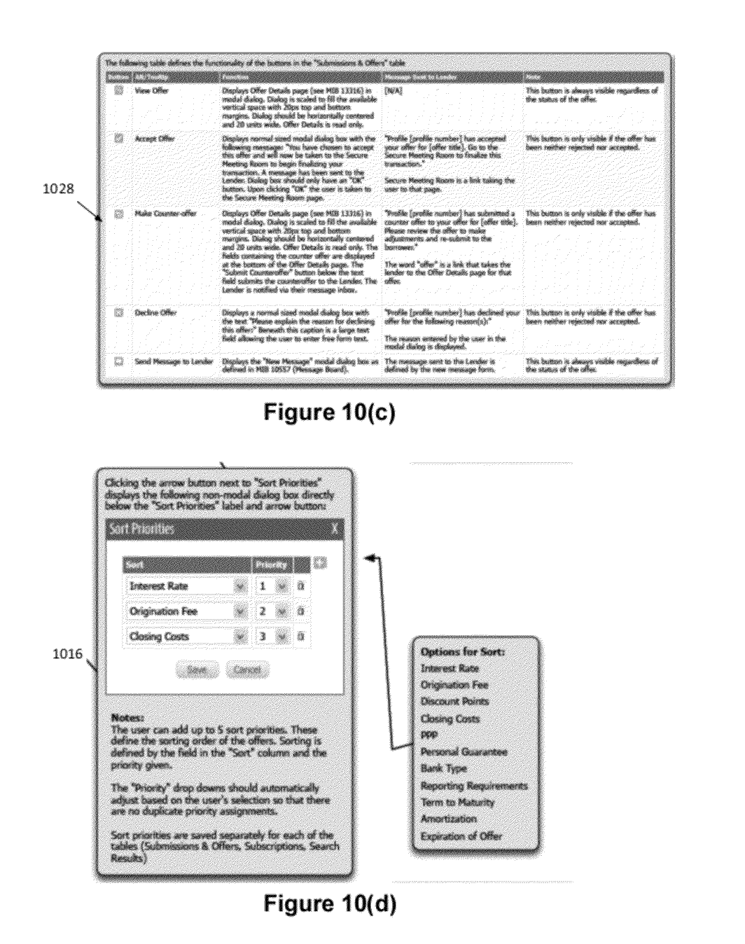

The system has programming configured to present several screens that may be used to display all of the consumer user's active transactions 1000. For instance, after a consumer user has entered a personal profile, the public personal profile 1002 may be made available on the system. This is shown in the first row of the Submission & Offers table of FIG. 10(a). If the consumer user applied for a credit card or home loan in the process of completing the screens for credit card and real estate, submissions will reflected in the next rows 1004 of the Submission & Offers table of FIG. 10(a). These submissions are made available to users of the system, for instance, lender users, and offers may be made in response to the submission.

The system may have programming configured to enable presenting a table 1006 showing active work rooms associated with the consumer user. As an example, financial institutions may make offer to a consumer user's submission. Once the offer is accepted, the system has programming configured to generate a work room to allow the lender user and consumer to finalize the transaction. The programming may be present a display of the table 1006 showing the status of active work rooms. The system may have programming configured to generate a view button 1008 which once activated takes the consumer to a particular work room. For instance, as shown in the drawings, the work room table is displayed at the top of the “Auction Forum” and the view button is located in the far-right column. The programming may be configured to provide color coding indication for certain work rooms in which the consumer user is required to complete a task.

Below the listing of work rooms, programming may be configured to display all of the consumer user's submissions and offers. As shown in the drawings, all of the consumer's submitted profiles and loan applications are listed in the submissions and offers table. The view button 1010 below the profile or loan application takes the consumer to the profile or loan form. Preferably, the consumer's applications and profiles are identified by name. Programming may be configured to display a field 1012 with information about joint applicants and/or co-signer, guarantors may also be provided. In the drawings, certain of the columns contain the names (or email address if the person is not a system member) of the joint applicant or co-signer/guarantor, respectively. Programming may be configured to present a display of status check marks may be used to indicate the status of the joint applicant, co-signer, or guarantor, for instance, (i) whether they have been notified but has not responded to the consumer's request, (ii) rejected the consumer's request, (iii) accepted the consumer's request, but has not yet completed their application; or (iv) has accepted the user's request and has submitted their application. Color check marks may be used.

Programming may be also configured to present a drop down 1014 menu to allow the user to customize the display of the submission and offers table through preselected filter options. For instance, the offers received selection of the drop down menu may filter the list in the offer(s) column to only display those offers that have been received but neither denied nor accepted. The offers accepted selection of the drop down menu may filter the list in the offer(s) column to only display those accepted by the borrower. The offers denied selection of the drop down menu may filter the list in the offer(s) column to only display those denied by the borrower. The all selection of the drop down menu may show all offers related to the user's profile and their submitted applications.

Programming may be also configured to present a priorities arrow button 1016 to allow the user to customize the types of offers received in response to submissions listed on the submission and offers table. The programming may be such that clicking the priorities arrow button enables the display of a non-modal dialog box directly below the sort priorities arrow button such as that shown in FIG. 10(d). The programming may be such that the consumer may add a priority and sorting bases that define the sorting order of the offers. Sorting is defined by the field in the sort column and the priority given. Programming may be also configured to present a priority drop down menu with selections that are adjusted based on the consumer user's selection so that there are no duplicate priority assignments. A selection from the priority drop down menu of sort priorities may be saved separately for each of the tables displayed. For example, in the context of a home loan, the priority may be sorted based upon interest rate, origination fees, and closing costs. Other option for sorting may include discount points, PPP, personal guarantee, bank type, reporting requirements, term to maturity, amortization, and expiration of offer.

Programming may be also configured to present an advisor button 1018 in connection with the submission and offers table to allow the consumer to solicit help from their trusted advisors or new advisors to evaluate and understand the offers that they have received. The programming may be such that clicking the button may enable the display of a modal dialog box 1020 such as that shown in FIG. 10(b) to allow the consumer to provide access to a selected offer to a trusted advisor(s). Programming may be also configured to present a display 1022 to enable the consumer to select from among a list of predesignated advisors. Checking a box adjacent the advisor's name indicates asking the advisor for help and allows the advisor access to the offer via the system. Programming may be also configured to present a display that lists all of the submissions 1004 made by the consumer with a check box 1024 next to each submission. The check box 1024 allows the user to select which advisors and offers are included, respectively. When the user clicks the submit button 1026, the programming may be such that a message is sent to the selected advisor's system message board with links to each offer. The programming may be such that the links redirects the advisor to an offer details page. The offer details page has a text field for the advisor to leave comments that the user can then review when considering the offer.

Programming may be also configured to present a display of a delete button 1028 in connection with the submission and offers table. Once activated, the delete button preferably prompts the user to confirm whether they want to delete their submission and/or application. Programming may be also configured such that activation of the delete button removes the application from the system and deletes all offers. Additionally, the programming may be also configured such that the financial institution that submitted an offer for the application receives notification in their system message boards that the application has been deleted and the offer deleted.

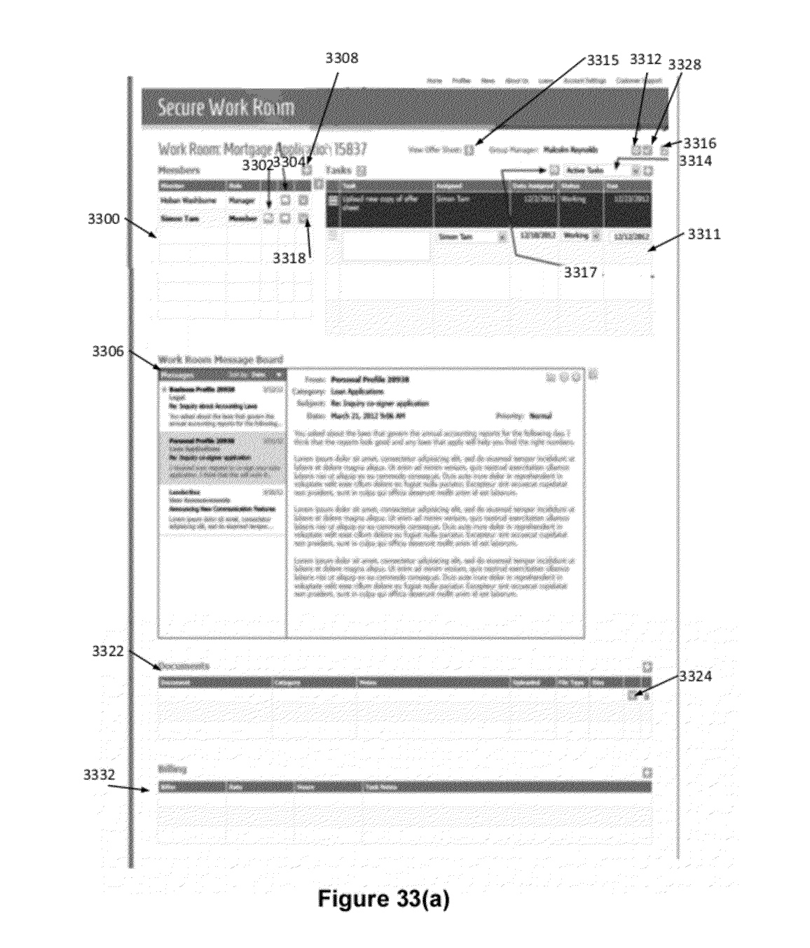

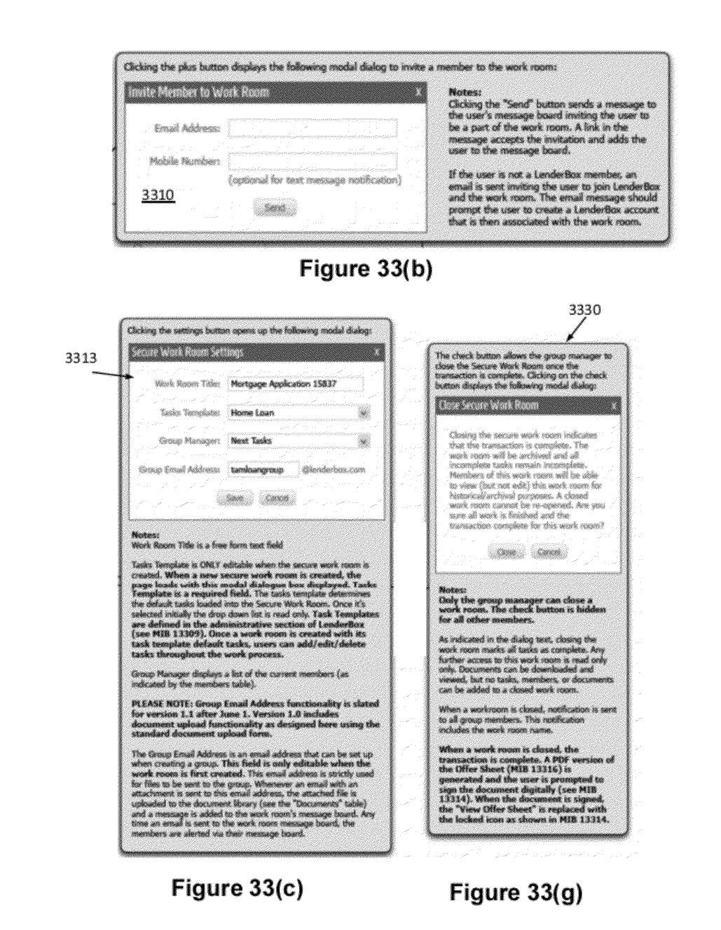

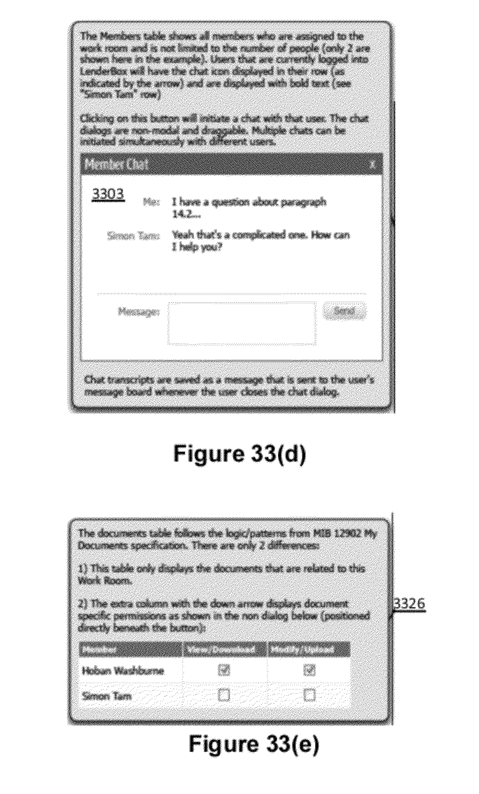

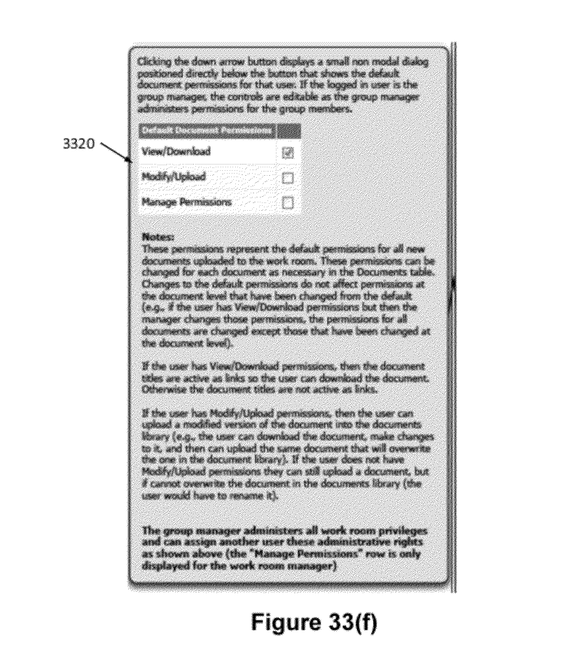

Programming may be also configured to present the display of icons 1028 to provide additional functionality in connection with the submission and offers table. FIG. 10(c) shows a representative list. For instance, a view offer button may be displayed and be configured such that the offer details are presented in a modal dialog box. An accept offer button may be displayed and configured to present the display of a modal dialog box with the following message: “You have chosen to accept this offer and will now be taken to the Secure Meeting Room to begin finalizing your transaction. A message has been sent to the financial institution.” Upon clicking the ok button in the dialog box, programming may be configured to present a link that redirects the consumer user to the secure meeting room pages discussed in greater detail below in reference to the discussion of FIGS. 33(a)-33(g). Programming may also be configured to enable a message to be sent to the financial institution at that time stating, for example, “Profile [profile number] has accepted your offer for [offer title]. Go to the Secure Meeting Room to finalize this transaction.” Programming may be configured to present a link that redirects the financial institutional to the secure meeting room pages discussed in more detail below. Programming may also be configured to present a make counter-offer button enables the consumer to make a counter-offer. Additional programming associated with the make counter offer button may present fields enabling the consumer user to make a counter-offer in a standard format. As shown in the drawings, the counter-offer fields are displayed at the bottom of the offer details page. Programming may be configured to present a submit counter-offer button below the text field that submits the counter-offer to the financial institution. The system may be enabled to provide a message to the message board of the financial institutions indicating a counter-offer, for instance, “Profile [profile number] has submitted a counter offer to your offer for [offer title]. Please review the offer to make adjustments and re-submit to the borrower.” Programming may be configured to present a decline offer button that displays a free form text box prompting the consumer user to explain the reason for declining this offer. Programming may be configured to send a message via the system to the financial institution indicating the declining of an offer, for instance, “Profile [profile number] has declined your offer for the following reason(s):.”, and the reason entered by the consumer user in the modal dialog is displayed. Programming may be configured to send a message to a financial institution user explaining the declining of the offer. For instance, programming may be configured to display a message button that once activated generates a display that may include a modal dialog box that allows the consumer to input free form text for a message. Programming may be configured to display a send button that once activated sends the message via the system to the financial institution.

Below the submission and offers table, the programming may be configured to present a display 1030 to allow a consumer to select priorities/needs that they may have. In the drawings, the display is indicated in a table format as “My Opportunities”. A plurality of check boxes may be provided via programming to filter the list of general offers being made by financial institutions. As shown in the drawings, the check boxes may be categorized under “My Priorities” and “My Needs”. Under “My Priorities”, the check boxes may include “Low Interest Rate”, “Low Monthly Payments”, “Low Fees/Closing Costs”, and “Cash”. Under “My Needs”, the check boxes may include: “Credit Card Application(s)”, “Auto Loan Application(s)”, “Home Loan Application(s)”, and “Consolidate Loan(s)”. In response to the selections, financial institutions (i.e., lender users) and other users of the system may send offers to the consumer based upon perceived needs.

The offers received relative to the fields check in the My Opportunities display 1030 may be included in table format 1032 as shown in the drawings. Programming may be configured to present fields that specify the type of offer and terms. The fields may display matched criteria via a comma delimited list of the search criteria matching an offer matched, for example, as shown in the drawings, “Interest Rate <5%, Closing Cost Range: $4000-$5000, Bank Type: National” Programming may be configured to delete opportunities for the opportunities table. The consumer user can use this feature to essentially “block” previously entered opportunities from further search/filter results. Programming may be configured to present a view button that displays an offer in a modal dialog box in a manner similar to manner previously described in the submissions and offers display. If the consumer is interested in accepting one of these generic offers for a specific purchase/refinance/loan/etc., the programming may be configured such that clicking the message button sends a message to the financial institution. The system may generate a new message for the financial institution in the manner previously described and transmit the message through the system message board. In this way, the consumer user and financial institution may turn a submission into a transaction and be directed to a secure meeting room to finalize the transaction. If an offer from a financial institution expires, the programming may be such that the consumer user is notified via the message board and the offer no longer appears in the submission and offers table. Programming may be configured to display an accept offer button (i.e., the check mark button in the drawings). The programming may be such that activation of the accept offer button essentially locks in the offer and initiates programming to actuate a link to redirect the consumer user and the financial institution user to a secure meeting room. Programming may be configured to allow the consumer user to filter the search results in the “My Opportunities” section with a filter button. The results may be filtered by a financial institution's approval criteria (i.e., what the lender would approve this borrower for). As described herein (“Auction Forum”—Lender), programming may be configured to assist the financial institution in providing the criteria to locate opportunities. The criteria are essentially a method to generate “pre-approval” for the borrower/consumer.

Programming may also be configured to present a display of an icon 1018 in connection with the “My Opportunities” fields to allow a consumer to select a trusted advisor. The programming may be such that clicking the trusted advisor button may generate the further display of a dialog box accepting free form text with prompts directing the consumer user to send a message a trusted advisor(s) seeking additional help from a trusted advisor in optimizing/improving their profile/applications. Programming may be configured such that the message contains a link to the specific offer with which the user wants help. The functionality is similar to that previously described in the submissions and offers table. Programming may be configured to present a sort priorities button 1016 with all or some of the functionality previously described.

The system may also be enabled to allow the consumer to automatically accept an offer based upon specified criteria. For instance, as shown in the drawings an automatic offer acceptance display 1034 may be displayed. The automatic offer acceptance display allows a consumer user to establish parameters that will automatically accept an offer. Preferably, numeric criteria must be established for automatic offer acceptance. Programming may be configured to enable the consumer to input acceptance criteria. For instance, as shown in the drawings, offer acceptance criteria may be based upon any or all of the following: “Interest Rate”, “Origination Fee”, Discount Points”, “Maximum Closing Cost”, “PPP”, “Personal Guarantee”, “Bank Type”, “Reporting”, “Term to Maturity”, and “Amortization”. Drop down menus may be provided with the fields to assist the consumer in the data input. For instance, default options for “Bank Type” 1036 may include: “All”, “International”, “National”, “Local”, “Credit Union”, “Broker”, “Private”, “VC”, “Private Equity”, “Factoring”, and “Asset Based Lender”. When an offer matches the criteria established by the consumer, programming may be configured to send a message to the consumer user's message board and programming generates a secure work room to enable finalizing the transaction. The consumer's selections in the automatic offer acceptance section may be saved to the system database.

Once the profile is completed, the information will be displayed to the consumer on the consumer user's home page as shown in FIG. 12. Public profile information for the consumer will made available to users of the system in a format such as that shown in FIGS. 11(a)-11(b). Because a completed public profile for the consumer user provides indication that the consumer user has all the documents and information needed for a particular transaction, a lender user is in a position to make a hard offer to the consumer user. Once the consumer user accepts the offer, a secure work room may be generated and documents and other information needed for the transaction may be automatically produced to the lender user to allow the parties to finalize the transaction. Because the information needed to complete the transaction is provided by the consumer user in the course of completing the profile and before the profile is published and an offer is made, the lender user may make a hard offer that requires little or no follow-up, no substantive documentation or information, and only corroboration of the produced materials to consummate the transaction as discussed above.

### “Business User”

The business user screen displays are similar to those previously described with respect to the consumer user. The system has programming configured to present several screen displays that enable the business user to input information about their business.

### “Business Profile”

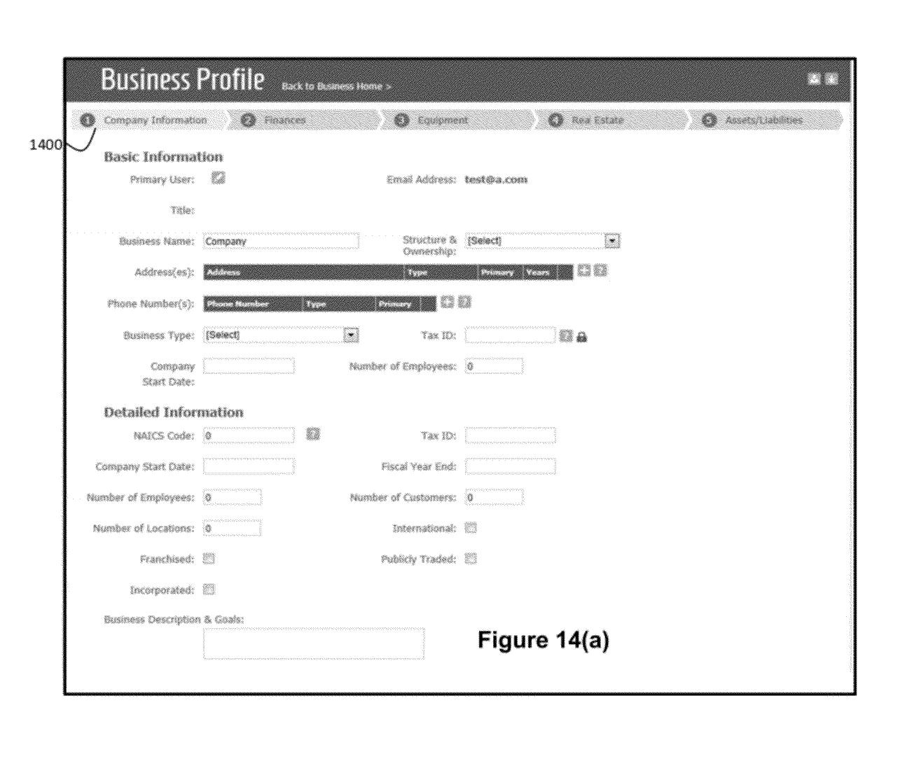

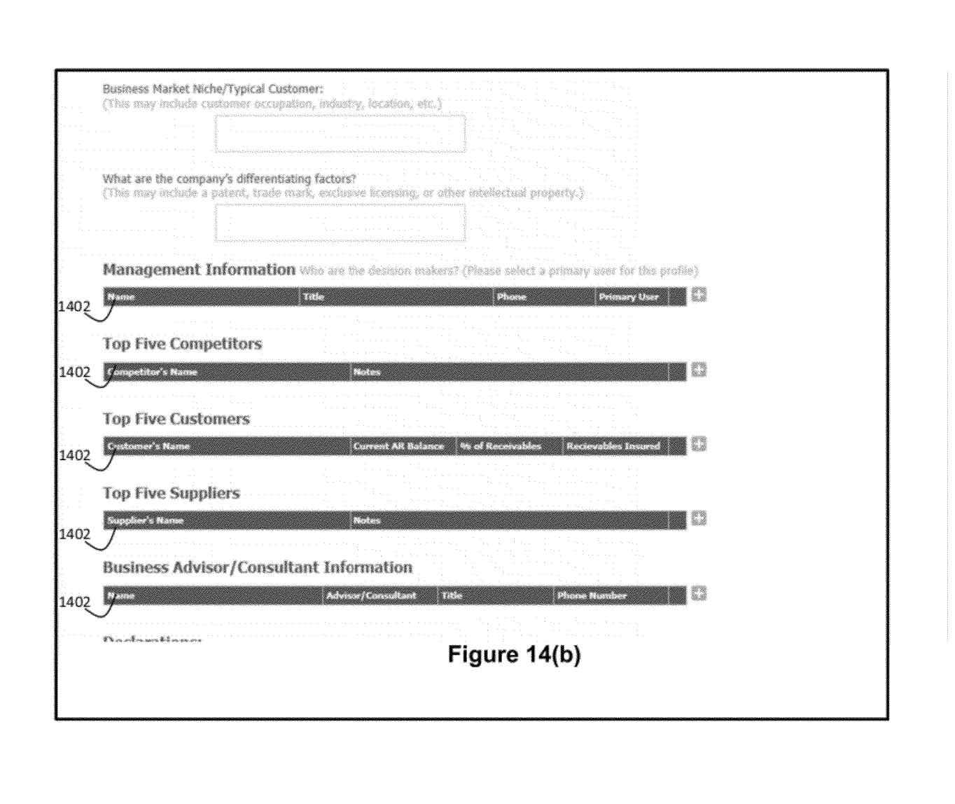

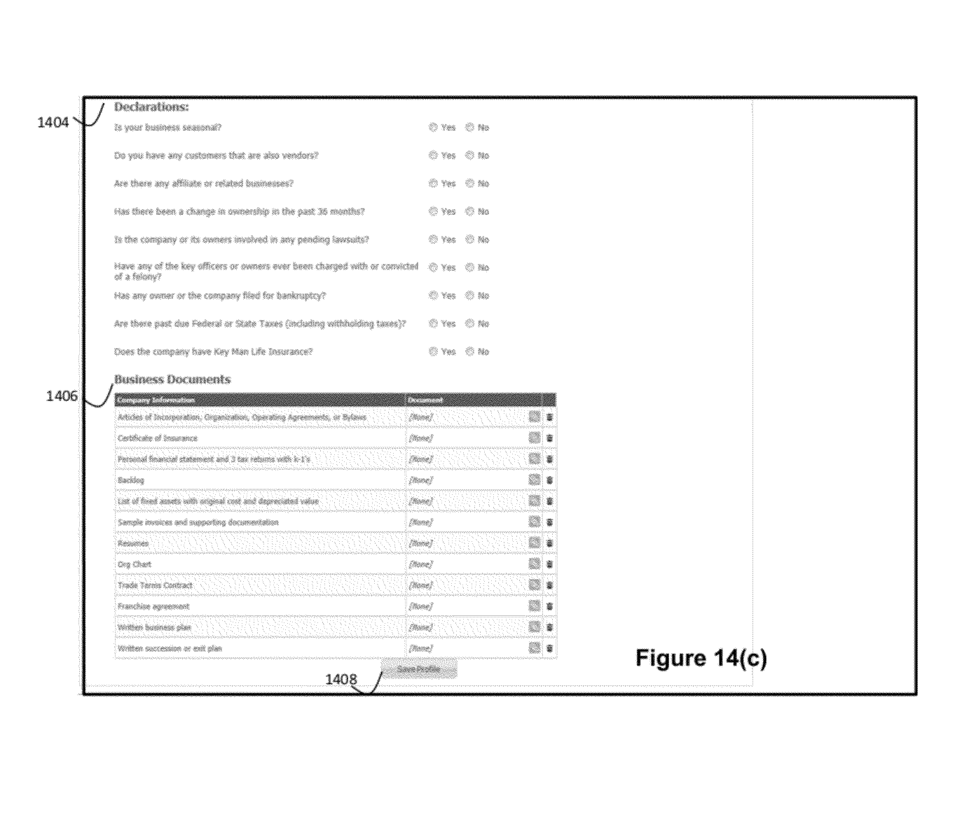

For instance, as shown in FIGS. 13, and 14(a)-14(c), the system is configured to present a series of displays with fields 1400 that prompt the business user to input basic information about their business. The information may include the business name, the business address, the business phone numbers, the company start date, and the number of employees. The system may be configured to provide drop-down menus to facilitate the business user in inputting information. For instance, as shown in FIG. 14(a), a drop-down menu may be provided to allow the business user to select the type of structure of ownership (i.e., C corp, S corp, partnership, LLC). Also as shown in FIG. 14(a), the series of screen displays may prompt the business user to input information regarding the company's start date, the number of locations, its business goals, business markets. As shown in FIG. 14(b), the series of screen displays may also prompt the business user to input information concerning its management, top five competitors, and top five customers 1402. As shown in FIG. 14(c), the system may also be configured to display declarations 1404 used by businesses in applying for financing, and the programming may be configured to display “yes” or “no” radio buttons next to each declaration. If a “yes” radio button is selected, the program may be configured to display an explanatory field for the business user to provide additional information in a manner similar to that described above in the consumer user screens.

Additionally, the programming may be configured to present a display 1406 to enable the business user to upload business documents that may be needed by the business when applying for financing. The documents may include articles of incorporation, certificates of insurance, financial statements associated with the business, a listing of fixed assets with original costs and depreciated value, sample invoices and supporting documentation, resumes, organizational charts, business plans, succession or exit plans.

As with the other screens previously described, programming may be configured to save information to the system. For instance, as shown in the drawings, programming may be configured to display a save button 1408, whereupon clicking the save button saves the changes to the database and notifies the business user that the profile has been saved.

### “Finances”

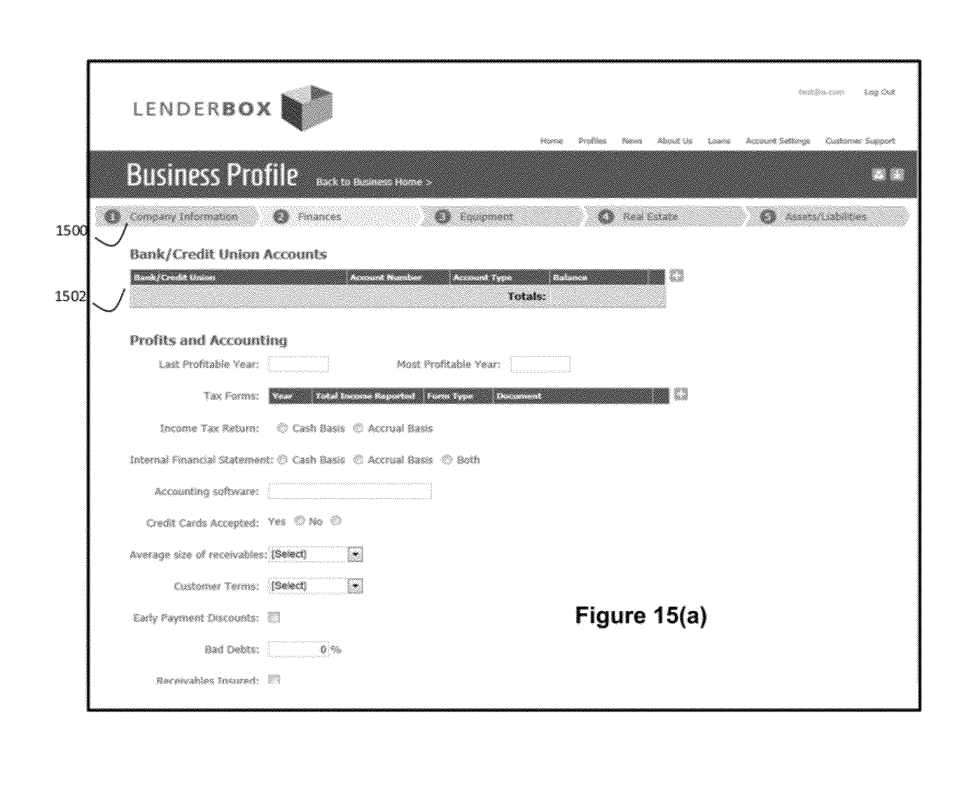

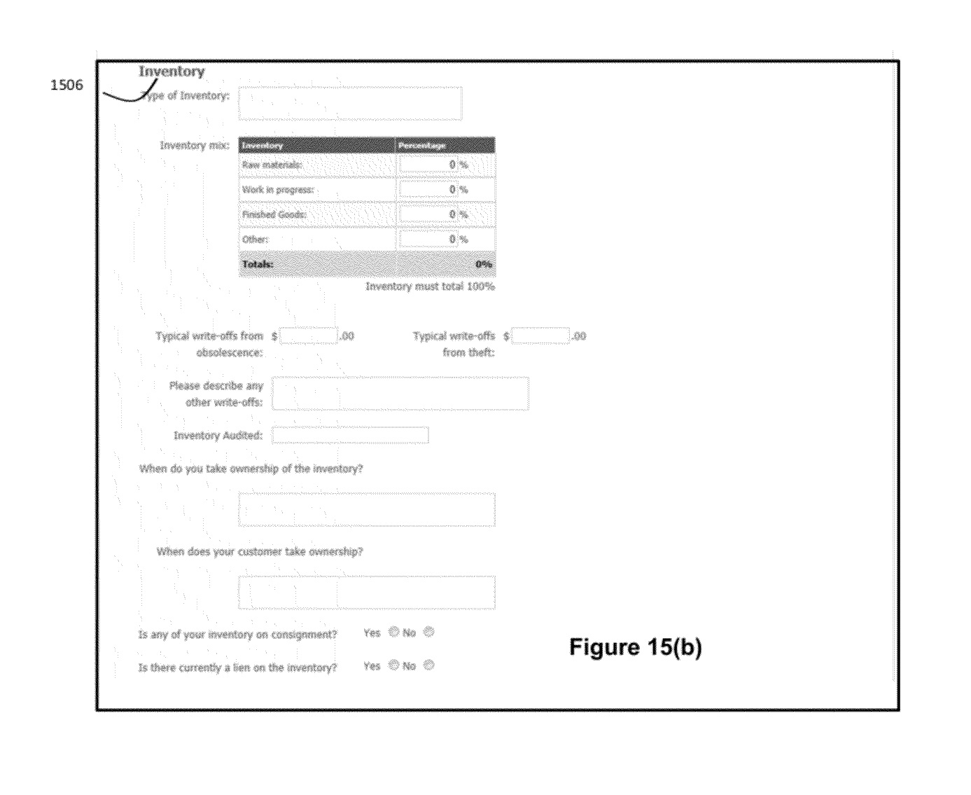

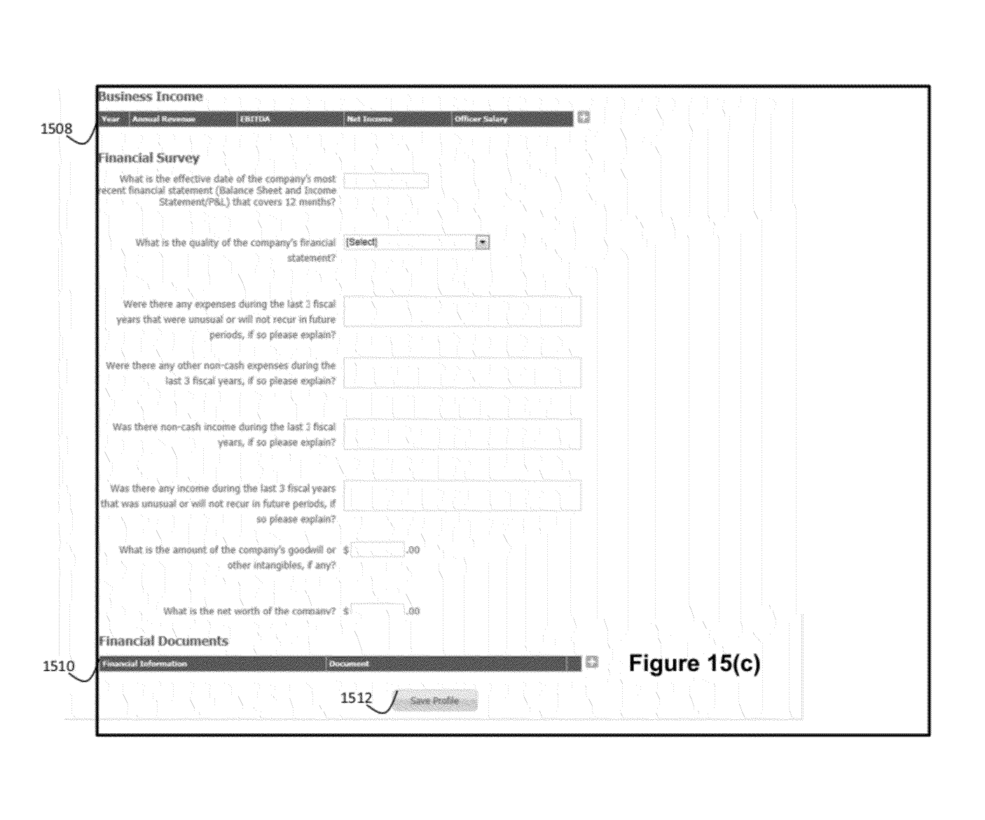

The system may also include programming to allow the business user to input information associated with their finances. For instance, as shown in FIGS. 15(a)-15(c), the programming may be configured to display information regarding the business' bank accounts 1500. The programming may be configured to display the bank account information in a tabular format with master/detail programming in the manner previously described with respect to the consumer user. Additionally, the programming may be configured to display fields to allow the business user to input information about their profits and accounting 1502. The programming may present a series of displays to enable the business user to indicate their last profitable year, most profitable year, the basis of their income tax return, internal financial statements, accounting software, the average size of their receivables, customer terms, bad debts, inventory, billing, and company financing. To facilitate entry of the information, the programming may be configured to present a display of radio buttons. For instance, as shown in the drawings, a radio button is provided next to income tax return to allow the business user to indicate whether the return is a cash basis or an accrual basis. Additionally, programming may be configured to display drop-down menus to allow the business user to input information regarding the average size of its receivables, the customer terms, and billing methods.

Additionally, as shown in FIG. 15(b), the programming may be configured to display fields 1506 to allow the business user to input information about its inventory, including the type of inventory, a percentage of the inventory mix, typical write-offs associated with inventory obsolescence and theft, and other explanatory fields typically used by financial institutions when evaluating risk associated with a business user. The explanatory fields may include prompts for the business user to explain when the business takes ownership of the inventory and when the customer takes ownership.

Also as shown in FIG. 15(c), the system may also be configured to display fields 1508 with prompts for information regarding the business' finances. For instance, as shown in the drawings, the screen displays include a financial survey. The questions in the financial survey may be those types of questions typically utilized by financial institutions when evaluating risk for loans to businesses. This programming may also be configured to present displays 1510 to enable the business user to upload financial documents and the programming may be configured to display a save button 1512 to save the entries to the system database.

### “Equipment”

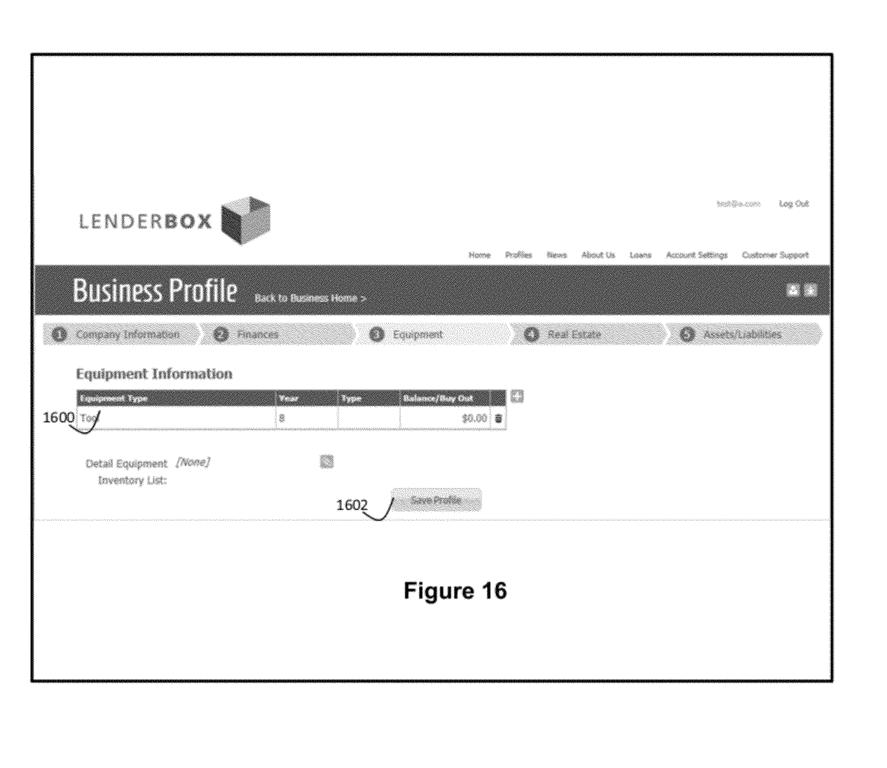

As shown in FIG. 16, the system may be configured to present a display with fields 1600 to enable the business user to input information about its equipment. For instance, the programming may be configured to allow the business user to input information in the form of a table with master/detail capability. The programming may be configured to provide expanded dialogue boxes that enable the business user to input information about the equipment, including the type, year, description, location, life expectancy, original costs, current value, data purchase, data value, and whether the equipment is owned, loaned, or leased. Again, the programming may be such that a “save profile” button 1602 may be provided to enable the business user to save information to the system.

### “Real Estate”

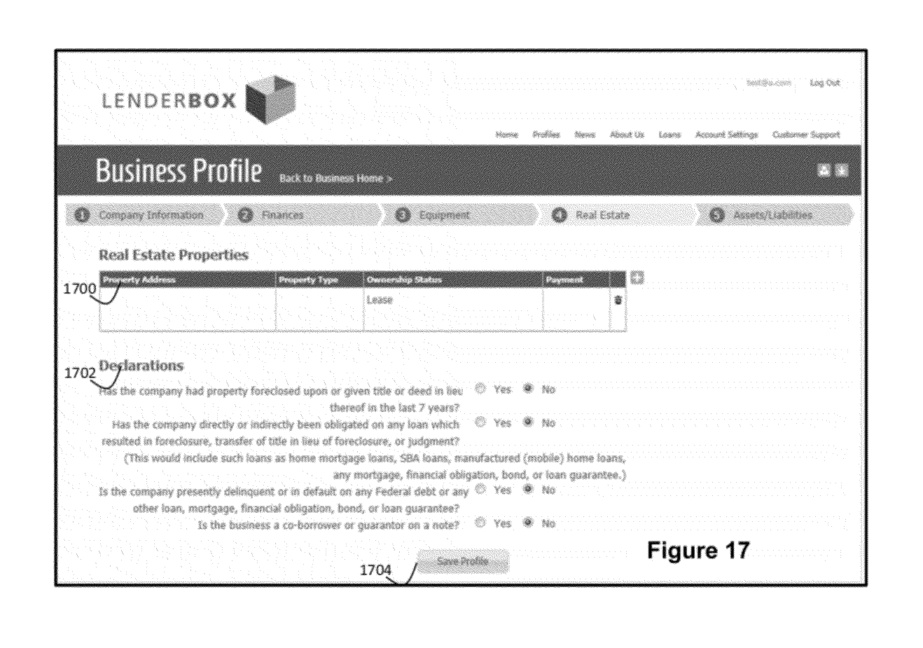

As shown in FIG. 17, the system may have programming to present a display of fields 1700 to enable the business user to input information into the system regarding business-related real estate properties. The system may be configured to display the real estate details in a dialogue box which is presented when the user begins data input. The information may include the real estate address, its ownership status, and the type of real estate property.

The system may also be configured to present a display 1702 with declarations in the display in a manner previously described. Radio buttons may also be provided adjacent each declaration to facilitate the business user's data input. As described previously, the programming may be such that information regarding real estate properties may be saved to the database using a save button 1704.

### “Assets and Liabilities”

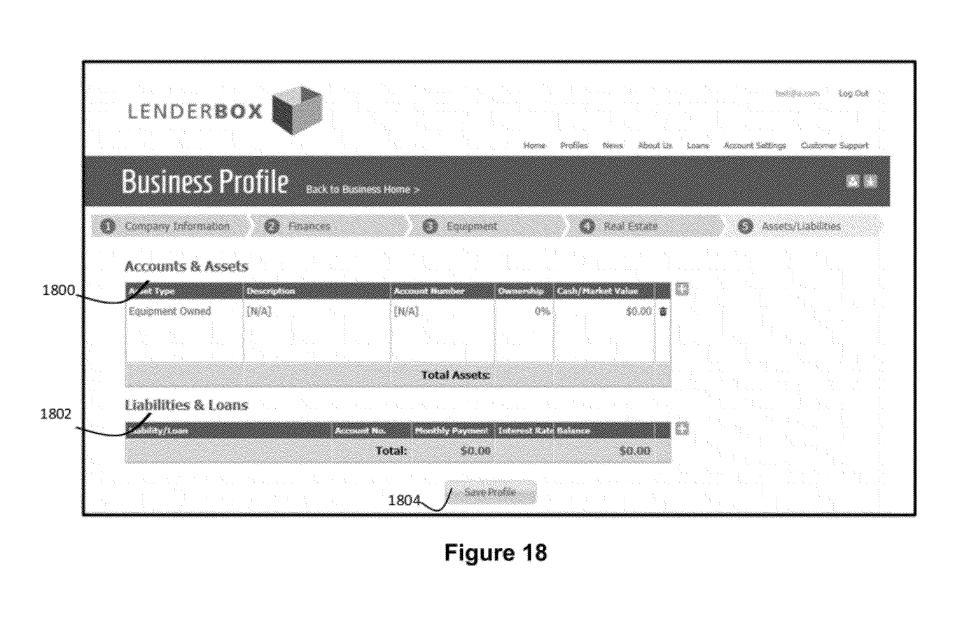

As shown in FIG. 18, the system may also be programmed to present displays 1800,1802 to enable the business user to input information about accounts and assets. The accounts and assets may be listed in a table 1800 with master/detail capability. The business' liabilities may be listed in a table 1802 with master/detail capability. Preferably, information regarding assets and liabilities may be auto-populated from screens and other inputs previously entered, including any linked profiles. The business user may enter in specific information about an asset or account. When the business user begins the data input, the programming may be such that a dialogue box may be presented with drop down menus to facilitate the business user's data input. As with the previous description concerning the consumer, the business user may also list as an asset cash, bank account, stocks, bonds, life insurance, etc. The business owner may indicate whether the asset is collateral for a specific item. The business owner may also indicate an ownership percentage and a cash/market value. In a similar format, the business user may list liabilities and loans. When the business user begins data input, the programming may be such that a dialogue box may be presented to facilitate the data input. For instance, the dialogue box may display fields seeking prompts describing the liability and loan in terms of liability type, account number, creditor name, phone number, creditor address, original amount, monthly payment, interest rate, balance, maturity date, and start date. Information may be uploaded to the system with a save button 1804.

### “Business Public Profile”

The system may be configured to present a display to other users of the system regarding a business seeking capital or other financing. FIGS. 19(a) to 19(c) provide an illustrative business public profile. Each business user is assigned a profile number 1900 that links to their business profile. The profile number allows a business user to be identified while hiding the business user's identity. Basic information 1902 about the business may include “Business Type”, “No of Employees”, “State”, “Start Date”, “No. of Locations”, “Franchised”, and “Publicly Traded.” As described before, the system may be enabled to present fields 1904 to allow the business user to input financial information about the business. Programming may be provided to facilitate the data input via drop down menus. Thus, the business owner may input financial data based upon EBITDA, Net Worth, and/or Revenue. The information may be provided on a quarterly or annual basis, and may be provided based upon set times of last 3 years, last 5 years, and last 10 years. The system may be configured to present a display 1906 of the inputted information in chart format in the public profile. As shown in the drawings, depending on user selection of the drop down menus, programming may enable the display of a line chart where the labels on the “y” axis scale may change depending on the range of values in the graph itself, and the labels on the “x” axis scale may change depending on the time range of values selected (quarter/year, then number of years). Programming may enable colored graph lines 1908 to allow the user to differentiate between EBITDA, Revenue and Net Worth.

Based on the business user inputted information, programming may also enable a display 1910 in the business public profile of certain important business related ratios. As shown in the drawings the system is configured to display certain ratios in chart form. The chart may include “Net Worth”, “Liquidity”, “Debts/Assets”, “Revenue from Last Fiscal Year”, “Net Income”, “Total Cash”, “Debt Service Ratio/FCCR”, and “EBITDA”.

Programming may also enable the display in the business public profile of finances associated with the business user. As shown in the drawings, the system may be configured to present a display 1912 indicating: “Last Profitable Year”, and “Most Profitable Year”, and radio buttons to indicate income tax returns as “Cash Basis” or “Accrual Basis”, and internal financial statements as “Cash Basis” or “Accrual Basis.” Programming may also be configured to present displays of business income, for instance, “Annual Revenue”, “Interest Expense”, “Depreciation”, “Depletion”, “Amortization”, “Income Tax Expense”, “Net Income”, “and Officer Salary”. Programming may also present display related to inventory, for instance, “Type of Inventory”, “Inventory mix”, “Raw materials”, “Work in progress”, “Finished Goods”, and “Other.”

Programming may also be configured to present a display 1914 in the business public profile the name of the professional partner. For instance, programming may determine if the business user has a professional partner who most recently updated any record in that table. The programming may be then display that name. Programming may enable the business user to double click on a name which takes business user to the professional partner profile. A star rating for that professional partner may also be displayed next to name.

Programming may also be configured to present in the business public profile a display 1916 showing assets and a display 1918 showing liabilities information for the business. For instance, as shown in the drawings, asset type displays may include “Cash”, “Bank Account”, “Stocks”, “Bonds”, “Accounts Receivable”, “Business Owned”, “Equipment Owned”, “Real Estate Owned”, “Life Insurance”, and “Other”. Programming may also be configured to present “Ownership” and “Cash/Market Value.” For Accounts Receivable, programming may also be configured to present a detailed table for the particular asset type. For instance, as shown in the drawings, liability type displays may include “Equipment Loan”, “Equipment Lease”, “Credit Card”, “Revolving Charge Accounts”, “Commercial Real Estate Loans”, “Stock Pledges”, “Working Capital Line”, “Working Capital Term Loan”, “Capital Lease”, “Operating Lease”, “Judgement”, “Note From Share Holder”, “Pension”, and “Other”. Programming may be configured to present a display of “Monthly Payment”, “Interest Rate” and “Balance.” Contingent liabilities and loans may also be displayed.

Programming may also be configured to present a display 1920 of all document categories the business user has uploaded to their business profile. As shown in the drawings, the document categories are displayed in chart format with a green check next to each category of documents. Preferably, the programming does not display the actual document but provides indication of the nature of the document and that it is ready to be produced. Programming may be configured to adjust the number of rows depending on how many document categories the business user has currently uploaded.

Programming may also be provided to display in the business public profile a list 1922 of declarations completed by the business user. The declarations assist potential lenders in evaluating risk associated with the business. To facilitate evaluation of the answers to the declarations, the programming may present a display of a series of radio buttons with yes or no answers, and may include the generation of a dialog box that accepts free form text entry to allow a business user to provide an explanation.

Programming may also allow for the display of buttons 1924,1926 to allow a lender user or other user of the system to send an offer to the profile or a general message to be sent to the profile.

An auction forum with functionality similar to the consumer user may also be provided for the business user.

Once the profile is completed, the information will be displayed on the business user's home page as shown in FIG. 20. Public profile information for the business user will made available to users of the system in a format such as that shown in FIGS. 19(a)-19(c). Because a completed public profile for the business user provides indication that the business user has all the documents and information needed for a particular transaction, a lender user is in a position to make a hard offer to the business user. Once the business user accepts the offer, a secure work room may be generated and documents and other information needed for the transaction may be automatically produced to the lender user to allow the parties to finalize the transaction. Because the information needed to complete the transaction is provided by the business user in the course of completing the profile and before the profile is published and an offer is made, the lender user may make a hard offer that requires little or no follow-up, no substantive documentation or information, and only corroboration of the produced materials to consummate the transaction as discussed above.

### “Lender User”

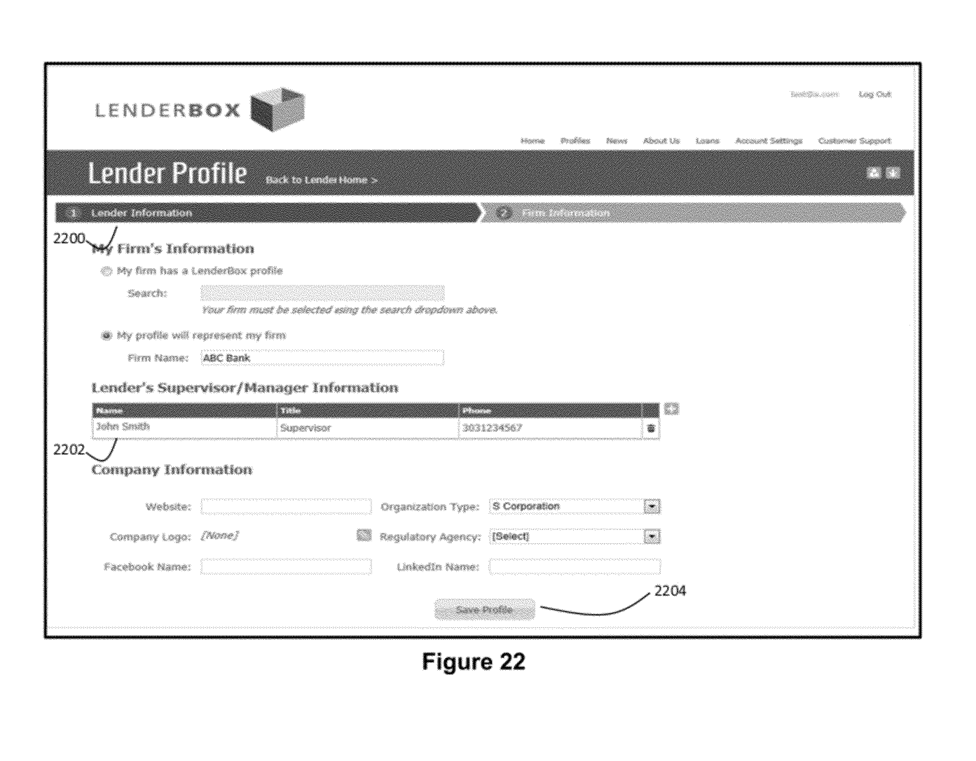

As shown in FIGS. 21, 22, and 23(a)-23(b), the system may be configured to present a series of displays to enable a lender to construct a lender profile. As used herein, a lender profile includes a lender representative's profile as well as lending firm or institution's profile. Generally speaking, the system is enabled to present a series of displays to allow a representative of a lending firm or institution to first construct a profile for the lending firm or institution (FIG. 22). The display may include fields 2200 with prompts to allow the representative to input information about the lending firm name, company website, organizational type, or regulatory agency. The display may include fields 2202 with prompts to allow the representative to input information about the lender representative's supervisor and manager information. The programming may be such that save button 2204 is displayed and clicking thereon stores the inputted information in the system database.

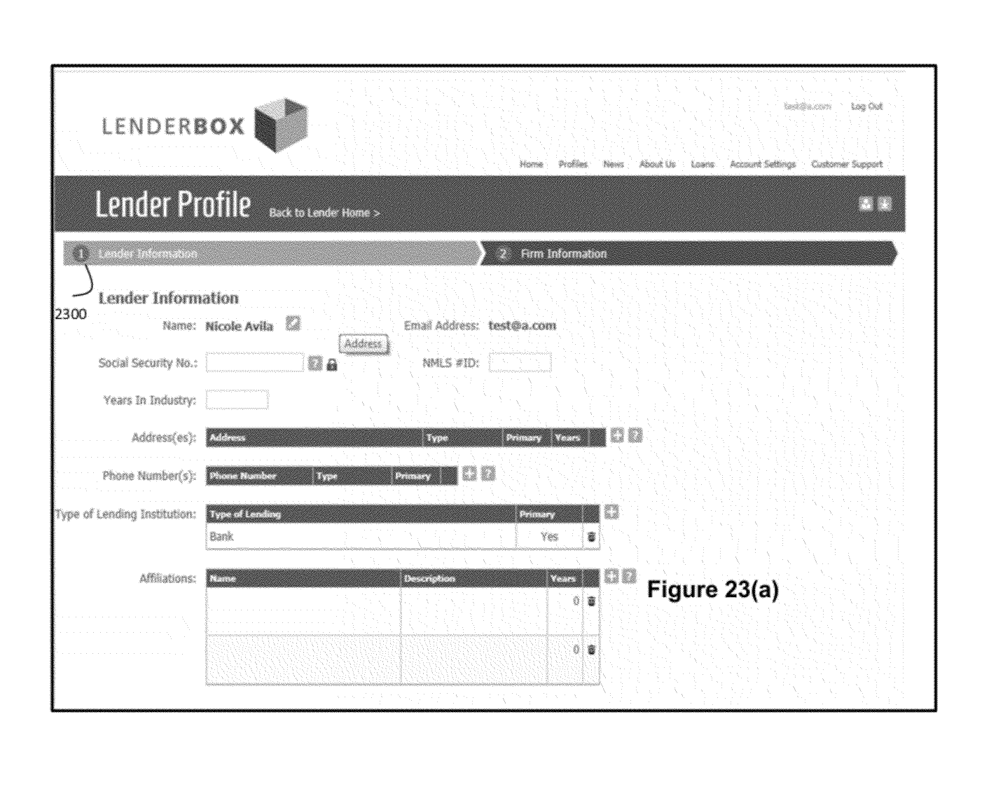

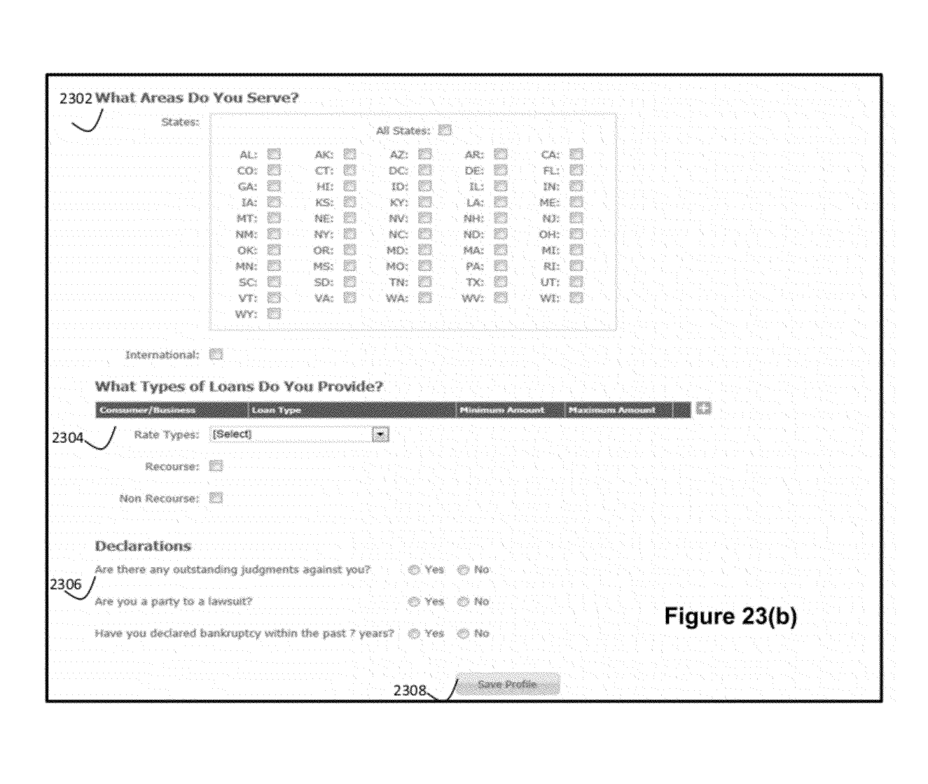

After constructing the profile for the lending firm, the lender representative will construct a lender user profile linked with the lending firm's profile (FIGS. 22(a)-22(b)). The display may include fields 2300 with prompts to allow the representative to input information about the representative. The basic information may include specific information associated with the representative, including the lender representative's address, phone number, NMLS ID number, and the representative's affiliations. As shown in FIG. 23(b), the display may include fields 2302 with prompts to allow the representative to input information about the areas in which the representative serves. Screen displays may also include prompts 2304 to enable the representative to describe the types of loans the representative generally provides. The programming may also be configured to present a display 2306 with declarations that businesses or consumer users may wish to review when considering a potential lender.

Once the lender user's profile (i.e., representative and firm) has been created, the lender user's profile may be saved to the database using a save button 2308. The lender user's profile may then be provided to other users in the system. FIG. 26 provides an illustrative representation of a screen display that may be presented to other users in the system showing a lender's public profile. FIG. 27 shows the lender user's home page with a dashboard indication indicating action items or other transactions in which the lender user may be involved.

### “Auction Forum”—Lender

The system has programming configured to present several screens that may be used to display all of the lender user's (i.e., financial institutions) activity on the system. Although the description that follows is directed toward a consumer user, similar functionality may be provided to allow the lender user to make offers to business users. For the ease of illustration, the functionality of the system will be discussed in the context of a consumer user.

Like for the consumer user, the programming may be configured to display the status of lender user's active transactions in work rooms. The secure work room will be discussed below in greater detail in reference to the discussion of FIGS. 33(a)-33(g). As shown in the drawings, the work room status information 2400 may be displayed in tabular form. The system has programming configured to present a button 2402 in the far-right column to allow the lender user to view a particular work room. For instance, work rooms assigned to the currently logged in lender user may be color coded (i.e., marked in red) to indicate to the specific user of the lender user that a work room needs attention. Programming may also configured to display in a color coded format work rooms that have tasks due within 2 days. The system programming may be configured to present a display 2404 of filter options to control the filters on the rows displayed in work room table. The options may include filter to display the work rooms that are currently active, and to display the work rooms for which transactions have been completed. The system may have programming configured to present a display 2406 of a calendar to assist the user in visualizing due dates for tasks. The programming may be such that clicking the calendar button may display a small calendar that highlights dates on which tasks are due. The programming associated with the calendar feature may be enabled to expand the calendar to display tasks in a visual context/layout with weekly and monthly views.

The system may also have programming to facilitate the lender user in evaluating submitted offers. Below the listing of work rooms, programming may be configured to present a display 2408 to show the lender user all the offers from lenders that have been submitted for a profile and/or application. For instance, as shown in the drawings, a submitted offers table 2408 displays all the offers that the lender has submitted that are in direct response to a profile or loan application. These offers are sorted by the application type (Profile, Home Loan, Auto Loan, etc.) then by the consumer user's profile number. The profile number only is displayed to provide anonymity in the process. Preferably, the programming is such that the first offer listed 2410 is the lender user's most current offer and is listed in bold text. Offers from other lender users appear in regular text. The programming may be configured to present a field 2412 showing a description of the offer. The programming may be configured to present a button 2414 to enable the lender user to view an offer. The programming may be such that clicking the view button displays the offer details in a modal dialog box. Preferably, the offer details page is in a read only format. The programming may be configured to present a button 2416 to enable the lender user to view information on other offers by other lenders. The programming may be configured to present a button 2418 to enable the lender user to view another lender's public profile. The programming may also be configured to present a display of a button 2420 to enable the lender to view information on the consumer user making a submission. As shown in the drawings, a view button 2420 allows the lender user to view the public profile of the user who submitted the profile or application and a view button 2422 beneath the application in the application type column allows the lender user to the view the particular application.

Programming associated with the submitted offers table may be configured to allow the lender user several options in viewing offers. For instance, as shown in the drawing, a show button 2424 may be configured to display a drop down menu with preselected options to control the filter on the rows displayed in submitted offers table. The programming may be configured to enable other options including a display of current offers that the lender has submitted and is essentially waiting a borrower's approval. The programming may be such that there may be a display of offers that the lender has submitted that have been accepted but do not have a complete transaction. These offers may match the records displayed in the work rooms with the filter in the work rooms table set to active. The programming may be such that another option may be a display of the current offers that the lender has submitted that the lending firm has not approved yet. The programming may be such that another option may be a display of every offer the lender has made, regardless of status. The table may be configured to display a sum total 2426 of the offers. The programming may be configured to present a display in connection with the table of several buttons to assist the lender user. The programming may be such that the counter offer button 2428 may be configured to display a draggable, non-modal dialog box that is displayed below the button. Inside the dialog box the counter offer is displayed with threshold values as defined in the offer. The programming may be such that the message button 2430 may be configured to display a modal dialog box to allow the lender user to transmit a message via the system to a recipient corresponding to the profile of the profile column

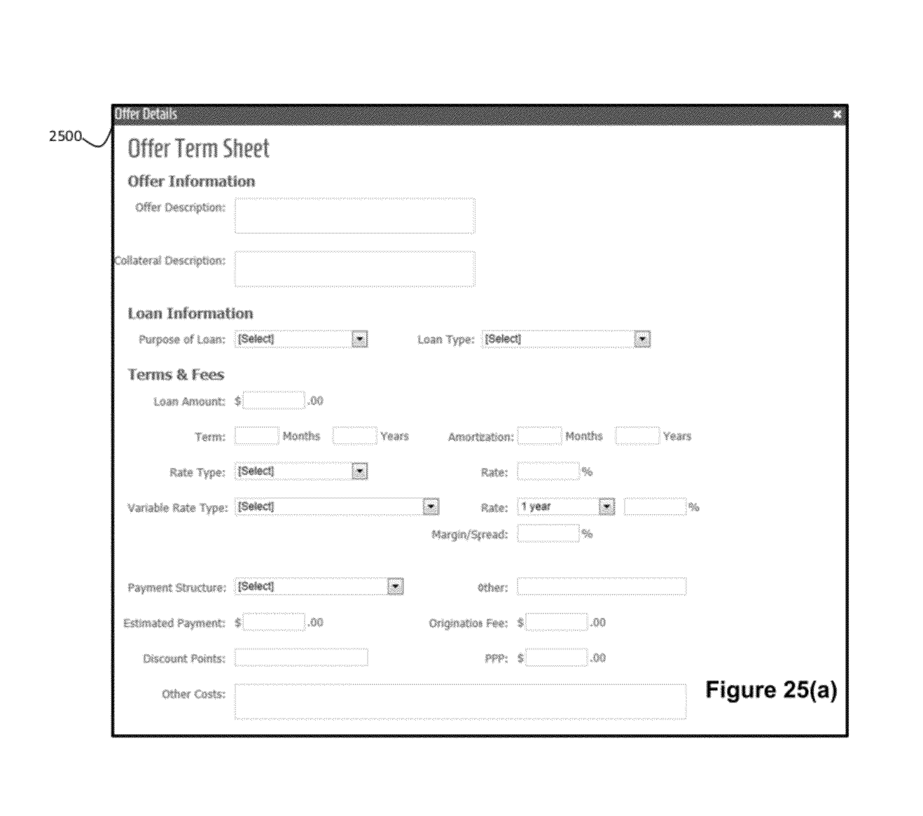

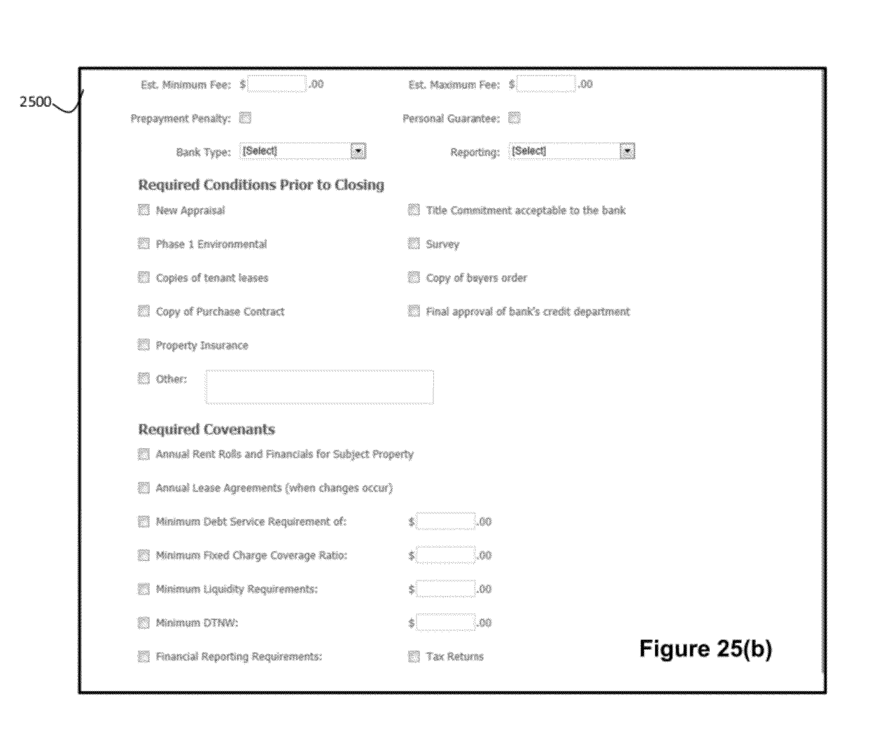

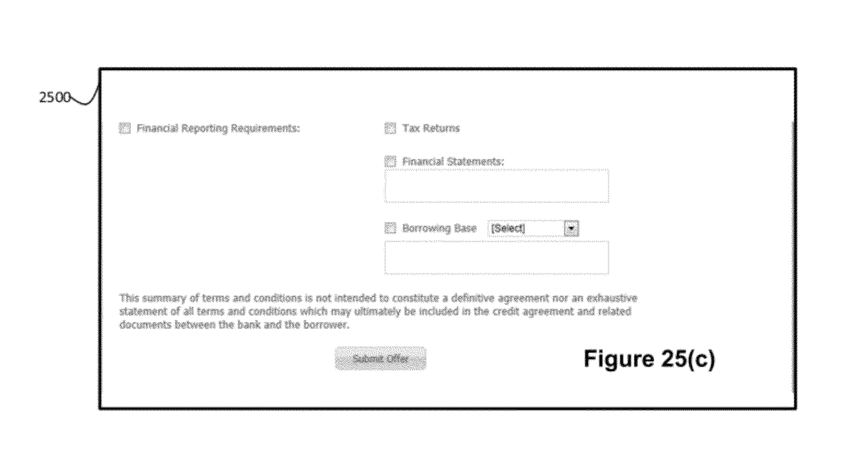

Below the submitted offers table, programming may be configured to present a display 2432 to allow a lender user to view general offers the lender has made. In the drawings, the display is indicated in a table format as “Submitted Opportunities”. In general, the information displayed relates to general offers or opportunities that are not attached to or in response to a specific profile or application. The system may have programming to present a display to allow a lender user to submit an offer. As shown in the drawings an add button 2434 enables the display of a dialog box that allows a lender user to create a new offer. The new offer will then show up in searches from consumer/business users. A representative dialog box 2500 containing the offer sheet is shown in FIGS. 25(a)-25(c). The programming may be such that the table may be configured to be sorted by the offer type and offer as defined by the lender.

The programming may be configured to present a display of an edit button 2436 in connection with the table to allow the lender user to make changes to their offer. Programming may be provided so that in clicking the edit button creates a display showing the offer details in modal dialog box. Upon submitting changes to the offer, all system users who have subscribed to the offer receive notification in their message board inbox that the offer has been updated.

The programming may be configured to present a display of a message button 2430 in connection with the table that may be configured to display a modal dialog box to allow the lender user to transmit a message via the system to a recipient corresponding to the profile of the Profile column

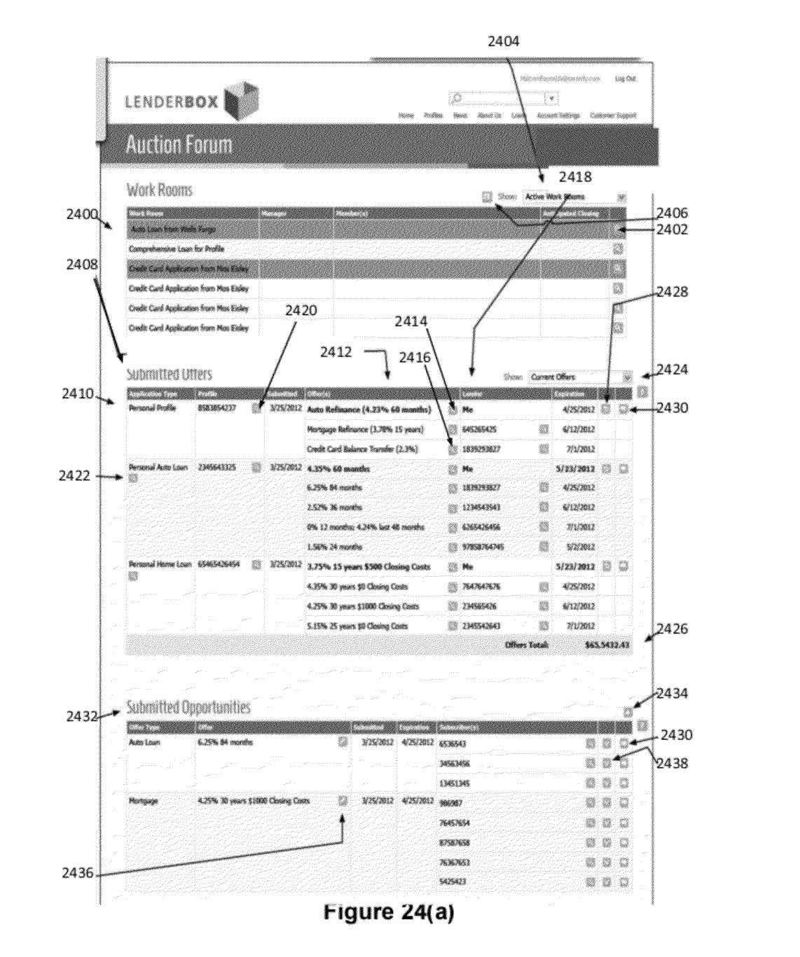

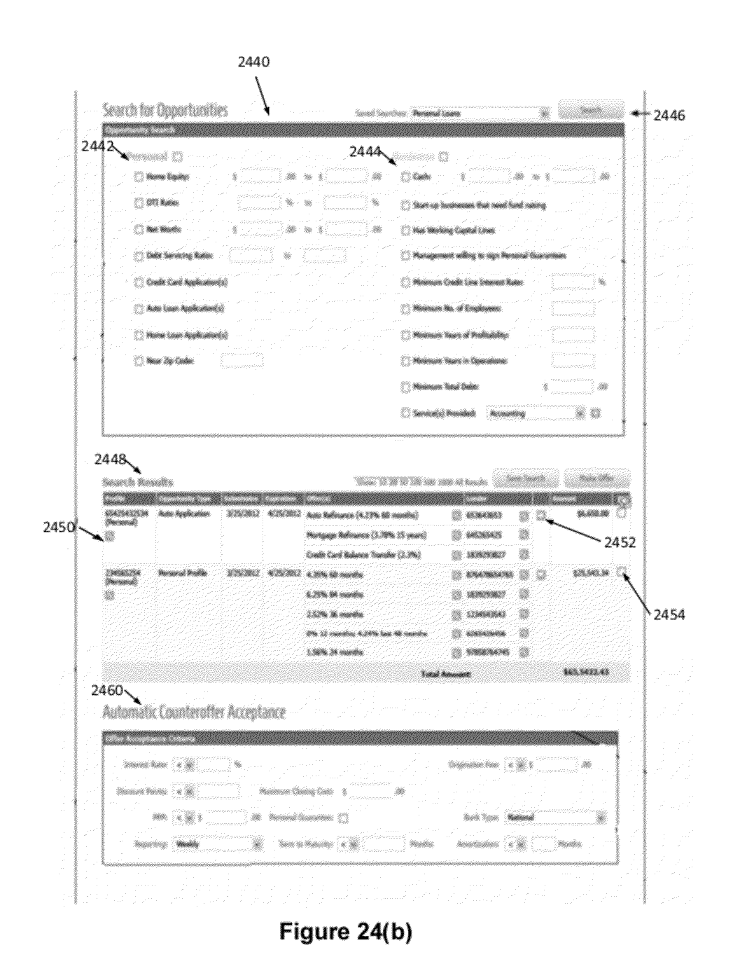

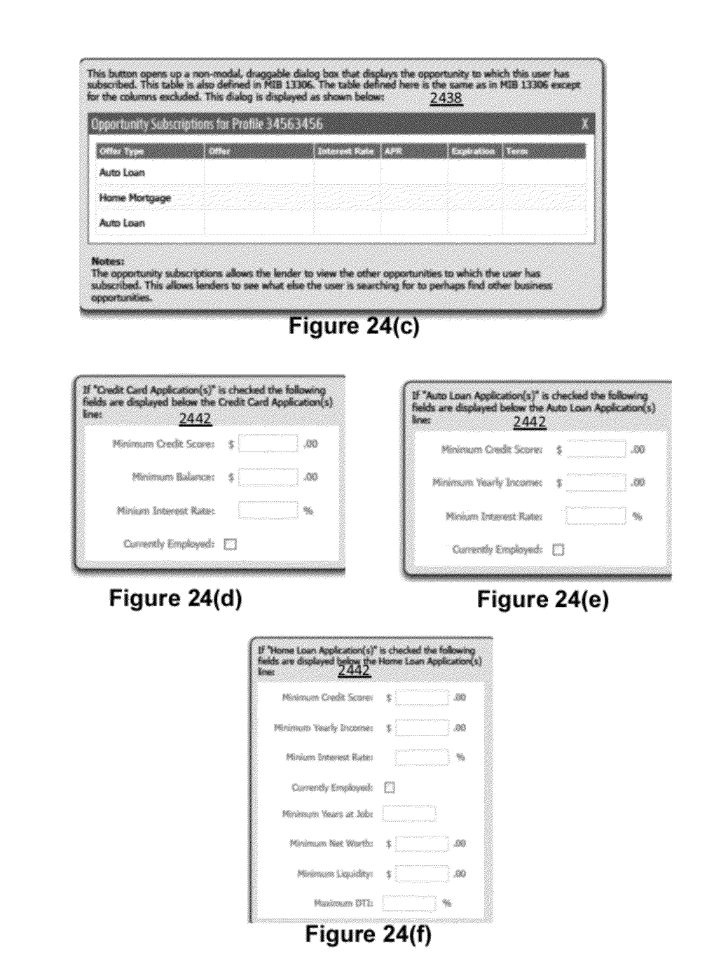

The programming may also be configured to present a display of a view subscription button 2438 in connection with the table. The programming may be such that activation of the view button may create a display comprising a non-modal, draggable dialog box such as that shown in FIG. 24(c) that displays the opportunity to which a particular consumer user has subscribed. The opportunity subscriptions allow the lender user to view the other opportunities to which the consumer user has subscribed. This allows the lender user to see what else the user is searching for to perhaps find other business opportunities.

The programming may also be configured to present fields in connection with the Auction Forum Borrower screens to allow the lender user to search for particular opportunities. As shown in FIG. 24(b), a “Search for Opportunities” display 2440 may appear and be configured with series of check boxes and drop down menus to allow a lender user to develop search criteria for new opportunities. The search criteria may be used to check for matches of criteria inputted by users through the “My Opportunities” screen presented to the consumer or business user. As shown in the drawings, the “Search for Opportunities” may be divided into two basic types: “Personal” 2442 and “Business” 2444, with further classifications in each basic type. For instance, “Personal” 2442 characteristics may include check boxes for: “Home Equity”, “DTI Ratio”, “Net Worth”, “Debt Servicing Ratio”, “Credit Card Application”, “Auto Loan Application”, “Home Loan Application”, and “Zip Code Locator”. Within certain classifications, additional programming may be provided to allow the lender user to provide search criteria. For instance, if “Credit Card Application” is checked the following fields may be displayed below the Credit Card Application(s) as shown by example in FIG. 24(d): “Minimum Credit Score”, “Minimum Balance”, “Minimum Interest Rate”, and “Currently Employed”. “If” Auto Loan Application(s)” is checked the following fields may be displayed below the Auto Loan Application(s) line as shown in FIG. 24(e): “Minimum Credit Score”, “Minimum Yearly Income”, “Minimum Interest Rate”, and “Currently Employed”. If “Home Loan Application(s)” is checked the following fields may be displayed below the Home Loan Application(s) line as shown in FIG. 24(f): “Minimum Credit Score”, “Minimum Yearly Income”, “Minimum Interest Rate”, “Currently Employed”, “Minimum Years at Job”, “Minimum Net Worth”, “Minimum Liquidity”, and “Maximum DTI”.

By way of example, “Business” characteristics 2444 may include check boxes for: “Start-up businesses that need fund raising”, “Has Working Capital Lines”, “Management willing to sign Personal Guarantees”, “Minimum Credit Line Interest Rate”, “Minimum No. of Employees”, “Minimum Years of Profitability”, “Minimum Years in Operations”, “Minimum Total Debt”, and “Services Provided”. For certain classifications, the system may be enabled to allow the lender user to further define search criteria. For instance, if “Has Working Capital Lines” is checked, the system may be configured to display a record in a table showing the account type corresponding to the user inputting their business lines of credit as displayed in the asset and liabilities screens presented to the user. Also, to assist the lender user in further defining search criteria, the “Service Provided” may be configured as a drop down menu that may also allow a lender user to search for multiple services that may be associated with a business or consumer user. Dialog boxes similar to those described above of the Personal opportunities may also be provided with fields specific to the search criteria selected.

Programming may also be provided to allow the lender user to save searches. As shown in the drawings, a “Saved Searches” button 2446 is provided. The saved searches feature allows the lender user to name and save a set of search parameters. Selecting a saved search from the drop down menu saves the saved search parameters and executes the search. Programming may be configured such that clicking the “Save Search” button opens a modal dialog box with a simple field to name the search and a save button to save the search. The dialog box may also have a cancel button that closes the dialog without saving the search.

The system may also be configured to display the search results from a current search or previously saved search. As shown in the drawings, the search results may be displayed in a “Search Results” table 2448. The results may include a display 2450 showing the consumer user's profile, opportunity type, submission date, expiration date, offer description, other lender's offers to the consumer user, and amount. The amount column includes either the loan amount field from the respective loan application or the total debt amount from the profile (e.g., the total from the liabilities table from the profile).

The system may have programming configured to present the display of a message button in the context of the search results table. The system may be configured such that activation of the message button 2452 creates a display of a dialog box where the lender user can enter free text with prompts to send a message via the system. The recipient of the message is the profile from the profile column The system may have programming configured to present the display of other lender users' offers and associated lender's public profile in the context of the search results table.

The search results table may also be configured to present check boxes 2454 to allow the lender user to select people to whom they will send an offer. As shown in the drawings, the search results table has a check box in the header that selects or deselects all the offers in the table. Programming may be provided such that clicking the make offer button opens up the offer details page. When the lender finishes filling out the offer details page as shown in FIGS. 25(a)-25(c), the offer is then sent to each of the selected user's message boards as an offer.

The system may also have programming configured to present a display 2460 with several fields that allow a lender user to set automatic counteroffer acceptance. For instance, as shown in the drawings, the Auction Forum—Borrower screens include an “Automatic Counter Offer Acceptance” section that allows a lender user to establish parameters that will automatically accept counter offers. Preferably, numeric criteria must be established for automatic offer acceptance. When a counteroffer matches the criteria established by the lender user, the programming is enabled to send a message via the system to the lender user's message board and a secure work room is created with the lender and the borrower. The programming may be configured such that the lender user's selections may be saved to the database. As shown in the drawings, the representative lender user criteria may include “Interest Rate”, “Origination Fee”, “Discount Points”, “Maximum Closing Cost”, “PPP”, “Personal Guarantee”, “Bank Type”, “Reporting”, “Term to Maturity”, and “Amortization”. The programming may be configured to present drop down menus to facilitate the lender user's entry of search criteria. For instance, for the field “Bank Type”, a drop down menu may be provided with the following menu selections: “All”, “International”, “National”, “Local”, “Credit Union”, “Broker”, “Private”, “VC”, “Private Equity”, “Factoring”, and “Asset Based Lender”.

Once the profile is completed, the information will be displayed on the lender user's home page as shown in FIG. 27. Public profile information for the lender user will made available to users of the system in a format such as that shown in FIG. 26.

### “Professional Partner”

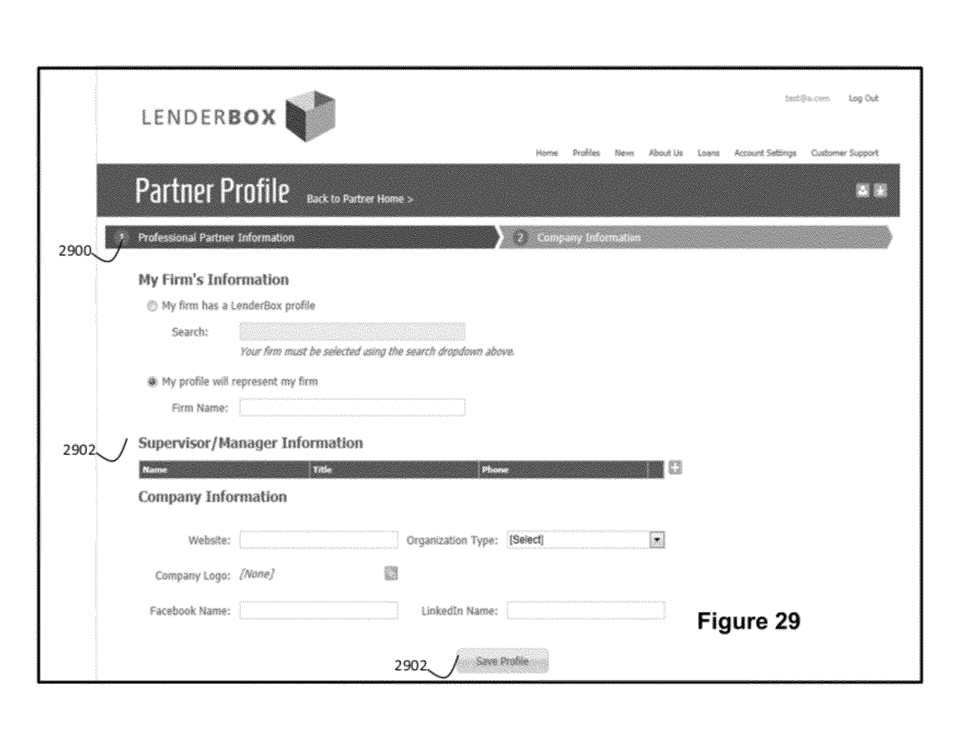

The professional partner pages (FIGS. 28, 29, 30(a)-30(b), 31, 32) are similar to the lender user pages and require the professional partner to generally perform two steps: first construct a firm or company information profile (if the professional partner has such an affiliation—if not, this step may be omitted); and then constructing a professional partner profile which may or may not be linked to the company or firm profile. As used herein, a professional partner profile includes a firm representative's profile as well as firm or institution's profile. Generally speaking, the system is enabled to present a series of displays to allow a representative of a lending firm or institution to first construct a profile for the firm or institution (FIG. 29). The display may include fields 2900 with prompts to allow the representative to input information about the firm's name, company website, organizational type, or regulatory agency. The display may include fields 2902 with prompts to allow the representative to input information about the representative's supervisor and manager information. A save button 2904 stores the inputted information in the system database.

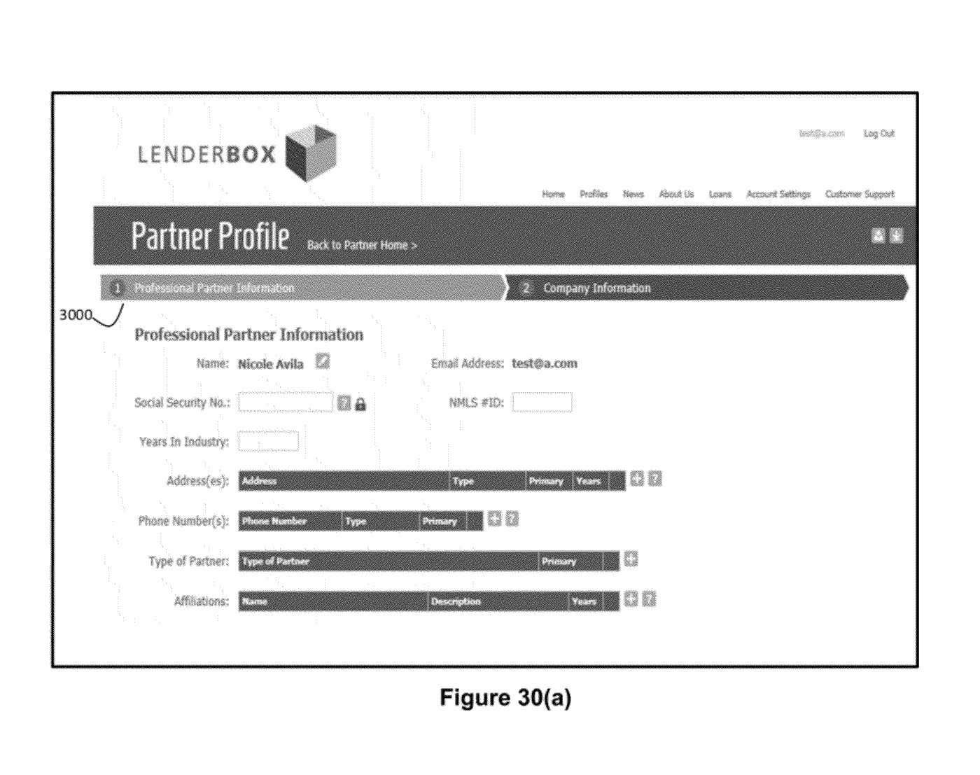

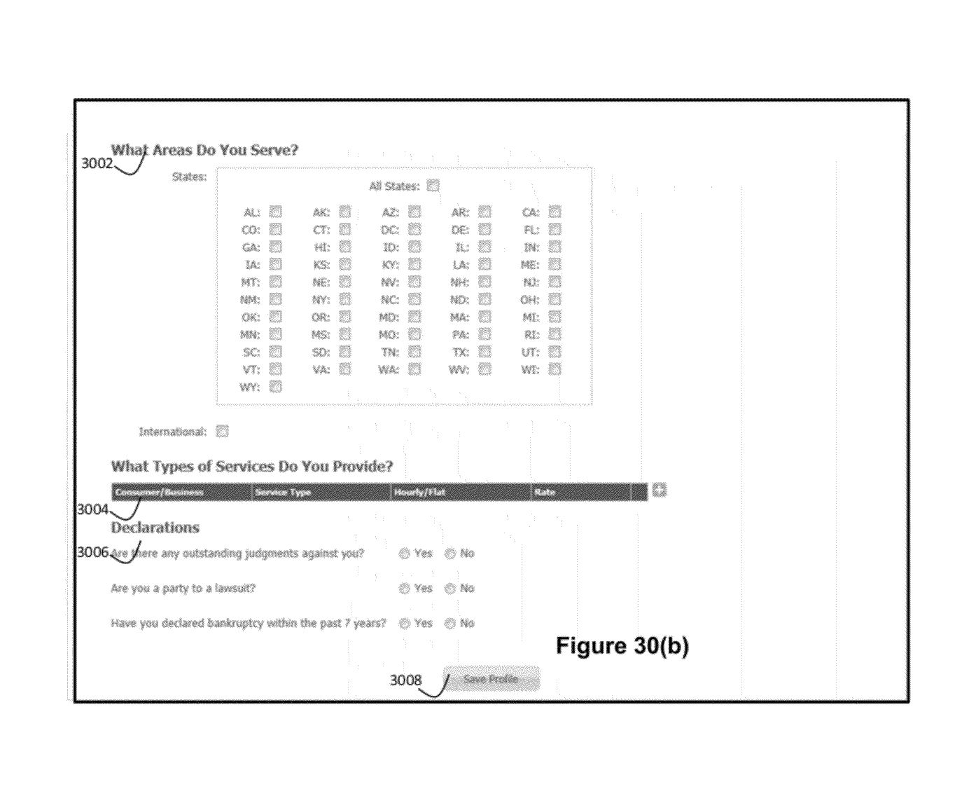

After constructing the profile for the firm, the representative will construct a user profile linked with the firm's profile (FIGS. 30(a)-30(b)). The programming may present a display that includes fields 3000 with prompts to allow the representative to input information about the representative. The basic information may include specific information associated with the representative, including the lender representative's address, phone number, NMLS ID number, and the representative's affiliations. As shown in FIG. 30(b), the display may include fields 3002 with prompts to allow the representative to input information about the areas in which the representative serves. Screen displays may also include prompts 3004 to enable the representative to describe the types of services the representative generally provides. The programming may also be configured to present a display 3006 with declarations that businesses and/or consumer users may wish to review when considering a potential professional partner. Once the professional partner's profile has been created, the programming may be such that the profile may be saved in the database with a save button 3008. A public version of the profile may be provided to the system. FIG. 31 shows a representative screen display illustrating the professional partner public profile that may be provided to the system. FIG. 32 provides a representative screen display of a professional partner's home page with a dash board indication showing the status of items in which the professional partner may be engaged.

### “Secure Work Room”

As explained earlier, the system may have programming configured to present a series of displays (i.e., a secure work room) to allow the parties to complete a transaction. FIGS. 33(a)-33(f) show exemplary displays of a secure work room to facilitate users in completing transactions. Programming is configured to present a display 3300 of members associated with or involved with a transaction. The display may be in a table format. As shown in the drawings, the “Members Table” shows all members who are assigned to a work room. The number of people shown in the example (i.e., 2 members) is exemplary, and is not limited.

The system processor is programmed configured to display icons to allow users to send instant messages, and messages are then sent to a user's message board. For instance, users that are currently logged into the system may have the chat icon 3302 displayed in their row and may be displayed in bold text. The programming may be such that clicking on the chat icon button 3302 will initiate a chat with that user via a chat dialog box 3303 such as that shown in FIG. 33(d). Preferably, the chat dialog box is non-modal and draggable. The system processor may have programming to enable multiple chats may be initiated simultaneously with different users. The system processor may have programming to enable chat transcripts to be saved as a message that may be sent to the user's system message board (as opposed to the work room message board, discussed below) whenever the user closes the chat dialog.

The system also has programming configured to send messages to users who may not be currently logged into the system. The programming may be such that clicking the message button 3304 will open a new message dialog box that may receive free form text. Using the message button, a user can send a new message to that individual. The user may have options to send the message to the individual's system message board (i.e., a private message for that user) or the work room message board.

The system may have programming configured to create the work room message board 3306 (as opposed to the user's system message board) and display only those messages sent to the work room email and the work room itself. This allows all group members to see the group communication without creating duplicate messages in each individual's system message board. The system may have programming such that when a work room is set up and a group member is added to the work room, a folder for the work room is automatically created in the user's system message board where all work room message board message are also stored.

The system may have programming configured to allow a user to add members to a work room. For instance, as shown in the drawing a plus button 3308 is displayed in the table showing the current members of a work room. The programming may be such that clicking the plus button displays a modal dialog box 3310 such as that shown in FIG. 33(b) to invite a member to the work room. The dialog box may include a field to enter the user's email address and notes to invite a member to a work room. The programming may be such that clicking a send button in the dialog box sends a message to the user's system message board inviting the user to be a part of the work room. The programming may be such that a link in the message allows the invited user to accept the invitation. Programming associated with the link adds the invited user to the message board if the user accepts the invitation. If the invited user is not a system member, the programming may be such that the message includes a link to allow the user to log into the system and join the work room. For instance, the email message may prompt the invited user to create a system account that is then associated with the work room.

The system may have programming to present a display 3311 of tasks associated with a particular transaction in a work room. For instance, as shown in the drawings, the tasks may be presented in a table format. When a new secure work room is created, the work room manager may create tasks to be presented in the table. Programming may be configured to present a display of settings button 3312. Programming may be such that clicking the setting button generates a modal dialogue box 3313 such as that shown in FIG. 33(c) that allows the work room manager to set-up the work room and task(s) associated with the transaction. The dialog box may include a free form text field to allow the work room manager to enter a work room a title. The system may also have programming to display within the dialog box a tasks template. The tasks template determines the default tasks loaded into the work room table. Once a work room is created with its task template default tasks, users can add/edit/delete tasks throughout the work process. The work room manager can also set up a group email address to be used for files to be sent to the group. Whenever an email with an attachment is sent to this email address, the attached file may be uploaded to the document table and a message may be added to the work room's message board.

The system may have programming configured to allow a user to filter tasks. For instance, as shown in the drawings, task table drop down 3314 may be provided with the following: “All Tasks (displays all tasks regardless of status)”; “Submitted Tasks (displays all tasks submitted to manager for approval)”; “Active Tasks (displays all tasks with status of pending or working)”; “Completed Tasks (displays all tasks with status of complete)”; and “Cancelled Tasks (displays all tasks with status of cancelled).” As shown in the drawings, the tasks table may be presented as an in-line editable table. The first column in the table may display the sort handle that allows the user to drag/drop sort the task. A second column is a text field allowing the user to describe the task (“task column”). A third column displays a drop down list of work room members to which the task can be assigned (“assigned column”). When the assigned column is completed with a member's name, programming may be configure to enable notification to be sent to the person to whom the task is assigned via the work room message board. When an entry in the assigned column is changed, programming may enable a message to be sent to the person who had been assigned the task indicating that they are no longer assigned the task, and programming may enable a message to be sent to the person to whom the task is now assigned. A fourth column includes the date for which a task is assigned. The fourth column may be set up as a read only field that is updated with the current date when a task is assigned to someone, showing the date when the task was assigned to the current individual. A fifth column may be set up to display status of an assigned task. As shown in the drawings, the status column may have the following options: “Submitted”, “Pending”, “Working”, “Complete”, and “Cancelled”. If a task is indicated as “Working,” the display may present a bar for the task with a red background color indicating the current task where the workflow resides. Multiple tasks can be marked as “Working” and may indicate who has the “hot potato.” Whenever a task status or due date is changed, programming may enable a notification to be sent to all group members via the work room message board. A sixth column may indicate the due date of the task (“due date column”). The user selects the date via a calendar date picker. If a task still has the status of “pending” or “working” past the task's due date, programming may enable notification to be sent to all group members via the message board.

When a task is created, programming may be configured to enable a message to be sent to the work room manager's message board that a new task has been created. The programming may be such that the individual identified as the work room manager is the only person that can change the status of a submitted task to “pending” and assign it out. The programming may be such that all new tasks must be approved by the work room manager. The programming may be such that a new task has the status of “submitted” until the work room manager has changed the status and initiated the task as part of the workflow. The programming may be such that once the task is part of the workflow (i.e., the manager has assigned it/changed status to pending/working), the user who is assigned the task controls the status of the task without needing any approvals.

The system processor may have programming configured to present the display of icons to facilitate viewing materials in the work room. For instance, the work room table may include a view offer sheet button 3315. The programming may be such that clicking the view offer sheet button opens the offer details page in a modal dialog box. If the user is a lender (and the creator of the offer), the programming may be such that the offer details page may be editable so that the offer can be changed as the negotiation process occurs through the course of the work room tasks/review/etc.

Also, as shown in the drawings, a refresh button 3316 is provided. The programming may be such that the refresh button reloads the data for the tables so that the user can see any changes made by other members of the work room. While these changes will appear as the user is interacting with the tables themselves, if the user has been working in tasks, for example, and has not done anything with messages or documents, the programming may be such that clicking the refresh button will reload all the tables so the user sees the latest information.

Also as shown in the drawings, a calendar button 3317 may be provided. The programming may be such that clicking the calendar button displays a small calendar that highlights dates on which tasks are due. The programming may be such that the calendar may be expanded to display tasks in a visual context/layout with weekly and monthly views.

The system processor may have programming to present the display of other icons to facilitate communication among members of a work room. For instance, as shown in the drawings, a down arrow 3318 may be displayed. The programming may be such that clicking the down arrow button displays a small-non modal dialog box 3320 such as that shown in FIG. 33(f), positioned directly below the button that shows the default document permissions for that user. For instance, the dialog box may show permissions as “View/Download”, “Modify/Upload”, and “Manage Permissions” with a check box indicating whether the user has a specific level of permissions. The programming may be such that the status labels may be changed as needed. The programming may be such that the permissions represent the default permissions for all new documents uploaded to the work room. If a user is logged in as the group manager, the check box controls are editable as the group manager administers permissions for the other group members. The programming may be such that the work room manager administers all work room privileges and may assign another user these administrative rights. Accordingly, the “Manage Permissions” row shown in the drawings is available only for the work room manager.

The processor may be programmed to present a display showing documents in the work room 3322. The display may be in a table format. For instance, as shown in the drawings, a document table is shown that displays the documents that are related to a particular work room and a button 3324 (i.e., “down arrow button”) that displays document specific permissions. The document permissions may be shown in a non-dialog box 3326 such as that shown in FIG. 33(e) positioned directly beneath the down arrow button. The permissions may be displayed in a chart format showing the member's name and document permissions as a check mark, for instance, “Modify/Upload” and “View/Download”. Documents may be added to the document table using a document upload logic that stores the documents in the database automatically with specific keys that link the documents to a particular work room. The document upload logic may also include programming that enables sending a message to the group message board as soon as a document is uploaded, notifying all group members that a new document has been uploaded.

The programming may be such that the permissions may be changed for each document as necessary in the documents table, discussed below. Preferably, the programming is such that the default permissions may be changed on a global basis and may be overridden as to a specific document. For instance, if the user has “View/Download” permissions but then the work room manager changes those permissions, the programming may be such that the permissions for all documents are changed except those that have been changed at the document level. If the user has “View/Download” permissions, then the programming may be such that the document titles in the document table are active as links so the user can download the document. Otherwise the document titles are not active as links. The programming may be such that if the user has “Modify/Upload” permissions, then the user can upload a modified version of the document into the documents library, for instance, the user can download the document, make changes to a document, and then upload the document. The uploaded document will save over and replace (i.e., overwrite) the document stored in the document library. If the user does not have “Modify/Upload” permissions, the programming may be such that the user may still upload a document, but the user may not upload the document and save over the document stored in the documents library, for instance, the user could upload the document to the system as a new or renamed document.

The system may also have programming configured to present a display to allow the work room manger to close the work room. For instance, as shown in FIG. 33(a), a check button 3328 may be provided to allow the group manager to close the secure work room once the transaction is complete. The programming may be such that clicking on the check button may present the display of a dialog box 3300 such as that shown in FIG. 33(g), prompting confirmation from the work room manager that the transaction is complete. The programming may be such that only the work room manager can close a work room, and the check button is hidden for all other members. The programming may be such that closing the work room marks all tasks as complete and any further access to this work room is on a read-only basis. The programming may be such that documents may be downloaded and viewed, but no tasks, members, or documents may be added to a closed work room. When a work room is closed, the programming may be such that notification is sent to all group members. Additionally, when a work room is closed, the programming may be such that an archival read-only version of the offer sheet is generated and the user is prompted to sign the document digitally. When the document is signed when a work room is closed, the programming may be such that the view offer sheet icon is replaced with the locked icon.

The system may also have programming to present a display 3332 relating to billing information. For instance, as shown in the drawings, a billing table may be presented in a read only format. Billing tasks may be added and displayed in the billing table when called for by the task template. The task template may include a dialog box with fields allowing the user the input billing information.

While specific embodiments have been described in detail in the foregoing detailed description and illustrated in the accompanying drawings, those with ordinary skill in the art will appreciate that various modifications and alternatives to those details could be developed in light of the overall teachings of the disclosure. Accordingly, the particular arrangements disclosed were meant to be illustrative only and not limited as to the scope of the invention which is to be given the full breadth of the appended claims and any equivalents thereof.

What is claimed is:

1. A system for facilitating debt instrument transactions, the system comprising:
a processor for communication with a plurality of remote computers via a network; and
a memory;
the processor configured to:
store a data structure in the memory, the data structure comprising a plurality of data items associated together as a user profile, the data items comprising data representative of a financial condition and creditworthiness for a user associated with the user profile;
complete a debt instrument transaction between the user and a lender in response to inputs from a plurality of the remote computers;
detect the completed debt instrument transaction; and
in response to detection of the completed debt instrument transaction, automatically update the stored user profile based on the completed debt instrument transaction to thereby keep the user profile current such that a lender can review the updated user profile to make a decision on whether to extend an offer to the user regarding another debt instrument transaction.

2. The system of claim 1 wherein the user profile comprises data items representative of (1) an identity for the user, (2) an employment and income history for the user, (3) a credit financial condition for the user, (4) an automobile financial condition for the user, (5) a real estate financial condition for the user, and (6) an assets/liabilities condition for the user.

3. The system of claim 2 wherein the processor is further configured to (1) provide data to a first of the remote computers for populating at least one user interface screen displayed on the first remote computer, the provided data configured to solicit data from the user for populating the user profile, (2) receive data from the user for populating the user profile, and (3) store the received data in the user profile.

4. The system of claim 3 wherein the processor is further configured to (1) provide a second of the remote computers for operation by the lender with view access to the data within the stored user profile, (2) receive input from the second remote computer that is indicative of a request to extend a hard offer to the user with respect to a debt instrument transaction, (3) create a hard offer for the debt instrument transaction in accordance with the received input, (4) communicate the hard offer to the first remote computer for display thereon, and (5) receive input from the first remote computer indicative of an acceptance of the hard offer.

5. The system of claim 4 wherein the processor is further configured to (1) receive corroborating data from the first remote computer through the at least one user interface screen, the corroborating data comprising data that is representative of documentary supporting evidence with respect to at least one of the data items of the user profile, (2) store the corroborating data in association with the user profile, and (3) provide the second remote computer with access via a network to the corroborating data for use by the lender to make a decision regarding whether to extend a hard offer to the user with respect to a debt instrument transaction.

6. The system of claim 5 wherein the corroborating data comprises a copy of a governmental income tax return for the user.

7. The system of claim 5 wherein the corroborating data comprises a copy of a credit account statement for the user.

8. The system of claim 5 wherein the processor is further configured to permit the lender to select a type of debt instrument transaction for extending the hard offer to the user from among a plurality of types of debt instrument transactions, the plurality of debt instrument transaction types comprising at least two selected from the group consisting of (1) a transaction type to extend an amount of unsecured credit to the user, (2) transaction type for a credit account balance transfer, (3) a transaction type to extend an amount of secured credit to the user, (4) a transaction type for a mortgage, (5) a transaction type for a mortgage refinancing, (6) a transaction type for a home equity line of credit, and (7) a transaction type for an automobile loan.

9. The system of claim 5 wherein the processor is further configured to complete a second debt instrument transaction between the user and a lender based on the updated user profile without any further changes to the updated user profile by the user prior to the completion of the second debt instrument transaction.

10. The system of claim 5 wherein the processor is further configured to provide a secure workroom for collaboration between the user and the lender to complete the debt instrument transaction.

11. The system of claim 10 wherein the memory is further configured to store a plurality of trusted advisor profiles, each trusted advisor profile corresponding to a professional advisor, the user profile being associated with at least one trusted advisor profile, and wherein the processor is further configured to provide the professional advisor corresponding to the trusted advisor profile that is associated with the user profile with access to the hard offer for assisting the user with respect to whether to accept the hard offer.

12. The system of claim 10 wherein the memory is further configured to store a plurality of trusted advisor profiles, each trusted advisor profile corresponding to a professional advisor, the user profile being associated with at least one trusted advisor profile, and wherein the processor is further configured to provide the professional advisor corresponding to the trusted advisor profile that is associated with the user profile with access to the secure workroom for assisting the user to complete the debt instrument transaction.

13. The system of claim 12 wherein the trusted advisor profiles correspond to at least one member of the group consisting of an attorney, a financial advisor, and an accountant.

14. The system of claim 5 wherein the processor is further configured to (1) receive input from the first remote computer indicative of a sharing flag for the user profile, (2) store data representative of the sharing flag in association with the user profile, and (3) limit the viewability of the user profile to a lender based on the sharing flag.

15. The system of claim 5 wherein the processor is further configured to (1) receive input from the first remote computer indicative of at least one transaction interest for the user, (2) store data representative of the transaction interest in association with the user profile, and (3) limit a type of hard offer for a debt instrument transaction eligible for communication to the user in accordance with the transaction interest.

16. The system of claim 15 wherein the transaction interest comprises at least one member selected from the group consisting of a (1) credit account transaction interest, (2) an automobile loan transaction interest, (3) a home loan transaction interest, and (4) a loan consolidation transaction interest, and wherein the processor is further configured to provide data to the first remote computer for populating at least one user interface screen displayed on the first remote computer such that the at least one user interface screen is configured to list the group members as selectable options for the user to define the at least one transaction interest.

17. The system of claim 16 wherein the processor is further configured to (1) receive input from the first remote computer indicative of a priority with respect to a plurality of types of debt instrument parameters, (2) store data representative of the parameter priorities in association with the user profile, and (3) permit the lender to view the parameter priorities.

18. The system of claim 15 wherein the processor is further configured to (1) receive input from the first remote computer indicative of a priority with respect to a plurality of types of debt instrument parameters, (2) store data representative of the parameter priorities in association with the user profile, and (3) permit the lender to view the parameter priorities.

19. The system of claim 18 wherein the types of debt instrument parameters comprise at least two selected from the group consisting of (1) an interest rate parameter, (2) a monthly payment amount parameter, (3) a fees/closing costs amount parameter, and (4) a cash amount parameter, and wherein the processor is further configured to provide data to the first remote computer for populating at least one user interface screen displayed on the first remote computer such that the at least one user interface screen is configured to list the debt instrument parameter types as selectable options for the user to define the parameter priorities.

20. The system of claim 5 wherein the processor is further configured to create and administer an auction between a plurality of lenders with respect to a potential debt instrument transaction in response to a request from the first remote computer.

21. The system of claim 5 wherein the memory is configured to store a plurality of the user profile data structures for a plurality of different users, and wherein the processor is further configured to (1) define at least one search criterion in response to input from the second remote computer, (2) perform a search of a plurality of the user profiles to find any user profiles that match the defined at least one search criterion, and (3) communicate a result of the search to the second remote computer.

22. The system of claim 21 wherein the at least one search criterion comprises an interest rate paid by a user for a debt with reference to a threshold.

23. The system of claim 21 wherein the at least one search criterion comprises a geographic location for a user.

24. The system of claim 21 wherein the at least one search criterion comprises an amount of home equity for a user.

25. The system of claim 21 wherein the at least one search criterion comprises a debt-to-income ratio for a user.

26. The system of claim 21 wherein the at least one search criterion comprises a net worth for a user.

27. The system of claim 21 wherein the at least one search criterion comprises a credit score for a user.

28. The system of claim 21 wherein the at least one search criterion comprises an expressed interest by a user with respect to a particular type of debt instrument transaction.

29. The system of claim 5 wherein the memory is configured to store a plurality of the user profile data structures for a plurality of different users, and wherein the processor is further configured to (1) define at least one criterion for automatically generating a hard offer with respect to a debt instrument transaction in response to input from the second remote computer, (2) perform a search of a plurality of the user profile data structures to find any user profiles having parameters that match the defined at least one criterion, and (3) in response to the search finding a user profile that matches the defined at least one criterion, automatically generate a hard offer for a debt instrument transaction and communicating the generated hard offer to the user associated with the matching user profile.

30. The system of claim 29 wherein the processor is further configured to (1) define a plurality of parameters for inclusion in the automatically generated hard offer in response to input from the second remote computer, and (2) incorporate the defined parameters in an automatically generated hard offer.

31. The system of claim 29 wherein the at least one criterion comprises at least one member of the group consisting of (1) an interest rate paid by a user for a debt with reference to a threshold, (2) an amount of home equity for a user, (3) a debt-to-income ratio for a user, and (4) a net worth for a user.

32. The system of claim 29 wherein the at least one criterion comprises a plurality of criteria, the plurality of criteria comprising at least two members of the group consisting of (1) an interest rate paid by a user for a debt with reference to a threshold, (2) an amount of home equity for a user, (3) a debt-to-income ratio for a user, and (4) a net worth for a user.

33. The system of claim 29 wherein the at least one criterion comprises a plurality of criteria, the plurality of criteria comprising an expressed interest by a user with respect to a particular type of debt instrument transaction and at least one member of the group consisting of (1) an interest rate paid by a user for a debt with reference to a threshold, (2) an amount of home equity for a user, (3) a debt-to-income ratio for a user, and (4) a net worth for a user.

34. The system of claim 29 wherein the at least one criterion comprises a plurality of criteria, the plurality of criteria comprising a geographic location for a user and at least one member of the group consisting of (1) an interest rate paid by a user for a debt with reference to a threshold, (2) an amount of home equity for a user, (3) a debt-to-income ratio for a user, and (4) a net worth for a user.

35. The system of claim 29 wherein the processor is further configured to (1) define at least one acceptance criterion for at least one user profile in response to input from at least one first remote computer for a user associated with the at least one user profile, the at least one acceptance criterion for automatically accepting a hard offer with respect to a debt instrument transaction, and (2) for the at least one user profile, with respect to a received hard offer for a debt instrument transaction, (i) determine whether the received hard offer matches the defined at least one acceptance criterion, and (ii) in response to a determination that the received hard offer matches the defined at least one acceptance criterion, automatically accept the received hard offer.

36. The system of claim 5 wherein the processor is further configured to (1) define at least one acceptance criterion for the user profile in response to input from the first remote computer, the at least one acceptance criterion for automatically accepting a hard offer with respect to a debt instrument transaction, and (2) with respect to a received hard offer for a debt instrument transaction, (i) determine whether the received hard offer matches the defined at least one acceptance criterion, and (ii) in response to a determination that the received hard offer matches the defined at least one acceptance criterion, automatically accept the received hard offer.

37. The system of claim 36 wherein the at least one acceptance criterion comprises at least one member of the group consisting of (1) an interest rate for a debt instrument with reference to a threshold, (2) an origination fee for a debt instrument with reference to a threshold, (3) an amount of discount points for a debt instrument with respect to a threshold, (4) an amount for closing costs with respect to a threshold, (5) a term to maturity for a debt instrument with respect to a threshold, (6) an amortization duration for a debt instrument with respect to a threshold, and (7) a lender type for a lender associated with the hard offer.

38. The system of claim 36 wherein the at least one acceptance criterion comprises a plurality of acceptance criteria, the plurality of acceptance criteria comprising at least two members of the group consisting of (1) an interest rate for a debt instrument with reference to a threshold, (2) an origination fee for a debt instrument with reference to a threshold, (3) an amount of discount points for a debt instrument with respect to a threshold, (4) an amount for closing costs with respect to a threshold, (5) a term to maturity for a debt instrument with respect to a threshold, (6) an amortization duration for a debt instrument with respect to a threshold, and (7) a lender type for a lender associated with the hard offer.

39. The system of claim 5 wherein the completed debt instrument transaction comprises a transaction that changes an amount of credit that has been extended to the user to a new amount, the processor being configured to automatically update the user profile to reflect the new amount.

40. The system of claim 5 wherein the completed debt instrument transaction comprises a transaction that changes an interest rate for a debt owed by the user to a new interest rate, the processor being further configured to automatically update the user profile to reflect the new interest rate.

41. The system of claim 40 wherein the debt is a mortgage debt.

42. The system of claim 40 wherein the debt is an unsecured credit debt.

43. The system of claim 5 wherein the completed debt instrument transaction comprises a transaction that changes a mortgage owed by the user to a new mortgage amount, the processor being configured to automatically update the user profile to reflect the new mortgage amount.

44. The system of claim 5 wherein the memory is configured to store a plurality of the user profile data structures for a plurality of different users, and wherein the processor is further configured to (1) analyze a plurality of the user profile data structures to determine an average characteristic for a type of debt, (2) for at least one of the user profile data structures having a data item representative of that characteristic for that type of debt, compare that characteristic for that type of debt in the at least one user profile data structure with the average characteristic, and (3) communicate a result of the comparison to the user associated with at least one user profile data structure.

45. The system of claim 44 wherein the processor is further configured to analyze a plurality of the user profile data structures for a plurality of users within a defined geographic area to determine the average characteristic.

46. The system of claim 5 wherein the user profile data structure includes at least one data item that is representative of an interest rate for at least one debt of the user, wherein the memory is configured to store a plurality of the user profile data structures for a plurality of different users, and wherein the processor is further configured to (1) analyze a plurality of the user profile data structures to determine an average interest rate for a type of debt, (2) for at least one of the user profile data structures having a data item representative of an interest rate for that type of debt, compare the interest rate for that type of debt in the at least one user profile data structure with the average interest rate, and (3) communicate a result of the comparison to the user associated with at least one user profile data structure.

47. The system of claim 46 wherein the processor is further configured to analyze a plurality of the user profile data structures for a plurality of users within a defined geographic area to determine the average interest rate.

48. The system of claim 5 wherein the user profile is associated with a user who is an individual.

49. The system of claim 1 wherein the user profile is associated with a user that is a business entity, the user profile comprising data representative of (1) an identity for the business entity, (2) an annual profit history for the business entity, (3) a credit financial condition for the business entity, (4) an assets/liabilities condition for the business entity, (5) an amount of time in operation for the business entity, (6) a employee total for the business entity, and (7) a line of business for the business entity.

50. The system of claim 1 wherein the debt instrument transaction comprises a transaction to extend an amount of unsecured credit to the user.

51. The system of claim 1 wherein the debt instrument transaction comprises a credit account balance transfer.

52. The system of claim 1 wherein the debt instrument transaction comprises a transaction to extend an amount of secured credit to the user.

53. The system of claim 1 wherein the debt instrument transaction comprises a mortgage transaction.

54. The system of claim 1 wherein the debt instrument transaction comprises a mortgage refinancing transaction.

55. The system of claim 1 wherein the debt instrument transaction comprises a home equity line of credit transaction.

56. The system of claim 1 wherein the debt instrument transaction comprises an automobile loan transaction.

57. The system of claim 1 further comprising a server, wherein the processor and memory are resident on the server.

58. The system of claim 57 wherein the server comprises a plurality of networked servers, at least one of the servers hosting a website for interacting with the user and the lender.

59. The system of claim 1 wherein the processor comprises a plurality of processors.

60. A method for facilitating debt instrument transactions, the method comprising:
storing a data structure in a memory, the data structure comprising a plurality of data items associated together as a user profile, the data items comprising data representative of a financial condition and creditworthiness for a user associated with the user profile;
completing a debt instrument transaction between the user and a lender in response to inputs from a plurality of the remote computers received via a network;
detecting the completed debt instrument transaction; and
in response to detecting the completed debt instrument transaction, automatically updating the stored user profile based on the completed debt instrument transaction to thereby keep the user profile current such that a lender can review the updated user profile to make a decision on whether to extend an offer to the user regarding another debt instrument transaction; and
wherein the method steps are performed by a processor.

61. A system for facilitating debt instrument transactions, the system comprising:
a processor for communication with a plurality of remote computers via a network; and
a memory configured to store a plurality of user profile data structures, each user profile data structure being associated with a user and comprising a plurality of data items associated together, the data items comprising data representative of a financial condition and creditworthiness for the associated user;
the processor configured to:
define at least one criterion for automatically generating a hard offer with respect to a debt instrument transaction in response to input from the first of the remote computers for operation by a lender;
perform a search of a plurality of the user profile data structures to find any user profiles having parameters that match the defined at least one criterion;
in response to the search finding a user profile that matches the defined at least one criterion, automatically generate a hard offer for a debt instrument transaction; and
communicate the generated hard offer to a second of the remote computers for operation by the user associated with the matching user profile.

62. The system of claim 61 wherein the processor is further configured to (1) define a plurality of parameters for inclusion in the automatically generated hard offer in response to input from the first remote computer, and (2) incorporate the defined parameters in an automatically generated hard offer.

63. The system of claim 61 wherein the at least one criterion comprises at least one member of the group consisting of (1) an interest rate paid by a user for a debt with reference to a threshold, (2) an amount of home equity for a user, (3) a debt-to-income ratio for a user, and (4) a net worth for a user.

64. The system of claim 61 wherein the at least one criterion comprises a plurality of criteria, the plurality of criteria comprising at least two members of the group consisting of (1) an interest rate paid by a user for a debt with reference to a threshold, (2) an amount of home equity for a user, (3) a debt-to-income ratio for a user, and (4) a net worth for a user.

65. The system of claim 61 wherein the at least one criterion comprises a plurality of criteria, the plurality of criteria comprising an expressed interest by a user with respect to a particular type of debt instrument transaction and at least one member of the group consisting of (1) an interest rate paid by a user for a debt with reference to a threshold, (2) an amount of home equity for a user, (3) a debt-to-income ratio for a user, and (4) a net worth for a user.

66. The system of claim 61 wherein the at least one criterion comprises a plurality of criteria, the plurality of criteria comprising a geographic location for a user and at least one member of the group consisting of (1) an interest rate paid by a user for a debt with reference to a threshold, (2) an amount of home equity for a user, (3) a debt-to-income ratio for a user, and (4) a net worth for a user.

67. The system of claim 61 wherein the processor is further configured to (1) define at least one acceptance criterion for at least one of the user profiles in response to input from a remote computer for operation by the user associated with the at least one user profile, the at least one acceptance criterion for automatically accepting a hard offer with respect to a debt instrument transaction, and (2) for the at least one user profile, with respect to a received hard offer for a debt instrument transaction, (i) determine whether the received hard offer matches the defined at least one acceptance criterion, and (ii) in response to a determination that the received hard offer matches the defined at least one acceptance criterion, automatically accept the received hard offer.

68. The system of claim 61 wherein the user profile comprises data items representative of (1) an identity for the user, (2) an employment and income history for the user, (3) a credit financial condition for the user, (4) an automobile financial condition for the user, (5) a real estate financial condition for the user, and (6) an assets/liabilities condition for the user.

69. The system of claim 68 wherein each of at least a plurality of the user profile data structures further comprise corroborating data that is representative of documentary supporting evidence with respect to at least one of the data items of that user profile.

70. The system of claim 69 wherein the corroborating data comprises a copy of a governmental income tax return for the user.

71. The system of claim 69 wherein the corroborating data comprises a copy of a credit account statement for the user.

72. The system of claim 68 wherein the processor is further configured to perform the search by (1) analyzing a plurality of the user profile data structures to determine an average characteristic for a type of debt owed by a plurality of the users, (2) for a plurality of the user profile data structures having a data item indicative of that characteristic, comparing that characteristic in the plurality of user profile data structures with the average characteristic, and (3) based on the comparison, determining whether any of the user profile data structures are to be the subject of an automatically generated hard offer.

73. The system of claim 72 wherein the processor is further configured to perform the analysis with respect to a plurality of the user profile data structures for a plurality of users within a defined geographic area to determine the average characteristic.

74. The system of claim 68 wherein the processor is further configured to perform the search by (1) analyzing a plurality of the user profile data structures to determine an average interest rate for a type of debt owed by a plurality of the users, (2) for a plurality of the user profile data structures having a data item representative of an interest rate for that type of debt, comparing that interest rate in the plurality of user profile data structures with the average interest rate, and (3) based on the comparison, determining whether any of the user profile data structures are to be the subject of an automatically generated hard offer.

75. The system of claim 74 wherein the processor is further configured to perform the analysis with respect to a plurality of the user profile data structures for a plurality of users within a defined geographic area to determine the average interest rate.

76. A method for facilitating debt instrument transactions, the method comprising:
storing a plurality of user profile data structures in a memory, each user profile data structure being associated with a user and comprising a plurality of data items associated together, the data items comprising data representative of a financial condition and creditworthiness for the associated user;
defining at least one criterion for automatically generating a hard offer with respect to a debt instrument transaction in response to input via a network from a first remote computer operated by a lender;
performing a search of a plurality of the user profile data structures to find any user profiles having parameters that match the defined at least one criterion;
in response to the search finding a user profile that matches the defined at least one criterion, automatically generating a hard offer for a debt instrument transaction; and
communicating the generated hard offer via a network to a second remote computer operated by the user associated with the matching user profile; and
wherein the method steps are performed by a processor.

77. A system for facilitating debt instrument transactions, the system comprising:
a processor for communication with a plurality of remote computers via a network; and
a memory configured to store a user profile data structure, the user profile data structure being associated with a user and comprising a plurality of data items associated together, the data items comprising data representative of a financial condition and creditworthiness for the associated user;
the processor configured to:
define at least one acceptance criterion for the user profile in response to input from a remote computer, the at least one acceptance criterion for automatically accepting a hard offer with respect to a debt instrument transaction;
store the defined at least one acceptance criterion in the memory in association with the user profile data structure;
receive data corresponding to a hard offer for a debt instrument transaction that is directed toward the user profile;
determine whether the hard offer matches the defined at least one acceptance criterion; and
in response to a determination that the hard offer matches the defined at least one acceptance criterion, automatically accept the hard offer.

78. The system of claim 77 wherein the at least one acceptance criterion comprises at least one member of the group consisting of (1) an interest rate for a debt instrument with reference to a threshold, (2) an origination fee for a debt instrument with reference to a threshold, (3) an amount of discount points for a debt instrument with respect to a threshold, (4) an amount for closing costs with respect to a threshold, (5) a term to maturity for a debt instrument with respect to a threshold, (6) an amortization duration for a debt instrument with respect to a threshold, and (7) a lender type for a lender associated with the hard offer.

79. The system of claim 77 wherein the at least one acceptance criterion comprises a plurality of acceptance criteria, the plurality of acceptance criteria comprising at least two members of the group consisting of (1) an interest rate for a debt instrument with reference to a threshold, (2) an origination fee for a debt instrument with reference to a threshold, (3) an amount of discount points for a debt instrument with respect to a threshold, (4) an amount for closing costs with respect to a threshold, (5) a term to maturity for a debt instrument with respect to a threshold, (6) an amortization duration for a debt instrument with respect to a threshold, and (7) a lender type for a lender associated with the hard offer.

80. A method for facilitating debt instrument transactions, the method comprising:
storing a user profile data structure in a memory, the user profile data structure being associated with a user and comprising a plurality of data items associated together, the data items comprising data representative of a financial condition and creditworthiness for the associated user;
defining at least one acceptance criterion for the user profile in response to input from a remote computer, the at least one acceptance criterion for automatically accepting a hard offer with respect to a debt instrument transaction;
storing the defined at least one acceptance criterion in the memory in association with the user profile data structure;
receiving data corresponding to a hard offer for a debt instrument transaction that is directed toward the user profile;
determining whether the hard offer matches the defined at least one acceptance criterion; and
in response to a determination that the hard offer matches the defined at least one acceptance criterion, automatically accepting the hard offer; and
wherein the method steps are performed by a processor.

81. A system comprising:
a processor; and
a memory configured to store a plurality of user profile data structures, each user profile data structure being associated with a user and comprising a plurality of data items associated together, the data items comprising data representative of a financial condition and creditworthiness for the associated user, wherein at least a plurality of the user profile data structures comprise at least one data item representative of a debt owed by the associated user;
the processor configured to:
analyze a plurality of the user profile data structures to determine an average characteristic for a type of debt owed by a plurality of the users;
for a plurality of the user profile data structures having a data item indicative of that characteristic, compare that characteristic in the plurality of user profile data structures with the average characteristic; and
based on the comparison, for at least one of the compared user profile data structures, generate data indicative of how that characteristic for the at least one compared user profile differs from the average characteristic.

82. A method comprising:
analyzing a plurality of user profile data structures stored in a memory to determine an average characteristic for a type of debt owed by a plurality of the users, each user profile data structure being associated with a user and comprising a plurality of data items associated together, the data items comprising data representative of a financial condition and creditworthiness for the associated user, wherein at least a plurality of the user profile data structures comprise at least one data item representative of a debt owed by the associated user;
for a plurality of the user profile data structures having a data item indicative of that characteristic, comparing that characteristic in that plurality of user profile data structures with the average characteristic; and
based on the comparison, for at least one of the compared user profile data structures, generating data indicative of how that characteristic for the at least one compared user profile differs from the average characteristic; and
wherein the method steps are performed by a processor.

83. A system for facilitating debt instrument transactions, the system comprising:
a processor for communication with a plurality of remote computers via a network; and
a memory;
the processor configured to:
store a data structure in the memory, the data structure comprising a plurality of data items associated together as a user profile, the data items comprising data representative of a financial condition and creditworthiness for a user associated with the user profile;
provide a first of the remote computers for operation by a lender with access the user profile for a decision by the lender as to whether a hard offer for a debt instrument transaction is to be extended to the user associated with the user profile;
in response to input from the second remote computer, communicate a hard offer for a debt instrument transaction to a second of the remote computers for operation by the user associated with the user profile;
provide a secure workroom for collaboration between the user and the lender to complete the debt instrument transaction; and
complete a debt instrument transaction between the user and the lender in response to inputs from the user and the lender provided through the secure workroom.

84. The system of claim 83 wherein the processor is further configured to receive an acceptance of the communicated hard offer from the second remote computer prior to the collaboration within the secure workroom.

85. The system of claim 83 wherein the memory is further configured to store a plurality of trusted advisor profiles, each trusted advisor profile corresponding to a professional advisor, the user profile being associated with at least one trusted advisor profile, and wherein the processor is further configured to provide the professional advisor corresponding to the trusted advisor profile that is associated with the user profile with access to the hard offer for assisting the user with respect to whether to accept the hard offer.

86. The system of claim 83 wherein the memory is further configured to store a plurality of trusted advisor profiles, each trusted advisor profile corresponding to a professional advisor, the user profile being associated with at least one trusted advisor profile, and wherein the processor is further configured to provide the professional advisor corresponding to the trusted advisor profile that is associated with the user profile with access to the secure workroom for assisting the user to complete the debt instrument transaction.

87. The system of claim 86 wherein the trusted advisor profiles correspond to at least one member of the group consisting of an attorney, a financial advisor, and an accountant.

88. A method for facilitating debt instrument transactions, the method comprising:
storing a data structure in a memory, the data structure comprising a plurality of data items associated together as a user profile, the data items comprising data representative of a financial condition and creditworthiness for a user associated with the user profile;
providing a first of the remote computers operated by a lender with access the user profile for a decision by the lender as to whether a hard offer for a debt instrument transaction is to be extended to the user associated with the user profile;
in response to input from the second remote computer, communicating a hard offer for a debt instrument transaction to a second of the remote computers operated by the user associated with the user profile;
providing a secure workroom for collaboration between the user and the lender to complete the debt instrument transaction; and
completing a debt instrument transaction between the user and the lender in response to inputs from the user and the lender provided through the secure workroom; and
wherein the method steps are performed by a processor.

89. A system comprising:
a processor for communication with a plurality of remote computers via a network; and
a memory;
the processor configured to:
store a data structure in the memory, the data structure comprising a plurality of data items associated together as a user profile, the data items comprising data representative of a financial condition and creditworthiness for a user associated with the user profile, the data items being sufficient to meet application requirements for a plurality of different types of debt instruments;
define a permission access level for the user profile in response to user input from a remote computer via the network to thereby make data within the user profile anonymously viewable by a plurality of lenders such that the user is eligible to receive a plurality of hard offers for a plurality of debt instrument transactions from the without requiring the user to specifically apply for the debt instrument transactions;
permit the lenders to access the user profile through a plurality of remote computers via the network in accordance with the defined permission access level; and
generate at least one hard offer from a lender to the user for a debt instrument transaction based on the accessed user profile in response to input via the network from a remote computer associated with that lender.

90. A method comprising:
storing a data structure in a memory, the data structure comprising a plurality of data items associated together as a user profile, the data items comprising data representative of a financial condition and creditworthiness for a user associated with the user profile, the data items being sufficient to meet application requirements for a plurality of different types of debt instruments;
defining a permission access level for the user profile in response to user input from a remote computer via the network to thereby make data within the user profile anonymously viewable by a plurality of lenders such that the user is eligible to receive a plurality of hard offers for a plurality of debt instrument transactions from the without requiring the user to specifically apply for the debt instrument transactions;
permitting the lenders to access the user profile through a plurality of remote computers via the network in accordance with the defined permission access level; and
generating at least one hard offer from a lender to the user for a debt instrument transaction based on the accessed user profile in response to input via the network from a remote computer associated with that lender; and
wherein the method steps are performed by a processor.
